(19) United States
(12) Patent Application Publication
(10) Pub. No.: US 2024/0362465 A1
(43) Pub. Date: Oct. 31, 2024

(54) ARTIFICIAL INTELLIGENCE (AI)-BASED SYSTEM FOR AI APPLICATION DEVELOPMENT USING CODELESS CREATION OF AI WORKFLOWS

(71) Applicant: ACCENTURE GLOBAL SOLUTIONS LIMITED, Dublin 4 (IE)

(72) Inventors: Emmanuel MUNGUIA TAPIA, San Jose, CA (US); Colin CONNORS, Campbell, CA (US); Molly Carrene CHO, San Jose, CA (US); Jayashree SUBRAHMONIA, San Jose, CA (US); Kaustubh KURHEKAR, Pune (IN); Fnu SHASHI, San Jose, CA (US); Sujeong CHA, Seattle, WA (US); Anupam Anurag TRIPATHI, Chicago, IL (US); Neeru NARANG, San Jose, CA (US); Denise ZHENG, Washington, DC (US); Chantal GARCIA FISCHER, Bedford, NY (US); Naveen Kumar KUMAR THANGARAJ, Salem (IN); Sukryool KANG, Pleasanton, CA (US); Alok BEHERA, Bangalore (IN); Dhruvil BAVISHI, Manipur (IN); RBSanthosh KUMAR, Bangalore (IN); Saiguru KARTHIKEYAN, Bangalore (IN); Kevin COLLINS, Danville, CA (US)

(73) Assignee: ACCENTURE GLOBAL SOLUTIONS LIMITED, Dublin 4 (IE)

(21) Appl. No.: 18/647,652

(22) Filed: Apr. 26, 2024

Related U.S. Application Data
(60) Provisional application No. 63/462,064, filed on Apr. 26, 2023.

(51) Int. Cl. G06N 3/0464

(52) U.S. Cl. CPC G06N 3/0464

(57) ABSTRACT

Artificial intelligence (AI)-based systems and methods for AI application development using codeless creation of AI workflows is disclosed. The system receives request for creating an artificial intelligence (AI)-based workflow from the user device. Further, the system obtains input data from data sources and pre-process the obtained data using AI based pre-processing model. Further, the system identifies plurality of AI and Generative AI service nodes to be executed on the pre-processed data. The system further generates an AI-based workflow by connecting AI and Generative AI service nodes. Further, the system generates a metadata for AI and Generative AI service nodes by executing each of the identified plurality of AI and Generative AI service nodes. The system validates the metadata based on AI-based rules. Furthermore, the system determines actions to be performed on the metadata based on results of validation and performs the set of actions on the AI-based workflow. Additionally, the system deploys the AI-based workflow onto external system based on configuration parameters.

### CROSS REFERENCE

This application claims priority to incorporate by reference the entire disclosure of U.S. provisional patent application No. 63/462,064, filed on Apr. 26, 2023.

### TECHNICAL FIELD

The present disclosure generally relates to Artificial Intelligence, generative AI, and their rapid application to business processes and multi-user application development and, more specifically relates to, an Artificial Intelligence (AI) based system for codeless creation of AI workflows for rapid development.

### BACKGROUND

In recent years, the emergence of Generative Artificial Intelligence (GenAI) and Artificial Intelligence (AI) in general have played a pivotal role in the accelerated development of intelligent solutions for many different types of business processes and multi-user environments or applications. One problem with deploying such AI based solutions are challenges related to speed of deployment, efficiency and scalability. This includes prolonged development cycles of these AI solutions, ranging from six months to a year, or sometimes even more depending on the number of AI models included in the application. Due to these prolonged developed cycles, multiple inefficiencies may arise and thus hinder agility of such AI solutions. Existing approaches have not effectively addressed this challenge and therefore there still exists a need for a more streamlined development process to enhance efficiency and reduce time-to-market for such AI solutions for a wide variety of AI applications. Also, when changes are needed to an AI-based application, these changes face the same challenges in speed of development as the original application development.

Another major challenge with AI solutions development is redundant or repetitive development of AI or generative AI components required for such AI solutions. In some instances where multiple projects utilized the same AI sub-technology component, these AI solutions require recreating the AI sub-technology component instead of optimizing and reusing existing AI sub-technology component. This practice results in unnecessary duplication of efforts, leading to suboptimal development practices. For instance, integration with third-party systems, may involve repetitive development efforts for connectors and actions. This lack of a centralized repository for reusable components may lead to a cycle of low-quality, quick developments which may hinder the overall progress of such AI solutions.

Additionally, most AI solutions may rely on humans to take decisions when output of AI lacks confidence. Such a decision-making process may be implemented as a customization for each AI deployment and may not be a part of the architecture of the AI solution itself. Further, such decisions and actions may be hardcoded in typical AI deployments leading to low flexibility.

Therefore, there is a need to apply AI and Generative AI in the development process itself, to help streamline the development process via codeless creation of AI workflows and AI-based reusability of components.

### SUMMARY

This section is provided to introduce certain objects and aspects of the present disclosure in a simplified form that are further described below in the detailed description. This summary is not intended to identify the key features or the scope of the claimed subject matter.

In one aspect, the present disclosure relates to a system based on artificial intelligence (AI) and generative AI, for the fast development of AI-based applications using codeless creation of AI workflows that may be deployed in minutes. The system receives the request for creating an artificial intelligence (AI)-based workflow from the user device. Further, the system obtains input data from a plurality of data sources based on the received request and pre-processes the obtained data using artificial intelligence (AI) and generative artificial intelligence based pre-processing models. Further, the system identifies a plurality of AI and Generative AI service nodes to be executed on the pre-processed data based on the received request. The plurality of AI and Generative AI service nodes may include a functional task to be executed on the pre-processed data. The plurality of AI and Generative AI service nodes may include a plurality of processing nodes. The system further generates an AI-based workflow by connecting each of the identified plurality of AI and Generative AI service nodes in a pre-determined manner. The AI-based workflow may include the identified plurality of AI and Generative AI service nodes to be executed, an order of execution, and a service configuration, and the AI-based workflow may include a workflow description. Further, the system generates a metadata for each identified plurality of AI and Generative AI service nodes by executing each of the identified plurality of AI and Generative AI service nodes comprised in the generated AI-based workflow. The metadata is generated at each stage of execution of the plurality of AI and Generative AI service nodes. The system further validates the generated metadata based on a plurality of AI-based rules. Furthermore, the system determines a set of actions to be performed on the generated metadata based on results of validation and performs the determined set of actions on the generated AI-based workflow. Additionally, the system deploys the generated AI-based workflow onto at least one external system based on a set of configuration parameters.

In another aspect, the present disclosure relates to a method to apply artificial intelligence (AI), generative AI for the rapid codeless creation of AI workflows. The method includes receiving, by a processor, a request for creating an artificial intelligence (AI)-based workflow from a user device. Further, the method includes obtaining, by the processor, an input data from a plurality of data sources based on the received request. Further, the method includes pre-processing, by the processor, the obtained data using an artificial intelligence (AI) based pre-processing model. The method further includes identifying, by the processor, a plurality of AI and Generative AI service nodes to be executed on the pre-processed data based on the received request. The plurality of AI and Generative AI service nodes comprise a functional task to be executed on the pre-processed data and the plurality of AI and Generative AI service nodes comprise a plurality of processing nodes. Further, the method includes generating, by the processor, an AI-based workflow by connecting each of the identified plurality of AI and Generative AI service nodes in a pre-determined manner. The AI-based workflow comprises the identified plurality of AI and Generative AI service nodes to be executed, an order of execution, and a service configuration, and the AI-based workflow comprises a workflow description. Furthermore, the method includes generating, by the processor, a metadata for each of identified plurality of AI and Generative AI service nodes by executing each of the identified plurality of AI and Generative AI service nodes comprised in the generated AI-based workflow. The metadata is generated at each stage of execution of the plurality of AI and Generative AI service nodes. Further, the method includes validating, by the processor, the generated metadata based on a plurality of AI-based rules. Additionally, the method includes determining, by the processor, a set of actions to be performed on the generated metadata based on results of validation. The method further includes performing, by the processor, the determined set of actions on the generated AI-based workflow. The method further includes deploying, by the processor, the generated AI-based workflow onto at least one external system based on a set of configuration parameters.

In another aspect, the present disclosure relates to a non-transitory computer readable medium comprising a processor-executable instructions that cause a processor to receive the request for creating an artificial intelligence (AI)-based workflow from the user device. Further, the processor obtains input data from a plurality of data sources based on the received request and pre-processes the obtained data using an artificial intelligence (AI) based pre-processing model. Further, the processor identifies a plurality of AI and Generative AI service nodes to be executed on the pre-processed data based on the received request. The plurality of AI and Generative AI service nodes may include a functional task to be executed on the pre-processed data. The plurality of AI and Generative AI service nodes may include a plurality of processing nodes. The processor further generates an AI-based workflow by connecting each of the identified plurality of AI and Generative AI service nodes in a pre-determined manner.

The AI-based workflow may include the identified plurality of AI and Generative AI service nodes to be executed, an order of execution, and a service configuration, and the AI-based workflow may include a workflow description. Further, the processor generates a metadata for each of identified plurality of AI and Generative AI service nodes by executing each of the identified plurality of AI and Generative AI service nodes comprised in the generated AI-based workflow. The metadata is generated at each stage of execution of the plurality of AI and Generative AI service nodes. The processor further validates the generated metadata based on a plurality of AI-based rules. Furthermore, the processor determines a set of actions to be performed on the generated metadata based on results of validation and performs the determined set of actions on the generated AI-based workflow. Additionally, the processor deploys the generated AI-based workflow onto at least one external system based on a set of configuration parameters.

To further clarify the features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary block diagram representation of a network architecture in which a system may be implemented for artificial intelligence (AI) and generative AI, for the fast development of AI-based applications using codeless creation of AI workflows, in accordance with embodiments of the present disclosure.

FIG. 2 illustrates an exemplary block diagram representation of a computer-implemented the system, such as those shown in FIG. 1, capable of artificial intelligence (AI) and generative AI based method for the fast development of AI-based applications using based codeless creation of AI workflows, in accordance with embodiments of the present disclosure.

FIGS. 3A-C illustrates an example block diagram depicting various modules of the system such as those shown in FIG. 2, capable of creating artificial intelligence (AI) and generative AI, based workflows, in accordance with embodiments of the present disclosure.

FIGS. 4A-B illustrates example block diagrams depicting a platform for creating intelligence (AI) and generative AI based workflows, in accordance with embodiments of the present disclosure.

FIGS. 5A-D illustrates graphical user interfaces (GUIs) of a workflow composer module, such as those shown in FIG. 2, capable of generating AI—and generative AI based workflows, in accordance with embodiments of the present disclosure.

FIG. 6 illustrates a data flow diagram of system entities and relationships between the system entities, in accordance with embodiments of the present disclosure.

FIG. 7 illustrates a block diagram of an example workflow and service descriptors of AI and Generative AI services included in the workflow, in accordance with embodiments of the present disclosure.

FIGS. 8A-E illustrates a block diagram of a data entity, metadata entity and a format for a sample workflow, in accordance with embodiments of the present disclosure.

FIG. 9 illustrates an example block diagram depicting a process performed by the orchestration engine, in accordance with embodiments of the present disclosure.

FIG. 10 illustrates a high-level architecture diagram of the orchestration engine, in accordance with embodiments of the present disclosure.

FIG. 11 illustrates a technical architecture diagram of the orchestration engine, in accordance with embodiments of the present disclosure.

FIGS. 12A-B illustrates a block diagram of an example file-based and streaming data orchestration, in accordance with embodiments of the present disclosure.

FIG. 13 illustrates a block diagram of an example rule representation, in accordance with embodiments of the present disclosure.

FIG. 14 illustrates a block diagram of an example rule engine module, in accordance with embodiments of the present disclosure.

FIG. 15 illustrates an example rule engine architecture, in accordance with embodiments of the present disclosure.

FIG. 16 illustrates a block diagram representation of an example rule engine metadata processing, in accordance with embodiments of the present disclosure.

FIG. 17 illustrates an example block diagram of a process for creation of rules in the rule engine module, in accordance with embodiments of the present disclosure.

FIG. 18 illustrates a graphical user interface of an example rule editor, in accordance with embodiments of the present disclosure.

FIG. 19 illustrates a block diagram representation of an action engine module in accordance with embodiments of the present disclosure.

FIG. 20 illustrates an example flowchart executed by the action engine module, in accordance with embodiments of the present disclosure.

FIG. 21 illustrates an example architecture diagram of an agent routing module, in accordance with embodiments of the present disclosure.

FIG. 22 illustrates an example flow chart for agent routing module in accordance with embodiments of the present disclosure.

FIGS. 23A-D depicts graphical user interfaces of an example routing dashboard, in accordance with embodiments of the present disclosure.

FIG. 24 illustrates an example flowchart of optimization compiler module, in accordance with embodiments of the present disclosure.

FIG. 25 shows an example flowchart implemented in the cloud deployer module in accordance with embodiments of the present disclosure.

FIGS. 26A-C illustrates a system cloud deployer module architecture in accordance with embodiments of the present disclosure.

FIG. 27 illustrates an example flowchart implemented in an agent review dashboard in accordance with embodiments of the present disclosure.

FIGS. 28A-C illustrates graphical user interfaces (GUIs) of an example use case of agent review dashboard, in accordance with embodiments of the present disclosure.

FIG. 29 illustrates an example flowchart implemented in the management dashboard in accordance with embodiments of the present disclosure.

FIGS. 30A-B illustrates examples of management dashboard visualizations in accordance with embodiments of the present disclosure.

FIG. 31 illustrates a graphical user interface of an example gesture detection sample data in accordance with embodiments of the present disclosure.

FIG. 32 illustrates a block diagram of an example gesture detection in accordance with embodiments of the present disclosure.

FIG. 33 illustrates an example API specification for gesture detection in accordance with embodiments of the present disclosure.

FIGS. 34A-B illustrates an example representation of a gesture detection sample data in accordance with embodiments of the present disclosure.

FIG. 35 illustrates an example block diagram of a gesture detection for the above use case in accordance with embodiments of the present disclosure.

FIG. 36 illustrates an example API specification for gesture detection in accordance with embodiments of the present disclosure.

FIG. 37 illustrates a block diagram of an emotion detection in accordance with embodiments of the present disclosure.

FIGS. 38A-B illustrates exemplary representations of workflow for emotion detection (audio) in accordance with embodiments of the present disclosure.

FIG. 39 illustrates an exemplary representation of workflow for feature processing for emotion detection (audio) in accordance with embodiments of the present disclosure.

FIGS. 40A-B illustrates an example API specification for emotion detection (audio) and text in accordance with an embodiment.

FIG. 41 illustrates an example block diagram of an emotion detection (fusion-text and audio) in accordance with an embodiment.

FIG. 42 illustrates an example API specification for emotion detection (fusion) in accordance with an embodiment.

FIG. 43 illustrates a block diagram of an example STT transcription service in accordance with an embodiment.

FIG. 44 illustrates an example API specification for STT transcription in accordance with an embodiment.

FIG. 45 illustrates a block diagram of an age detection workflow in accordance with an embodiment.

FIG. 46 illustrates an example workflow for age detection based on audio file in accordance with an embodiment.

FIG. 47 illustrates an example API specification for age detection in accordance with an embodiment.

FIG. 48 illustrates a block diagram of an example gender detection in accordance with an embodiment.

FIG. 49 illustrates an example workflow for gender detection in accordance with an embodiment.

FIG. 50 illustrates an example API specification for gender detection in accordance with an embodiment.

FIG. 51 illustrates an example workflow for two-dimensional activity detection (video) in accordance with an embodiment.

FIGS. 52A-B illustrates an example workflow for three-dimensional activity detection in accordance with an embodiment.

FIG. 53 illustrates an example flowchart representation of a method for codeless creation of artificial intelligence (AI) and generative AI based workflows, in accordance with embodiments of the present disclosure.

FIG. 54 illustrates an exemplary block diagram representation of a hardware platform for implementation of the disclosed system, in accordance with embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, and the like. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a system and a method for artificial intelligence (AI) and generative AI based codeless creation of AI workflows. The system receives the request for creating an artificial intelligence (AI)-based workflow from the user device. Further, the system may obtain input data from a plurality of data sources based on the received request and pre-process the obtained data using an artificial intelligence (AI) based pre-processing model. Further, the system identifies a plurality of AI and Generative AI service nodes to be executed on the pre-processed data based on the received request. The plurality of AI and Generative AI service nodes may include a functional task to be executed on the pre-processed data. The plurality of AI and Generative AI service nodes may include a plurality of processing nodes. The system generates an AI-based workflow by connecting each of the identified plurality of AI and Generative AI service nodes in a pre-determined manner. The AI-based workflow may include the identified plurality of AI and Generative AI service nodes to be executed, an order of execution, and a service configuration, and the AI-based workflow may include a workflow description. Further, the system generates a metadata for each identified plurality of AI and Generative AI service nodes by executing each of the identified plurality of AI and Generative AI service nodes comprised in the generated AI-based workflow. The metadata is generated at each stage of execution of the plurality of AI and Generative AI service nodes. The system validates the generated metadata based on a plurality of AI-based rules. Further, the system determines a set of actions to be performed on the generated metadata based on results of validation and performs the determined set of actions on the generated AI-based workflow. Furthermore, the system deploys the generated AI-based workflow onto at least one external system based on a set of configuration parameters.

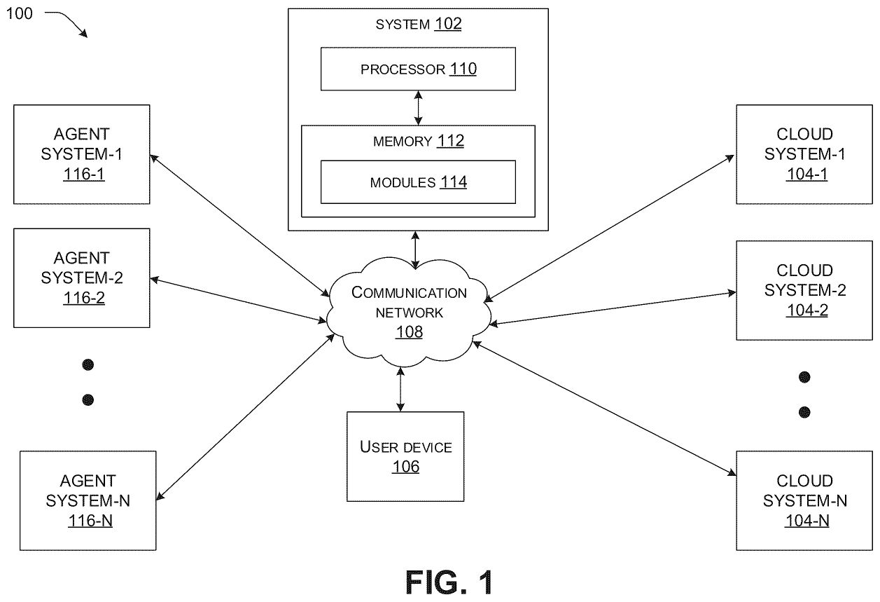

Referring now to the drawings, and more particularly to FIG. 1 through FIG. 54, where similar reference characters denote corresponding features consistently throughout the figures, there are shown preferred embodiments and these embodiments are described in the context of the following exemplary system and/or method.

FIG. 1 illustrates an exemplary block diagram representation of a network architecture 100 in which a system 102 may be implemented for artificial intelligence (AI) and generative AI, for the fast development of AI-based applications using codeless creation of AI workflows, in accordance with embodiments of the present disclosure. The network architecture 100 may include the system 102, one or more cloud systems 104-1, 104-2, . . . , and 104-N (individually referred to as the cloud system 104, and collectively referred to as the cloud systems 104), a user device 106, and one or more agent systems 116-1, 116-2 . . . and 116-N (individually referred to as the agent system 116, and collectively referred to as the agent systems 116). The agent system 116 may be associated with, but not limited to, a user, an agent, an individual, an administrator, a vendor, a technician, a worker, a specialist, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility, and the like. The agent system 116 may be used to provide one of an agent review, an agent recommended actions, training data and the like and/or receive output to/from the system 102. The agent system 116 may present to the agent one or more user interfaces for the agent to interact with the system 102 for creating AI and generative AI based workflows at real-time. The agent system 116 may be at least one of, an electrical, an electronic, an electromechanical, and a computing device. The agent system 116 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like. The system 102 and the agent system 116 may be communicatively coupled to the user device 106 via a communication network 108. The communication network 108 may be a wired communication network and/or a wireless communication network.

Further, the user device 106 may be associated with, but not limited to, a user, an individual, an administrator, a vendor, a technician, a worker, a specialist, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility, and the like. The user device 106 may be used to provide input and/or receive output to/from the system 102. The user device 106 may present to the user one or more user interfaces for the user to interact with the system 102 for creating AI workflows at real-time. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. Further, the system 102 includes one or more processor(s) 110, and a memory 112. The memory 112 may include a plurality of modules 114. The system 102 may be a hardware device including the processor 110 executing machine-readable program instructions for AI and generative AI based codeless creation of AI workflows. Execution of the machine-readable program instructions by the processor 110 may enable the proposed system 102 to perform artificial intelligence (AI) and generative AI based codeless creation of AI workflows. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more processors 110 may include, for example, microprocessors, microcomputers, microcontrollers, digital signal processors, central processing units, state machines, logic circuits, and/or any devices that manipulate data or signals based on operational instructions. Among other capabilities, the processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, network devices, databases, network attached storage devices, assets, machinery, instruments, facility equipment, emergency management devices, image capturing devices, cooling devices, heating devices, compressors, any other devices, and combination thereof. The person skilled in the art should not be limiting the components/subsystems shown in FIG. 1.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, Bluetooth adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may receive a request for creating an artificial intelligence (AI)-based workflow from a user device 106. The request may include one of user profile information, an event history, an event location, and user requirements. The user profile information may include personal information of the user, user subscription details, user preferences and the like. The event history may include past actions made by the user on the user device. The user requirements may include requirement for creating an AI workflow, a target cloud system, and the like. The requirement may include, for example, but not limited to, the requirements specified with respect to what has to happen at each node of the AI workflow.

In an exemplary embodiment, the system 102 may obtain an input data from a plurality of data sources based on the received request. The input data may include, such as, but not limited to, at least or a combination of audio data, visual data, a video data, a text data, or any other type of multi-media data. The plurality of data sources may include, for example, but not limited to, one of user inputs (upload from a user), a Secure File Transfer Protocol (SFTP) file transfer, a cloud data source, an online video stream, an online audio steam or any other external/internal data sources.

In an exemplary embodiment, the system 102 may pre-process the obtained data using an artificial intelligence (AI) based pre-processing model. To pre-process the obtained data, the system 102 may further identify a type of data format associated with the obtained data. The type of data format may include a multi-media data format. The multi-media data format may include, for example, but not limited to, one of an audio, video, or text data formats. Further, the system 102 may classify the obtained data into a plurality of categories based on content of the obtained data. The plurality of categories may include, for example, but not limited to, one of an audio category, a video category or a text category based on sliding window, or utterance timestamps from transcript and the like. Further, the system 102 may segment the obtained data into a plurality of multi-media files based on the plurality of categories. Each of the plurality of multi-media files may include data objects and data object descriptors. In an exemplary embodiment, data object may represent raw data or transformed data. Further, any input raw data may be represented as JSON and hence new data types (e.g., image, video, cloud point) may be added easily as new source input decoders are created. Further, the data object descriptors may be a concatenation of all services descriptors in JSON format. In an example embodiment, the data object descriptor may define an AI service (or service node) and a sub-steps (or the processing nodes) therewithin. For example, data object descriptor specifies a video decoding format and a location on an image or time stamp for audio detection. The data object descriptor may define the way the data flows through different service nodes (defined by service descriptors). The data object descriptor defines the manner in which the different services are concatenated or connected and also specifies what each service node is supposed to do. In an example embodiment, the data object descriptor may be provided using JSON format. In an example embodiment, the data object descriptors may be software codes using JSON format. In an example, the data objects may be a data structure for holding any type of data flowing through the workflow, such as video, images, audio, text, cloud-points, and the like.

In an example embodiment, the system 102 may identify a plurality of AI and Generative AI service nodes to be executed on the pre-processed data based on the received request. The plurality of AI and Generative AI service nodes may include a functional task to be executed on the pre-processed data. The plurality of AI and Generative AI service nodes may include a plurality of processing nodes. In an example embodiment, the plurality of AI and Generative AI service nodes are full services that may be arranged in a workflow such as data decoders, processors, segments, and AI and Generative AI detectors with their respective configuration. To identify the plurality of AI and Generative AI service nodes to be executed on the pre-processed data based on the received request, the system 102 may determine a plurality of functional tasks to be performed for each type of the plurality of multi-media files based on the received request. The plurality of functional tasks may be to decode a video, emotion detection, age detection, activity detection, gender detection, a data segmentation, and the like. Further, the system 102 may tag the determined plurality of functional tasks to each type of the plurality of multi-media files. For example, if the emotion detection is for an audio file, then the system 102 tags the emotion detection task to the audio file. Further, the system 102 may determine the plurality of processing nodes corresponding to the determined plurality of functional tasks. The plurality of processing nodes is to perform a computation within the determined plurality of functional tasks. For example, the processing node performs specific reusable computation within or across AI and Generative AI services. In an example, the plurality of AI and Generative AI service nodes is composed internally by a DAG of processing nodes, each for which performs specific reusable computation within or across services. Further, the system 102 may configure the determined plurality of processing nodes based on the received request. The plurality of processing nodes are configured with a set of parameters. The set of parameters may include AI service engine or model, sampling rate, target classification classes, and the like. Further, the system 102 may identify the plurality of AI and Generative AI service nodes corresponding to the configured plurality of processing nodes.

In an example embodiment, the system 102 may generate an AI-based workflow by connecting each of the identified plurality of AI and Generative AI service nodes in a pre-determined manner. The AI-based workflow may include the identified plurality of AI and Generative AI service nodes to be executed, an order of execution, and a service configuration. The AI-based workflow may include a workflow description. The pre-determined manner may be graphical connection of AI and Generative AI service nodes in a hierarchical or stage-wise manner. To generate the AI-based workflow by connecting each of the identified plurality of AI and Generative AI service nodes in the pre-determined manner, the system 102 may determine a service configuration of the identified plurality of AI and Generative AI service nodes based on a type of an AI service node. The service node configuration may be a service node name, a data type, an input type, a label, a color, a value, and the like. The system 102 may further identify an order of execution for the identified plurality of AI and Generative AI service nodes based on a data flow of the pre-processed data and a type of the plurality of functional tasks. The order of execution may depend on the inputs and outputs requirement for each of the identified AI and Generative AI service nodes. For example, if the AI service node is to segment an audio and a video file, then the order of the AI service node “segmentation” will be placed between an AI service node which outputs an “audio or video file” at the input level and an AI service node which requires the “segmented output” at the output level. The type of functional task may be data file, image file, or an audio file, a video file, and the like. The data flow corresponds to inputs and outputs of each of the AI and Generative AI service nodes.

The system 102 further may determine a flow path between the identified plurality of AI and Generative AI service nodes based on the identified order of execution and the determined service configuration. The identified plurality of AI and Generative AI service nodes is dragged and dropped at a plurality of node locations. Further, the system 102 may connect each of the identified plurality of AI and Generative AI service nodes based on the determined flow path. Furthermore, the system 102 may generate the AI-based workflow including the identified plurality of AI and Generative AI service nodes to be executed, the order of execution, and the service configuration based on the connection. The AI-based workflow may include the workflow description. The AI-based workflow may include a starting service node, one or more intermediate service nodes and an ending service node connected in the order of execution and based on the determined flow path. In an example embodiment, the AI-based workflow describes an interconnected directed acyclic graph (DAG) of AI and Generative AI services that is required to be executed in their order of execution and configuration.

In an example embodiment, the system 102 may analyze workflow descriptors associated with each of the identified plurality of AI and Generative AI service nodes, The workflow descriptors may include data objects in a human-readable format. The system 102 may further instantiate each of the plurality of AI and Generative AI service nodes in the generated AI-based workflow and perform the functional task associated with each of the plurality of AI and Generative AI service nodes in the order of execution. Further, the system 102 may measure an execution time of each of the processing nodes within the plurality of AI and Generative AI service nodes and validate the generated AI-based workflow based on at least one of the measured execution times, a processing node description, code functions, and the analyzed workflow descriptors. Furthermore, the system 102 may generate an updated AI-based workflow based on results of validation by modifying the AI-based workflow with updated processing nodes and corresponding AI-based service nodes. The system 102 may further re-compute the execution time of each of the updated processing nodes and tune the updated AI-based workflow based on the re-computed execution time using an AI-based optimization method. Additionally, the system 102 may generate a ranked list of workflows and node configurations based on the tuned AI-based workflow and modify container implementation information for each of the AI-based service nodes comprised within each of the generated ranked list of workflows and the node configurations.

In an example embodiment, the system 102 may generate a metadata for each of identified plurality of AI and Generative AI service nodes by executing each of the identified plurality of AI and Generative AI service nodes comprised in the generated AI-based workflow. The metadata may be generated at each stage of execution of the plurality of AI and Generative AI service nodes. The metadata corresponds to a data structure including metadata information or “data summaries” in the form of events detected by AI, generated by fusing several metadata pieces and other processing. To execute each of the identified plurality of AI and Generative AI service nodes included in the generated AI-based workflow, the system 102 may analyze the workflow descriptor associated with each of the identified plurality of AI and Generative AI service nodes. The workflow descriptor includes the data objects in a human-readable format. In an example, the human-readable format may be a JSON format. Further, the system 102 may instantiate each of the plurality of AI and Generative AI service nodes in the generated AI-based workflow. Furthermore, the system 102 may perform a functional task associated with each of the plurality of AI and Generative AI service nodes in the order of execution. Additionally, the system 102 may generate the metadata for each of the identified plurality of AI and Generative AI service nodes at each stage of execution of the functional task. Furthermore, the system 102 may fuse the metadata generated at each stage with corresponding data objects of an AI or Generative AI service node. Furthermore, the system 102 may generate a fused metadata output at each stage of execution of the functional task.

In an example embodiment, the system 102 may validate the generated metadata based on a plurality of AI-based rules. The plurality of AI-based rules may represent a rule that define conditions over metadata to trigger automation actions in the system 102. To validate the generated metadata based on the plurality of AI-based rules, the system 102 may obtain a list of the generated metadata, policy set identifiers (IDs) and parameters for metadata processing. The parameters for metadata processing may include confidence thresholds, presence and frequency, temporal and other location windows, and additional parameters. Further, the system 102 may segment each of the generated metadata in the list into a plurality of data segments using a sliding window. Further, the system 102 may determine the plurality of AI-based rules associated with the plurality of data segments based on a pre-stored rule database. The rules may be combined into groups, and the groups into policies. The polices may be defined at different hierarchical levels (regions, countries, production instances). In an example, the rules may be logical statements using ifs, ANDs, ORs, and the like captured in JSON format, and which are actionable by a rule engine. The policies may be group of rules defined by a client and organized around themes. A policy group may be a group of policies for a specific audience that may be defined by a geography, an age, a session type. Furthermore, the system 102 may then validate the generated metadata by applying the determined plurality of AI-based rules to the generated metadata. Additionally, the system 102 may generate a confidence score for the generated metadata based on the validation. The confidence score may include one of a low confidence score and a high confidence score.

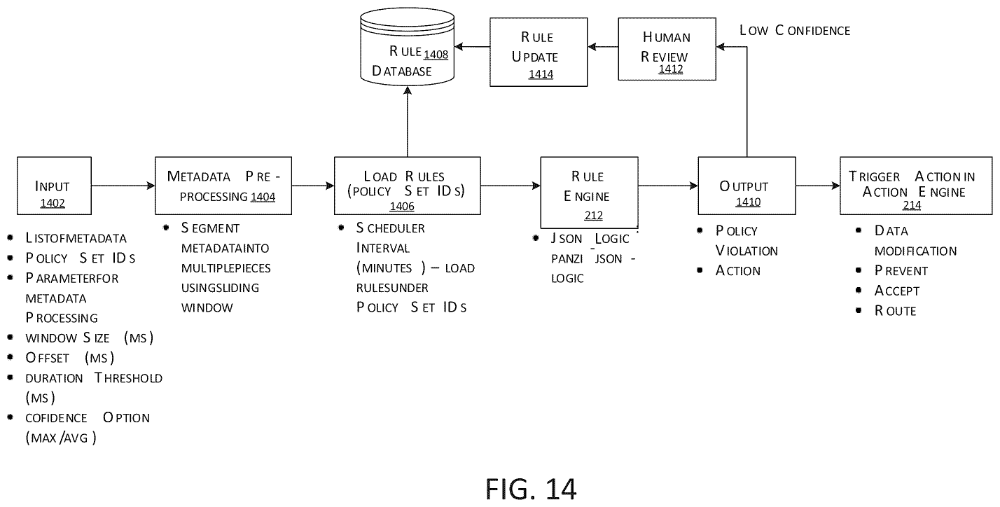

In an example embodiment, the system 102 may generate the plurality of AI-based rules based on at least one of a metadata existence, data formatting and logic inconsistencies between an existing rule and an updated rule. The plurality of AI-based rules is configured with updated metadata. The system 102 may further periodically modify the plurality of AI-based rules based on the updated metadata, a plurality of events detected by an AI service node, the received request, and the plurality of AI and Generative AI service nodes. Each of the modified plurality of AI-based rules are assigned with corresponding confidence scores and actions to be performed. FIG. 14 shows how the plurality of AI-based rules are modified.

In an example embodiment, the system 102 may determine a set of actions to be performed on the generated metadata based on results of validation. In an example embodiment, the system 102 may determine the set of actions to be performed on the generated metadata when the generated confidence score corresponds to the high confidence score. The set of actions may include at least one of a locally executable part of a code within a system 102 and integrations with the at least one external system 116. In an example, an action may represent an automation or action to be taken after a rule has been triggered. These actions may be assembled into a library of actions.

In an alternate embodiment, the system 102 may route the received request to the agent system 116 for resolution when the generated confidence score corresponds to the low confidence score. In such a case, a processor at the agent system 116 may resolve the received request by assessing the received request based on a description, a priority level, a business line, and product information. In an example embodiment, the priority level may be low, medium, high, and critical. In an example, the business line may include healthcare, industry, defense, finance, or the like. The product information may include product specifications, product identifier, product description, product type, end customers and the like. Further, the processor at the agent system 116 may determine a request description score and a request priority score for the received request based on the assessment. A request description score may be a classification of the issue category the case belongs to. A priority score is a prediction of the appropriate priority level, such as low, medium, high, and critical, based on the case inputs. Furthermore, the processor at the agent system 116 may identify issue resolution pain-points for the received request to be resolved by the agent system 116. In an example embodiment, the issue resolution pain-points may include, but not limited to, a feasibility and impact analysis.

The processor at the agent system 116 may further determine an appropriate agent corresponding to the received request based on at least one of the determined request description scores, the request priority score, the priority level, identified issue resolution pain points, a resolution method, and a resolution sequence. In an example, the resolution method may include fully automated or AI-assisted resolutions. The resolution sequence may include a list of categorical values such as a sequence of agents who worked on the issue and a sequence of agent groups which worked on the issue. The appropriate agent is determined by constructing a working agent finding model. The processor at the agent system 116 may further assign the received request to the determined appropriate agent and periodically monitor a request progress at the agent system 116 based on feedback from the agent system 116, interaction logs and a status report. The request progress may include assigned, work in progress, delayed, completed, failure, absence of relevant agent groups and the like. The feedback from the agent system 116 may include learnings as described below. In an example embodiment, the interaction logs may include time stamped routing history between agents or agent groups.

Additionally, the processor at the agent system 116 may further continuously update the rule database with learnings from the agent system 116 upon resolving the received request. The learnings may include at least one of an issue category, knowledge base records, and operational support records. The issue category may include the taxonomy or hierarchy of all categories that issues may belong to. The knowledge base records may include frequently asked questions (FAQs) for issue resolution, and the like. The operational support records may include an acknowledgement time and an impact/outage information, including for example an end user down time.

In an example embodiment, the system 102 may perform the determined set of actions on the generated AI-based workflow. To perform the determined set of actions on the generated AI-based workflow, the system 102 may generate an action code relevant to the at least one external system based on the determined set of actions. The system 102 may further determine action parameters associated with the determined set of actions. Further, the system 102 may convert the determined action parameters into action descriptors. The action descriptors correspond to a human-readable format. Furthermore, the system 102 may determine an order of execution associated with the determined set of actions and trigger action APIs associated with the determined set of actions based on the determined order of execution. Additionally, the system 102 may monitor an action execution at the at least one external system 116. Furthermore, the system 102 may report an action execution status in the real-time based on the monitoring. The action execution status may include one of a successful execution status and errors detected status.

Further, the system 102 may deploy the generated AI-based workflow onto at least one external system 116 based on a set of configuration parameters. To deploy the generated AI-based workflow onto the at least one external system 116 at the real-time based on the set of configuration parameters, the system 102 may analyze the workflow descriptors associated with each of the identified plurality of AI and Generative AI service nodes. The workflow descriptors may include data objects in a human-readable format. Further, the system 102 may map the analyzed workflow descriptors to a target external system such as one among the external systems 116. The system 102 may further perform network connection tests at the target external system for deploying the generated AI-based workflow onto the target external system. Further, the system 102 may instantiate AI-based services corresponding to the generated AI-based workflow as containers at the target external system and execute each of the identified plurality of AI and Generative AI service nodes at the target external system in the pre-determined manner based on the generated AI-based workflow. Furthermore, the system 102 may validate the execution of each of the identified plurality of AI and Generative AI service nodes at the target external system and generate a deployment successful message upon successful validation of the execution of each of the identified plurality of AI and Generative AI service nodes at the target external system. Alternatively, the system 102 may generate a deployment failure message upon failure of the execution of each of the identified plurality of AI and Generative AI service nodes at the target external system. The deployment failure message may include one or more execution errors detected during execution. Additionally, the system 102 may perform the one or more actions to rectify the one or more execution errors at the target external system.

In an example embodiment, the system 102 may further obtain one of streaming data and a batch data associated with the generated AI-based workflow. Further, the system 102 may instantiate the generated AI-based workflow based on the obtained one of the streaming data and the batch data and deploy the AI-based workflow onto at least one external systems at real-time based on the set of configuration parameters. The system 102 may further create a plurality of cases for the deployed AI-based workflow using an AI-detection model. In an example, the case may represent a case which needs to be reviewed or resolved by a human agent or automatically documented by AI.

Additionally, the system 102 may generate AI-based insights and visualizations for a plurality of events detected and processing performed on the plurality of cases. Further, the system 102 may output the generated AI-based insights and visualizations on a graphical user interface of the user device 106.

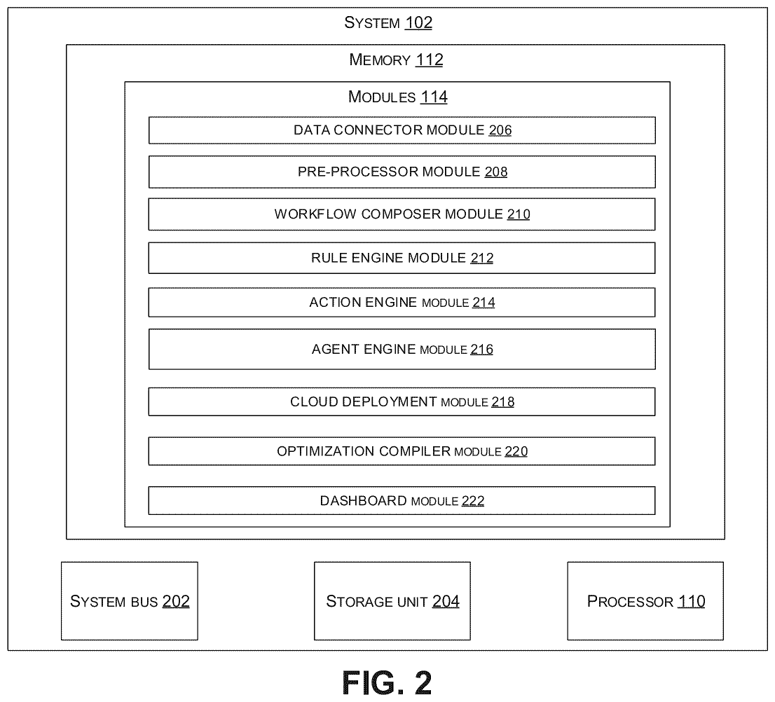

FIG. 2 illustrates an exemplary block diagram representation of a computer-implemented the system 102, such as those shown in FIG. 1, capable of capable of artificial intelligence (AI) and generative AI based method for the fast development of AI-based applications using codeless creation of AI workflows, in accordance with embodiments of the present disclosure. The system 102 may also function as a computer-implemented system 102. The system 102 includes the one or more processors 110, the memory 112, and a storage unit 204. The one or more processors 110, the memory 112, and the storage unit 204 are communicatively coupled through a system bus 202 or any similar mechanism. The memory 112 comprises a plurality of modules 114 in the form of programmable instructions executable by the one or more processors 110.

Further, the plurality of modules 114 includes a data connector module 206, a pre-processor module 208, a workflow composer module 210, a rule engine module 212, an action engine module 214, an agent routing module 216, a cloud deployment module 218, an optimization compiler module 220, and a dashboard 222.

The one or more processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more processors 110.

The storage unit 204 may be a cloud storage or a database such as those shown in FIG. 1. The storage unit 204 may store, but is not limited to, raw data, AI and Generative AI services, AI and Generative AI service nodes, processing nodes, workflows, configurations, descriptors, metadata, AI models, Generative AI models, agents, agent system information, the set of actions, data connectors, data flow, the plurality of cases, the AI-based insights, the plurality of AI-based rules, the plurality of functional tasks, the user information, priority score, business line, product information, confidence scores, resequencing methods, resequencing lists, order of execution, inputs, outputs, data paths, nodes, status reports, action APIs, workflow descriptors, data objects, network connection tests, updated AI-based workflows, updated rules, updated actions, and the like. The storage unit 204 may be any kind of database such as, but are not limited to, relational databases, dedicated databases, dynamic databases, monetized databases, scalable databases, cloud databases, distributed databases, any other databases, and a combination thereof.

In an exemplary embodiment, the data connector module 206 may receive the request for creating an artificial intelligence (AI)-based workflow from the user device 106. In an exemplary embodiment, the pre-processor module 208 may obtain an input data from a plurality of data sources based on the received request and pre-process the obtained data using an artificial intelligence (AI) based pre-processing model.

In an exemplary embodiment, the workflow composer module 208 may identify a plurality of AI and Generative AI service nodes to be executed on the pre-processed data based on the received request. The plurality of AI and Generative AI service nodes comprise a functional task to be executed on the pre-processed data and wherein the plurality of AI and Generative AI service nodes comprise a plurality of processing nodes. The workflow composer module 208 may further generate an AI-based workflow by connecting each of the identified plurality of AI and Generative AI service nodes in a pre-determined manner. The AI-based workflow comprises the identified plurality of AI and Generative AI service nodes to be executed, an order of execution, and a service configuration, and wherein the AI-based workflow comprises a workflow description. Further, the workflow composer module 208 may generate a metadata for each of identified plurality of AI and Generative AI service nodes by executing each of the identified plurality of AI and Generative AI service nodes comprised in the generated AI-based workflow. The metadata is generated at each stage of execution of the plurality of AI and Generative AI service nodes.

In an exemplary embodiment, the rule engine module 210 may validate the generated metadata based on a plurality of AI-based rules.

In an exemplary embodiment, the action engine module 212 may determine a set of actions to be performed on the generated metadata based on results of validation and perform the determined set of actions on the generated AI-based workflow.

In an exemplary embodiment, the cloud deployment module 218 may deploy the generated AI-based workflow onto at least one external system 116 based on a set of configuration parameters.

In an exemplary embodiment, the processor 110 is to pre-process the obtained data using the artificial intelligence (AI) based pre-processing model by: identifying a type of data format associated with the obtained data. The type of data format may include a multi-media data format. Further, the processor 110 is to classify the obtained data into a plurality of categories based on content of the obtained data and segment the obtained data into a plurality of multi-media files based on the plurality of categories. Each of the plurality of multi-media files comprise data objects and data object descriptors.

In an exemplary embodiment, the processor 110 is to identify the plurality of AI and Generative AI service nodes to be executed on the pre-processed data based on the received request by determining a plurality of functional tasks to be performed for each type of the plurality of multi-media files based on the received request. Further, the processor 110 is to tag the determined plurality of functional tasks to each type of the plurality of multi-media files and determine the plurality of processing nodes corresponding to the determined plurality of functional tasks. The plurality of processing nodes is to perform a computation within the determined plurality of functional tasks. Further, the processor 110 is to configure the determined plurality of processing nodes based on the received request and identify the plurality of AI and Generative AI service nodes corresponding to the configured plurality of processing nodes.

In an exemplary embodiment, the processor 110 is to generate the AI-based workflow by connecting each of the identified plurality of AI and Generative AI service nodes in the pre-determined manner by: determining a service configuration of the identified plurality of AI and Generative AI service nodes based on a type of an AI service node. Further, the processor 110 is to identify an order of execution for the identified plurality of AI and Generative AI service nodes based on a data flow of the pre-processed data and a type of the plurality of functional tasks. Further, the processor 110 is to determine a flow path between the identified plurality of AI and Generative AI service nodes based on the identified order of execution and the determined service configuration. The identified plurality of AI and Generative AI service nodes are dragged and dropped at a plurality of node locations. Furthermore, the processor 110 is to connect each of the identified plurality of AI and Generative AI service nodes based on the determined flow path and generate the AI-based workflow including the identified plurality of AI and Generative AI service nodes to be executed, the order of execution, and the service configuration based on the connection. The AI-based workflow may include the workflow description. The AI-based workflow may include a starting service node, an intermediate service node and an ending service node connected in the order of execution and based on the determined flow path.

In an exemplary embodiment, the processor 110 is to execute each of the identified plurality of AI and Generative AI service nodes comprised in the generated AI-based workflow by analyzing the workflow descriptor associated with each of the identified plurality of AI and Generative AI service nodes. The workflow descriptor comprises data objects in a human-readable format. Further, the processor 110 is to instantiate each of the plurality of AI and Generative AI service nodes in the generated AI-based workflow. Furthermore, the processor 110 is to perform a functional task associated with each of the plurality of AI and Generative AI service nodes in the order of execution. Furthermore, the processor 110 is to generate the metadata for each of the identified plurality of AI and Generative AI service nodes at each stage of execution of the functional task. Additionally, the processor 110 is to fuse the metadata generated at each stage with corresponding data objects of an AI service node and generate a fused metadata output at each stage of execution of the functional task.

In an exemplary embodiment, the processor 110 is to validate the generated metadata based on the plurality of AI-based rules by obtaining a list of the generated metadata, policy set identifiers (IDs) and parameters for metadata processing. Further, the processor 110 is to segment each of the generated metadata in the list into a plurality of data segments using a sliding window and determine the plurality of AI-based rules associated with the plurality of data segments based on a pre-stored rule database. Further, the processor 110 is to validate the generated metadata by applying the determined plurality of AI-based rules to the generated metadata and generate a confidence score for the generated metadata based on the validation. The confidence score comprises one of a low confidence score and a high confidence score.

In an exemplary embodiment, the processor 110 is to determine the set of actions to be performed on the generated metadata based on the generated confidence score. The confidence score corresponds to the high confidence score, and the set of actions may include at least one of a locally executable part of code within a system and integrations with the at least one external system 116. Further, the agent routing module 216 is to route the received request to an agent system for resolution based on the generated confidence score. The confidence score corresponds to the low confidence score, and a processor at the agent system 116 is to resolve the received request by: assessing the received request based on a description, a priority level, a business line, and product information. Further, the processor at the agent system 116 determines a request description score and a request priority score for the received request based on the assessment. Furthermore, the processor at the agent system 116 identifies issue resolution pain-points for the received request to be resolved by the agent system 116. Furthermore, the processor at the agent system 116 determines an appropriate agent corresponding to the received request based on at least one of the determined request description scores, the request priority score, the priority level, identified issue resolution pain points, a resolution method, and a resolution sequence. The appropriate agent is determined by constructing a working agent finding model. Additionally, the processor at the agent system 116 assigns the received request to the determined appropriate agent and periodically monitors a request progress at the agent system based on feedback from the agent system 116, interaction logs and a status report. Furthermore, the processor at the agent system 116 continuously updates the rule database with learnings from the agent system upon resolving the received request. The learnings may include at least one of an issue category, knowledge base records, and operational support records.

In an exemplary embodiment, the processor 110 is to generate the plurality of AI-based rules based on at least one of a metadata existence, a data formatting and logic inconsistencies between an existing rule and an updated rule. The plurality of AI-based rules is configured with updated metadata. Further, the processor 110 is to periodically modify the plurality of AI-based rules based on the updated metadata, a plurality of events detected by an AI service node, the received request, and the plurality of AI and Generative AI service nodes. Each of the modified plurality of AI-based rules are assigned with corresponding confidence scores and actions to be performed.

In an exemplary embodiment, the processor 110 is to analyze workflow descriptors associated with each of the identified plurality of AI and Generative AI service nodes. The workflow descriptors comprise data objects in a human-readable format. Further, the processor 110 is to instantiate each of the plurality of AI and Generative AI service nodes in the generated AI-based workflow. Furthermore, the processor 110 is to perform the functional task associated with each of the plurality of AI and Generative AI service nodes in the order of execution. Further, the processor 110 is to measure an execution time of each of the processing nodes within the plurality of AI and Generative AI service nodes and validate the generated AI-based workflow based on at least one of the measured execution times, a processing node description, code functions, and the analyzed workflow descriptors. Additionally, the optimization compiler module 220 is to generate an updated AI-based workflow based on results of validation by modifying the AI-based workflow with updated processing nodes and corresponding AI-based service nodes. Further, the optimization compiler module 220 is to re-compute the execution time of each of the updated processing nodes and tune the updated AI-based workflow based on the re-computed execution time using an AI-based optimization method. Furthermore, the optimization compiler module 220 is to generate a ranked list of workflows and node configurations based on the tuned AI-based workflow and modify container implementation information for each of the AI-based service nodes comprised within each of the generated ranked list of workflows and the node configurations.

In an exemplary embodiment, the cloud deployment module 218 is to deploy the generated AI-based workflow onto the at least one external systems at the real-time based on the set of configuration parameters by: analyzing workflow descriptors associated with each of the identified plurality of AI and Generative AI service nodes. The workflow descriptors may include data objects in a human-readable format. Further, the cloud deployment module 218 is to map the analyzed workflow descriptors to a target external system and perform network connection tests at the target external system for deploying the generated AI-based workflow onto the target external system. Further, the cloud deployment module 218 is to instantiate AI-based services corresponding to the generated AI-based workflow as containers at the target external system. Furthermore, the cloud deployment module 218 is to execute each of the identified plurality of AI and Generative AI service nodes at the target external system in the pre-determined manner based on the generated AI-based workflow. Additionally, the cloud deployment module 218 is to validate the execution of each of the identified plurality of AI and Generative AI service nodes at the target external system. Furthermore, the cloud deployment module 218 is to generate a deployment successful message upon successful validation of the execution of each of the identified plurality of AI and Generative AI service nodes at the target external system. Alternatively, the cloud deployment module 218 is to generate a deployment failure message upon failure of the execution of each of the identified plurality of AI and Generative AI service nodes at the target external system. The deployment failure message comprises one or more execution errors detected during execution. Further, the cloud deployment module 218 is to perform one or more actions to rectify the one or more execution errors at the target external system.

In an exemplary embodiment, the processor 110 is to obtain one of streaming data and a batch data associated with the generated AI-based workflow. Further, the processor 110 is to instantiate the generated AI-based workflow based on the obtained one of the streaming data and the batch data and deploy the AI-based workflow onto at least one external systems 116 at real-time based on the set of configuration parameters. Further, the processor 110 is to create a plurality of cases for the deployed AI-based workflow using an AI-detection model and generate AI-based insights and visualizations for a plurality of events detected and processing performed on the plurality of cases. Furthermore, the dashboard 222 is to output the generated AI-based insights and visualizations on a graphical user interface of a user device 106.

In an exemplary embodiment, the processor 110 is to perform the determined set of actions on the generated AI-based workflow by generating an action code relevant to the at least one external system based on the determined set of actions, determining action parameters associated with the determined set of actions. Further, the processor 110 is to convert the determined action parameters into action descriptors, wherein the action descriptors correspond to a human-readable format and determine an order of execution associated with the determined set of actions. Further, the processor 110 is to trigger action APIs associated with the determined set of actions based on the determined order of execution. Furthermore, the processor 110 is to monitor an action execution at the at least one external system; and report an action execution status at the real-time based on the monitoring. The action execution status may include one of a successful execution status and errors detected status.

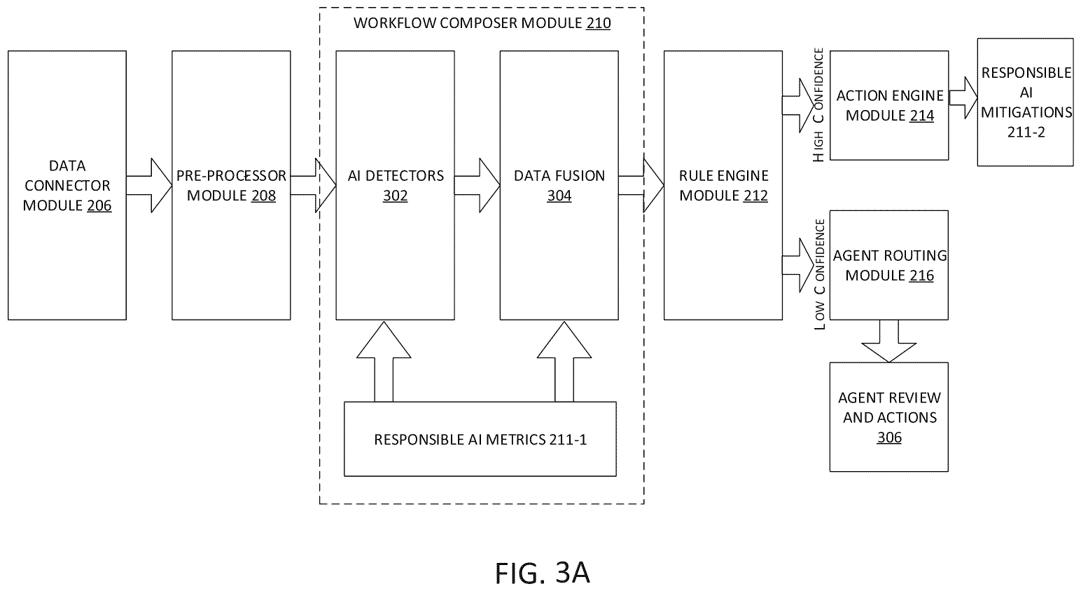

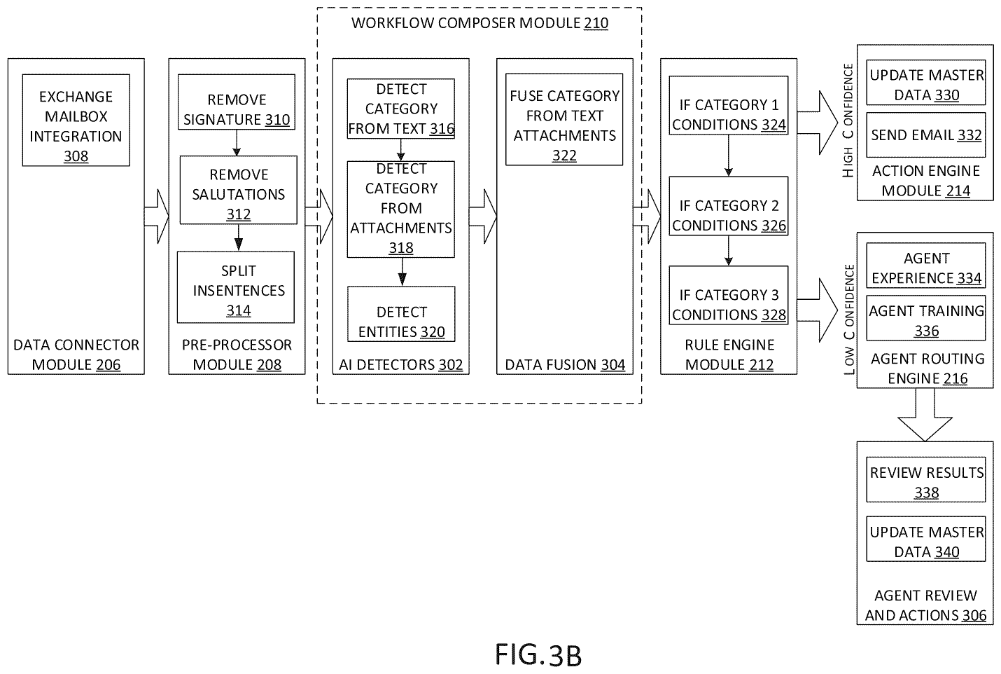

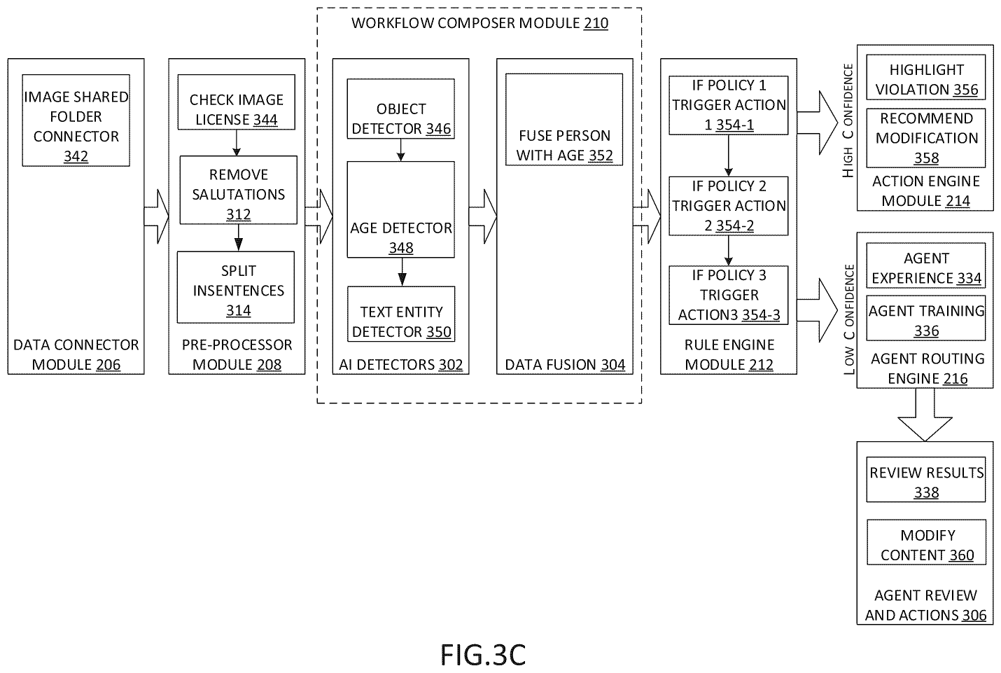

FIG. 3A illustrates an example block diagram depicting various modules 114 of the system 102 such as those shown in FIG. 2, capable of creating artificial intelligence (AI) and generative AI based workflows, in accordance with embodiments of the present disclosure. FIG. 3A depicts a generic workflow generation process. The system 102 may include the data connector module 206, the pre-processor module 208, the workflow composer module 210, the rule engine module 212, an action engine module 214, an agent routing module 216, and agent review and actions module 306. The data connector module 206 is configured to receive a request for creating an artificial intelligence (AI)-based workflow from user device 106. The pre-processor module 208 is configured to obtain an input data from a plurality of data sources based on the received request and pre-process the obtained data using an artificial intelligence (AI) based pre-processing model.

The workflow composer module 210 may include AI detectors 302, data fusion 304 and responsible AI metrics 211-1. The responsible AI metrics computation 211-1 are deployed as nodes within the workflow composer module 210, to monitor the compliance of the AI detectors 302 with respect to the different dimensions in responsible AI. The AI detectors 302 is configured to identify a plurality of AI and Generative AI service nodes to be executed on the pre-processed data based on the received request. The plurality of AI and Generative AI service nodes may include a functional task to be executed on the pre-processed data and the plurality of AI and Generative AI service nodes may include a plurality of processing nodes. The AI detectors 302 is configured to generate an AI-based workflow by connecting each of the identified plurality of AI and Generative AI service nodes in a pre-determined manner. The AI-based workflow may include the identified plurality of AI and Generative AI service nodes to be executed, an order of execution, and a service configuration. The AI-based workflow may include a workflow description.

Further, the data fusion 304 is configured to generate a metadata for each of identified plurality of AI and Generative AI service nodes by executing each of the identified plurality of AI and Generative AI service nodes comprised in the generated AI-based workflow. The metadata is generated at each stage of execution of the plurality of AI and Generative AI service nodes.

The rule engine module 212 is configured to validate the generated metadata based on a plurality of AI-based rules. The results of validation may include a low confidence score or a high confidence score. In case of high confidence score, the action engine module 214 is configured to determine a set of actions to be performed on the generated metadata based on results of validation and perform the determined set of actions on the generated AI-based workflow. In an embodiment, the action engine module 214 may be also configured to trigger corresponding responsible AI mitigation actions 211-2, based on the continuous monitoring of RAI metrics 211-1 for each of the AI detectors 302 included in the workflow composer module 210.

In case of the low confidence score, the agent routing module 216 is configured to resolve the received request by assessing the received request based on a description, a priority level, a business line, and product information. Further, the agent routing module 216 is configured to determine a request description score and a request priority score for the received request based on the assessment and identify issue resolution pain-points for the received request to be resolved by the agent system. Further, the agent routing module 216 is configured to determine an appropriate agent corresponding to the received request based on at least one of the determined request description scores, the request priority score, the priority level, identified issue resolution pain points, a resolution method, and a resolution sequence. The appropriate agent is determined by constructing a working agent finding model. Additionally, the agent routing module 216 is configured to assign the received request to the determined appropriate agent and periodically monitor a request progress at the agent system based on feedback from the agent system, interaction logs and a status report. Moreover, the agent routing module 216 is configured to continuously update the rule database with learnings from the agent system upon resolving the received request. The learnings comprise at least one of an issue category, knowledge base records, and operational support records.

The agent review and actions module 306 is configured to perform the set of actions to resolve the request. The agent review and actions module 306 works in conjunction with the agent systems 116 to perform the set of actions.

FIG. 3B illustrates an example block diagram depicting various modules 114 of the system 102 such as those shown in FIG. 2, capable of creating an exemplary email advisor as a workflow, in accordance with embodiments of the present disclosure.

In an example workflow of an email advisor as shown in FIG. 3B, the AI solutions fits a workflow template as described above. This solution uses AI to scan mailboxes for incoming customer email requests in a back-office scenario. Further, the request types are then automatically classified, and the necessary information are extracted to run automations. Such automations may include, for example, but not limited to, “get me a copy of my invoice”, “expedite my order”, and the like.

In this example, the data connector module 206 may include an exchange mailbox integration 308 for extracting necessary information to run the automations. The pre-processor module 208 may include pre-processing functional modules such as remove signature 310, remove salutations 312, and split sentences 314 to perform the pre-processing on the incoming customer email requests. The AI detectors 302 may include detect category from text 316, detect category from attachments 318 and detect entities 320 to perform one or more functional tasks on the email requests and select the appropriate AI and Generative AI service nodes to create an AI-based workflow. The data fusion 304 may include fuse category from text attachments 322 to fuse the detected text and attachments for generating the fused metadata output. The rule engine module 212 may include a plurality of rules such as, for example, if category 1 conditions 324, if category 2 conditions 326, if category 3 conditions 328 and the like. In case of high confidence score, the action engine module 214 may include actions such as, for example, update master data 330, send email 332, and the like. In case of low confidence score, the agent routing engine 216 may include agent actions such as, for example but not limited to, agent experience 334 and agent training 336. Further, the agent review and actions 306 may include review results 338, and update master data 340.

FIG. 3C illustrates an example block diagram depicting various modules 114 of the system 102 such as those shown in FIG. 2, capable of medical advertisement compliance solution as a workflow, in accordance with embodiments of the present disclosure. In an example workflow of a medical advertisement compliance solution, as shown in FIG. 3C, AI is leveraged to provide feedback on existing medical advertisements. For example, AI may automatically identify if the age of the person in the advertisement is appropriate based on medication specs. Further, the AI may identify objects in the advertisement that might not be legally allowed for advertisement in some countries such as “Beer” and “Tobacco”.

In this example, the data connector module 206 may include an image shared folder connector 342 for extracting information from medical advertisement images. The pre-processor module 208 may include pre-processing functional modules such as check image license 344, remove salutations 312 and split in sentences 314. The AI detectors 302 may include object detector 346, age detector 348 and text entity detector 350 to perform one or more functional tasks on the medical advertisement images and select the appropriate AI and Generative AI service nodes to create an AI-based workflow. The data fusion 304 may include fuse person with age 352 to fuse the detected age and person for generating the fused metadata output. The rule engine module 212 may include a plurality of rules such as, for example, if policy 1 triggers action 1 354-1, if policy 2 trigger action 2 354-2, if policy 3 trigger actions 3 354-3 and the like. In case of high confidence score, the action engine module 214 may include actions such as, for example, highlight violation 356, recommend modification 358 and the like. In case of low confidence score, the agent routing engine 216 may include agent actions such as, for example but not limited to, agent experience 334 and agent training 336. Further, the agent review and actions 306 may include review results 338 and modify content 360.

In another example, a use case may be to tag contents for advertisements. For example, content generation for advertisers may require retrieving content (images, videos, documents) from a database. For this process to be efficient, content needs to be tagged or annotated with metadata related to what the content may be about. This enables fast search and retrieval of content for content generation. In such a case, the AI detectors may include object detection, an activity detection, a translation, and an optical character recognition (OCR). The actions may include label images and video content with metadata and insert content labels into repository for search enablement.

In yet another example, a use case may be to perform an advertisement impact analysis. For example, this use case requires detecting the impact of advertisements with respect to human acceptability and impact in dimensions such as emotion and written comments depending on gender and age. In such a case, the AI detectors may include emotion detection, text entity detection, gender detector, and age detector. The actions may include identifying the impact of advertisements, modifying add content based on impact analysis.

In yet another example, the use case may be to perform a non-fungible token (NFT) copyright infringement detection. For example, there may be a need to identify illegal variations to NFTs in marketplaces and prevent their transactions. In such a case, the AI detectors may include similarity detector, object detector, OCR detector, translation detector and text entity detector. The actions may include identifying illegal variations to NFTs for preventing illegal NFT transactions.

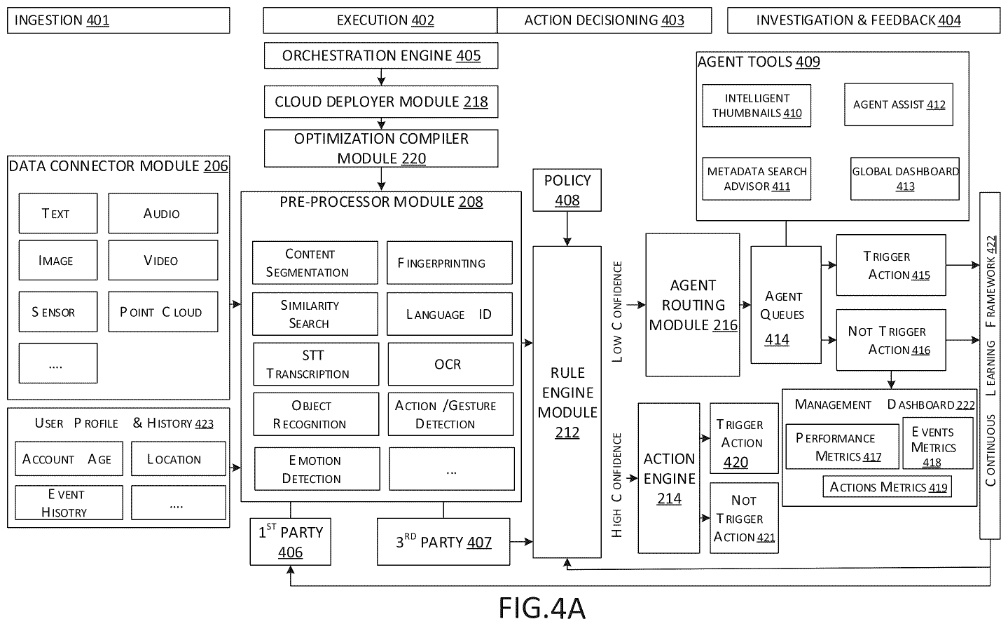

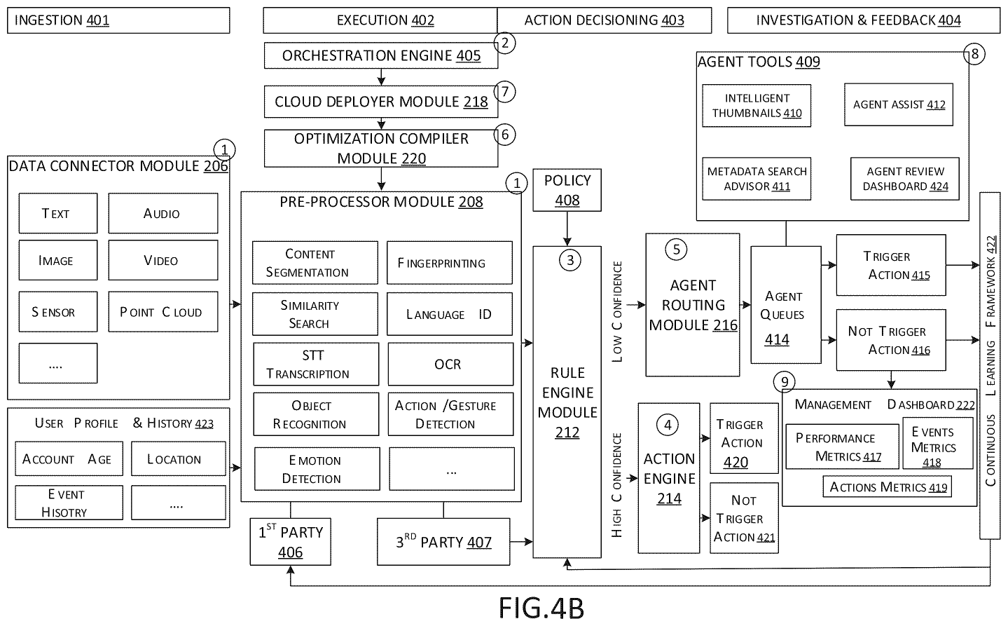

FIGS. 4A-B illustrates example block diagrams depicting a platform 400 for creating intelligence (AI) and generative AI based workflows, in accordance with embodiments of the present disclosure. The platform 400 may be deployed within the system 102 for creating intelligence (AI) and generative AI based workflows. In FIGS. 4A-B, the platform 400 may involve four phases including an ingestion stage 401, an execution stage 402, an action decisioning stage 403, and an investigation and feedback stage 404. In an example embodiment, the ingestion stage 401 may include data connector module 206 and a user profile and history module 423. The execution stage 402 includes an orchestration engine 405, a cloud deployer module 218, an optimization compiler module 220, and a pre-processor module 208 that is linked to a first party 406—and third-party entities 407. The pre-processor module 208 receives input data from the data connector module 206 and the user profile and history module 423. Further, the pre-processor module 208 pre-processes the received data and outputs a metadata to a rule engine module 212. The action decisioning stage 403 may include a policy module 408, the rule engine module 212, which routes low confidence event instances to an agent routing module 216 and high confidence event instances to an action engine 214. The action decisioning stage 403 further includes trigger action 420 and non-trigger actions 421 resulting from the action engine 214. The investigation and feedback stage 404 may further include agent tools 409 such as, for example, but not limited to, intelligent thumbnails 410, an agent assist 412, a metadata search advisor 411, and global dashboards 413. The investigation and feedback stage 404 further includes agent queues 414, that outputs a trigger action 415 and a non-trigger action 416 that is fed into a continuous learning and feedback framework 422. The continuous learning and feedback framework 422 provides feedback to the rule engine module 212 and the first party 406. The trigger actions and non-trigger actions from the action decisioning stage 403 and the investigation and feedback stage 404 are fed into management dashboard 222 included in the investigation and feedback stage 404.

In an exemplary embodiment, the AI service node may include library of data connectors, pre-processors, and AI and Generative AI services, to compose AI solutions in minutes. The platform 400 may include a graphical user interface (GUI) for various stages described above. For example, the platform 400 may include the GUI for a workflow composer module 210 and an event visualizer module. The orchestration engine 405 instantiates the AI solution workflow and manages data communication with AI service node execution in the right sequence according to the workflow. The rule engine module 212 may be an AI-based rule engine supporting configurable rules on the fly represented in human readable JSON format and associated graphical editor. The GUI interface associated with such rule engine module 212 may include a rule editor. The action engine 214 is responsible for executing the associated actions from an available pre-built library of actions and associated editor to associate actions with rules. The GUI interface associated with the action engine 214 may include an action editor. The agent routing module 214 obtains a detected event with low confidence and routes the event to the best available human (or agent) for actioning based on availability, past experience, trainings, and certifications. The GUI interface associated with the agent routing module 214 may include a routing dashboard. The optimization compiler module 2200 obtains the workflow descriptors and service processing node descriptions to generate a new execution graph which may be more compute efficient. The cloud deployer module 218 obtains the optimized workflow descriptor and deploys them on a target cloud. The management dashboard 222 provides a graphical display of performance metrics 417, agent metrics, events metrics 418, and actions metrics 419.

The platform 400 may enable in the AI-based workflow, as part of creating an AI solution, the creation of libraries and other components that may be re-used for different use cases by organization across multiple clients. The platform 400 also enables creation of subcomponents, provides features to: drag and drop the components/sub-components into an interface, establish connections between the components/sub-components, create the AI-based workflow that may read data from different sources (e.g., audio, video, images, documents), processors that take the data and convert (e.g., filter text, filter images), and provide AI and Generative AI services (e.g., perform OCR from an image data to detect text, detect emotion in speech). In an example embodiment, the components, connections, and services of the platform 400 may be re-used to create a new AI solution for a new use case in a matter of minutes. Such a solution can be deployed to target cloud as specified in about a few hours.

In an example embodiment, the platform 400 works for a batch-data and a real-time data. Further, the rule engine in the conventional systems may include hardcoded rules specific to a solution. The platform 400 implements a rule engine module 212 which has an associated rule editor using which an action may be defined that the AI needs to execute. The rule engine module 212 is configurable and is a part of the customizable AI-based workflow.

In some example embodiments, a framework or a workbench are provided to create AI solutions or applications for a given use case using re-usable components, the data connector module 206, the pre-processor module 208, the rule engine module 212 and the like. The AI solution or application or AI based workflow thus created may be connected to any third-party systems to achieve desired objective in a matter of few hours. In an example embodiment, the orchestration engine 405, the cloud deployer module 218 and the optimization compiler module 220 may be configured to allow creation of a new AI solution by re-using the pre-created components, connections, and rules. For example, the orchestration engine 405 may use the description of the AI-based workflow which was created by the “drag and drop” operation and deploys it at the target cloud using the cloud deployer module 218. The orchestration engine 405 may use the description and AI-based workflows and instantiates them as required. In another example, the optimization compiler module 220 optimizes the AI-based workflows based on the execution speed and performs appropriate changes such that the created AI solution may be suitable for cloud deployment by the cloud deployer module 218. In an example embodiment, the orchestration engine 405 may parse the obtained data and flow the data through different components of the system 102 (e.g., connectors 206, pre-processor module 208, rule engine module 212 and the like). In an example embodiment, the orchestration engine 405 may supervise each node or component while performing the respective tasks assigned to the respective node or component. The orchestration engine 405 may monitor each node or component and take the responsibility to ensure that each node or component completes the tasks assigned before the data is handed over to the next node/phase.

In an example embodiment, the platform 400 provides a workflow composer module 210 using which a new workflow may be created by “drag and drop” operations in few minutes. In some examples, plurality of modules or components or AI and Generative AI service nodes which have been selected are connected to each other to create the AI-based workflow which may then be stored and deployed on a cloud system within few hours. In an example embodiment, the platform 400 may provide a plurality of custom tools which include connectors 206, pre-processor module 208, rule engine module 212, AI inference, metadata fusion, agent routing module 216, action engine module 214 and the like. These tools enable creation of the AI-based workflow in a few minutes. In an example, an AI inference tool may be used for any process that requires application of AI. For example, the AI-inference tool may be used in a scenario where gender detection has to be performed based on speech or voice as input data.

In some embodiments, use cases may define the requirements with respect to what has to happen at each AI-service node. For example, the AI-based workflow may include one or more AI-based service nodes. Each of these AI-based service nodes may include a processing node. The requirements of the use case may pertain to specifying each service and also the sub-step in each service. In such an embodiment, data flows through the AI-based workflow and each AI service node obtains the data, processes the data, and produces a corresponding metadata. For example, in the use case of detecting emotion of a person based on speech, the data could be a five second window of audio and the metadata (output) generated by the AI service node may be an inference that “the speaker was happy during the five seconds”. Similarly, additional metadata may be generated based on the next window of audio that provides inference that “the speaker was angry for next 10 seconds”. In an example embodiment, the metadata summarizes the data and provides an output based on an input dataset. Depending on the metadata, various locations may be specified. For example, the time duration may be 0 to 10 seconds and the location may specify the time duration range. In another example, if the AI service node detects knives and guns in an image, the metadata may correspond to “knives and guns present in the image” and the location may specify a bounded box (capturing the knives and the guns in the image).

In an example embodiment, all such metadata is used by the rule engine module 212. The rule engine module 212 may not operate on raw data. For example, the rule engine module 212 may use the metadata (e.g., “gun detected”, “person happy”) and may apply further rules with confidence values that may be customized using the rule editing feature provided by the platform 400. The rule engine module 212 may also program the actions to be taken based on the metadata, the rules, and the confidence values.

In an example use case, it may be desirable to detect an emotion based on an audio file. The input data may be audio-visual data or a video. The AI-based workflow may include a video decoder to decode the video, a segmentation module to separate the audio track and emotion detection module that detects the emotion of a person based on the audio track. In an example embodiment, the service descriptor may define the AI service (or service node) and the sub-steps (or the processing nodes) therewithin. For example, the service descriptor specifies the video decoding format and the location on the image or time stamp for audio detection. The workflow descriptor may define the way the data flows through different service nodes (defined by service descriptors). The workflow descriptor defines the manner in which the different services are concatenated or connected and also specifies what each service node is supposed to do. In an example embodiment, the service and workflow descriptor may be provided using JSON format. In an example embodiment, the service and workflow descriptors may be software codes using JSON format.

Further, each of the service nodes may include a plurality of processing nodes. For example, a service node such as, the emotion detection module may include processing nodes such as segmentation module, preprocessor, feature extractors, and the like. In an example embodiment, the processing node descriptors are defined using the JSON format. The processing node descriptors may be used later by the optimization compiler module 220 to determine opportunities to perform entire processing more efficiently. For example, if the feature extractor service occurs two times in a given workflow, the optimization compiler module 220 may detect such an occurrence and may run or execute the feature extractor service once instead of two times to make the process more efficient.

In an example embodiment, a data entity format may be defined to accommodate multiple types of data that may flow through the system 102 or a given workflow for achieving generality. For example, any raw data (e.g., audio, video, text) as input is stored and represented in JSON format. Therefore, any node takes the data in JSON format, generates metadata, or transformed data that is again stored in JSON format, and passes on to the next node. There are numerous advantages of using JSON format for representing data and descriptors for workflow and services. For example, JSON format is human readable and simple enough to handle structured data used in AI solutions and systems. In an embodiment, any other format that is human readable and simple to understand and customize may be used in place of JSON format without deviating from the scope of the ongoing description.

In an example embodiment, as the data flows through the AI-based workflow (from left to right), each AI service node generates and embeds the metadata into the data. The new data entity that includes one or more such metadata may be stored and represented using the JSON format. Such a flexibility allows the system 102 to accept addition of a new data type such as, but not limited to, “point cloud” (a discrete set of data points in 3-Dimensional space) without the need of any additional coding. The inclusion of a new data type may be achieved by specifying the data type as “point cloud” and storing the associated file at the particular URL. The system 102 may recognize the data type and the data is picked up from the URL and the data flows through the AI-based workflow as described above.

In an example embodiment, the platform 400 may include built-in AI and Generative AI services. Such AI and Generative AI services may include a plurality of libraries. An example list of built-in libraries is shown in Tables. 1 and 2 below. As described earlier, the libraries are re-usable across multiple systems and use cases.

TABLE 1

| Type | Modality | Name | Description | Implementation |
|---|---|---|---|---|
| Pre-Processing | Video | Audio Video | Separate the | Custom |
| | | Segmentation | Audio from | |
| | | | a video | |
| AI Inference | Video | Activity | Detect human | Custom |
| | | Detection | gestures and | |
| | | | actions from | |
| | | | video | |
| AI Inference | 3D cloud | Activity | Detect human | Custom |
| | points + | Detection | gestures and | |
| | Controller | | actions from | |
| | Commands | | video | |
| AI Inference | Audio | Speech-to-Text | Convert spoken | Cloud |
| | | Transcription | audio signal | |
| | | | into text | |
| AI Inference | Text | Text Entity | Detect | Custom |
| | | Detection | confidential | |
| | | | information and | |
| | | | other entities | |
| | | | from text | |
| AI Inference | Audio | Emotion | Detect emotion | Custom |
| | | Detection | of a person from | |
| | | | spoken audio | |
| AI Inference | Text | Emotion | Detect emotion | Custom |
| | | Detection | of a person from | |
| | | | written text | |
| AI Inference | Audio | Age | Identify age | Custom |
| | | Detection | of a person | |
| | | | speaking | |
| AI Inference | Audio | Gender | Identify gender | Custom |
| | | Detection | of a person | |
| | | | speaking | |
| AI Inference | Image | OCR | Identify text | Cloud |
| | | | in an image | |
| AI Inference | Text | Language | Translate | Cloud |
| | | detection and | text to target | |
| | | Translation | language | |
| AI Inference | Image | Similarity | Compute | Custom |
| | | Detector | similarity score | |
| | | | across images | |
| AI Inference | Video | Similarity | Compute | Custom |
| | | Detector | similarity score | |
| | | | across images | |

TABLE 2

| | | | | Implemen- |
|---|---|---|---|---|
| Type | Modality | Name | Description | tation |
| AI | Image | Object | Detect objects in | Cloud |
| Inference | | Detection | an image | |
| AI | Image | Face | Detect objects in | Custom |
| Inference | | Detection | an image | |
| Metadata | Audio + | Emotion | Fuses output of | Custom |
| Fusion | Text | Detection | emotion detection | |
| | | Fusion | from Audio and | |
| | | | Text | |
| Data | Video | Video | Decode a video | Custom |
| Input | | Decoder | file in mp4 format | |
| Data | Audio | Audio | Decode an audio | Custom |
| Input | | Decoder | file in mp3 format | |
| Data | Image | Image | Decode an image | Custom |
| Input | | Decoder | in .jpg format | |
| Data | Image | Document | Decode a | Custom |
| Input | | Decoder | document in word | |
| | | | and pdf format | |
| Action | email | Email | Notify someone of | Custom |
| | | notification | an even via email | |
| Action | User | Update user | Update a user | Custom |
| | Profile | profile | profile property | |
| AI | Video | De-duplication | Detects videos | Custom |
| Inference | | Detector | and images that | |
| | | | have already been | |
| | | | processed and | |
| | | | stored in a | |
| | | | database. | |

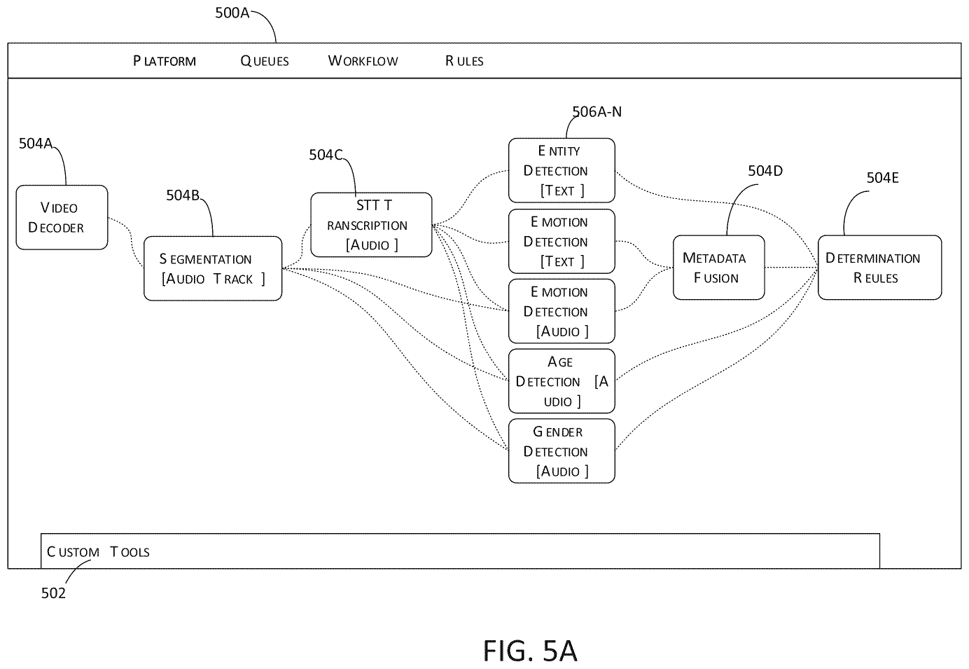

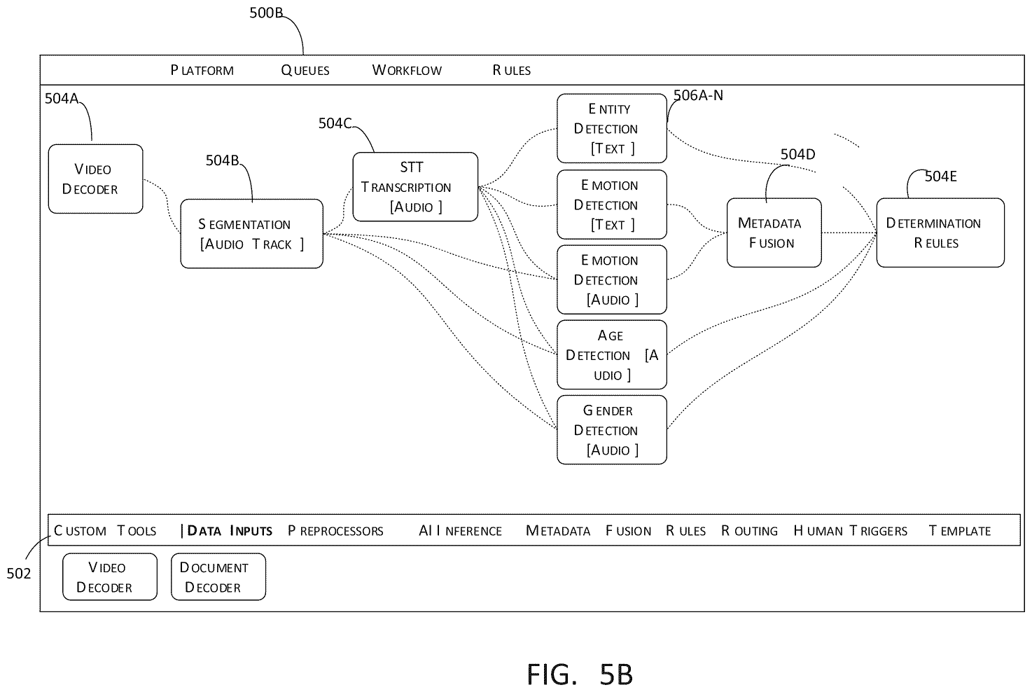

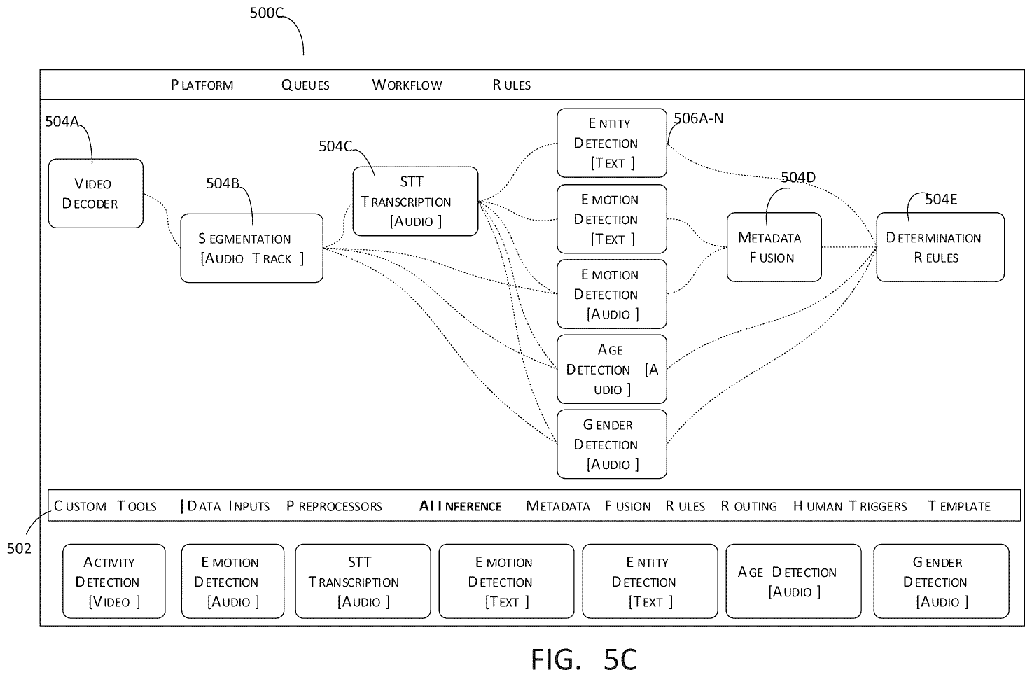

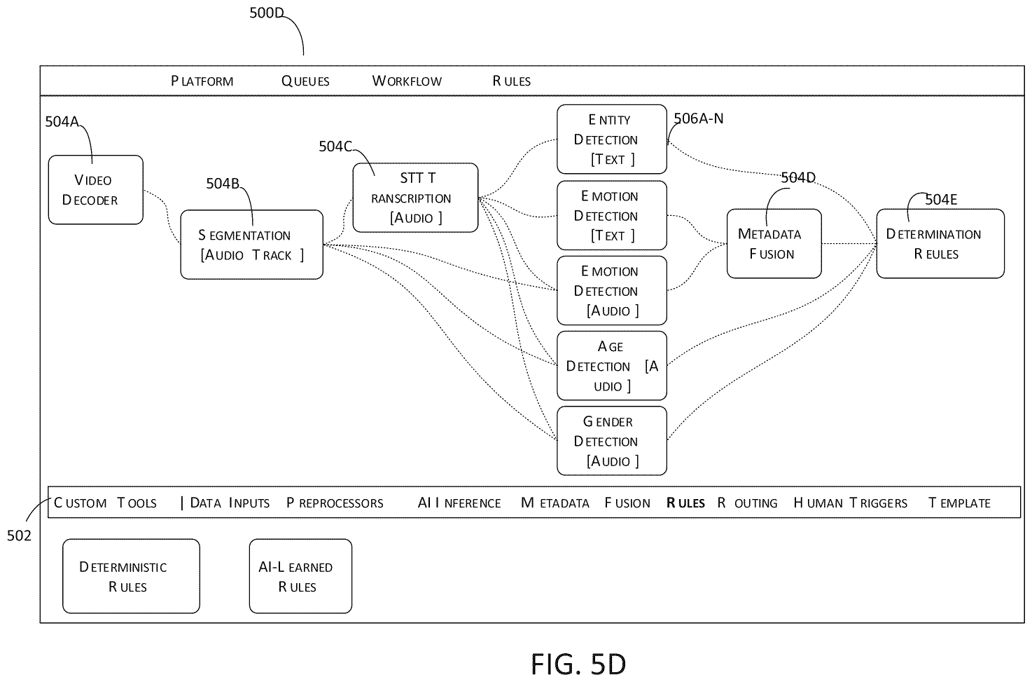

FIGS. 5A-D illustrates graphical user interfaces (GUIs) of a workflow composer module 210, such as those shown in FIG. 2, capable of generating AI—and generative AI based workflows, in accordance with embodiments of the present disclosure. The platform 500 provides for a workflow composer module 210 which may be used for creating workflows in real time by a user using simple operations such as, “drag and drop” for instance. The objective for providing the workflow composer module 210 is codeless graphical interface for composing AI-based workflow in a short duration (e.g., few minutes). In an example embodiment, the AI-based workflows specify the services that a given AI solution may use and in which sequence they may be executed. Each workflow may be an AI solution in itself that may be deployed to the cloud with the press/click of a button. In an example embodiment, the input data may be a JSON file descriptor for workflow and target cloud instantiation of each component service. In an example embodiment, the workflow composer module 210 is configured to coordinate the data flow and execution of each AI and Generative AI service node from input stage to output stage to accomplish the desired workflow task. The workflow composer module 210 provides a plurality of features for the user to interact with the platform 400. For instance, the user may drag and drop AI and Generative AI based service nodes (e.g., data sources, processors, AI detectors, Generative AI detectors, rule engines) into the GUI screen and connect them into a graph. In an example embodiment, the AI and Generative AI service nodes may be executed sequentially or in parallel to achieve a particular AI solution use case.

In an example embodiment, the workflow composer module 210 includes a plurality of custom tools that can be used to create the workflows for a given use case. The custom tools may include data inputs, preprocessors, AI inference, metadata fusion, rules, routing, and the like. Each of these tools corresponds to a service and may be clicked on the interface to access the options under a given tool. For example, the data inputs correspond to connector options that include video decoder and document decoder as shown in FIG. 5B. In another example, the AI inference or AI and Generative AI services may include activity detection (Video), emotion detection (Audio), STT Transcription (Audio), emotion detection (Text), entity detection (Text), age detection (Audio), and gender detection (Audio) as shown in FIG. 5C. In yet another example, the rule or rule engines that may be added to the workflow to define actionable rules over data and the detected metadata. Examples of rules may include deterministic rules and AI learned rules as shown in FIG. 5D.

FIG. 5B depicts a graphical user interface (GUIs) of a workflow composer module 210 depicting a data input connector as a custom tool, in accordance with embodiments of the present disclosure. The data input connectors may include for example, but not limited to, a video decoder and a document decoder. FIG. 5C depicts a graphical user interface (GUI) of a workflow composer module 210 depicting an AI inference services as a custom tool, in accordance with embodiments of the present disclosure. The AI inference services may include for example, but not limited to, activity detection for video file, emotion detection in audio file, STT transcription of audio file, emotion detection in a text file, entity detection in a text file, age detection in an audio file, and gender detection in an audio file. FIG. 5D depicts a graphical user interface (GUIs) of rule engine module 212 as a custom tool, in accordance with embodiments of the present disclosure. The GUI depicts examples of “Rule Engines” that may be added to the flow to define actionable rules over data and metadata detected. The rule engine module may include for example, but not limited to, deterministic rules, and AI learned rules.

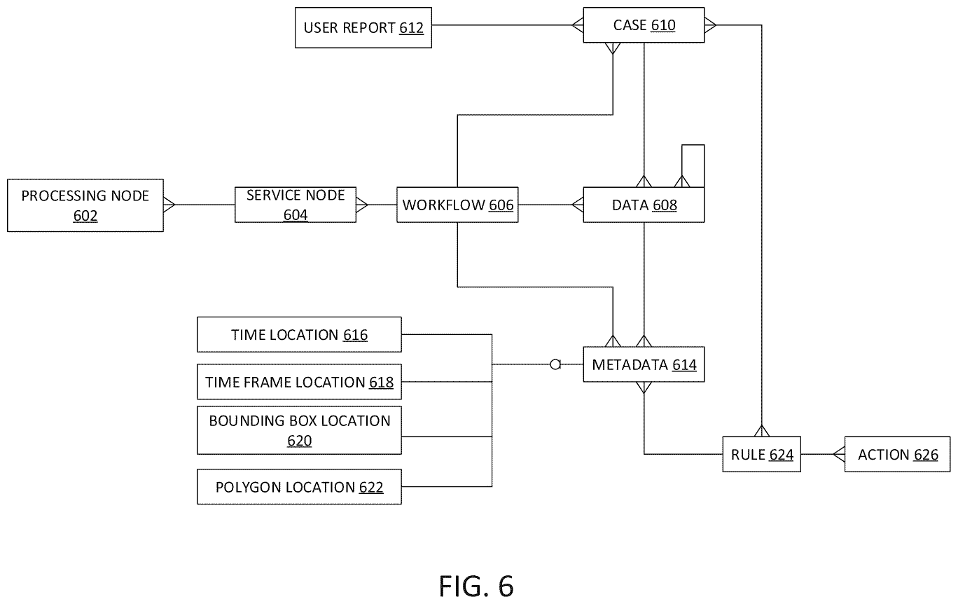

FIG. 6 illustrates a data flow diagram of system entities and relationships between the system entities, in accordance with embodiments of the present disclosure.

Table. 3 lists various example entities in the system 102 along with an entity type and a corresponding description.

TABLE 3

| Entity | Type | Description |
|---|---|---|
| Workflow 606 | Workflow | The workflow describes the |
| | | interconnected directed |
| | | acyclic graph (DAG) of services |
| | | that need to be executed, their |
| | | order of execution, configuration. |
| Service Node 604 | Service | Service nodes are full services |
| | | that can be arranged in |
| | | a workflow such as data |
| | | decoders, processors, segments, |
| | | AI detectors and Generative AI |
| | | detectors and their configuration. |
| Processing Node | Node | Service nodes are composed |
| 602 | | internally by a DAG of processing |
| | | nodes, each for which performs |
| | | specific reusable computation |
| | | within or across services. |
| Data 608 | Data | Structure for holding any type of |
| | | data flowing through the workflow, |
| | | such as video, Images, audio, |
| | | text, cloud points, and the like. |
| Metadata 614 | Metadata | Structure holding metadata |
| | | information or “data summaries” |
| | | in the form of events |
| | | detected by AI, generated |
| | | by fusing several |
| | | metadata pieces and other processing |
| Rule 624 | Metadata | Represents a rule that defines |
| | | conditions over metadata to trigger |
| | | automation actions in the system. |
| Rule Sets | Metadata | Represents sets of rules that |
| | | have something in common (e.g., |
| | | policies for regions, units, |
| | | environments, and the like). |
| Action 626 | Metadata | Represents the automation or action |
| | | to take after a rule has triggered. |
| | | This actions can be assembled |
| | | into libraries of actions |
| Case 610 | Metadata | Represents a case that needs |
| | | to be reviewed or resolved |
| | | by a human agent or |
| | | automatically documented by AI. |

In an example embodiment, the user report 612 may be generated for each case 610 based on the generated workflow 606. Further, the metadata 614 may include a time location 616, a time frame location 618, a bounding box location 620 and a polygon location 622.

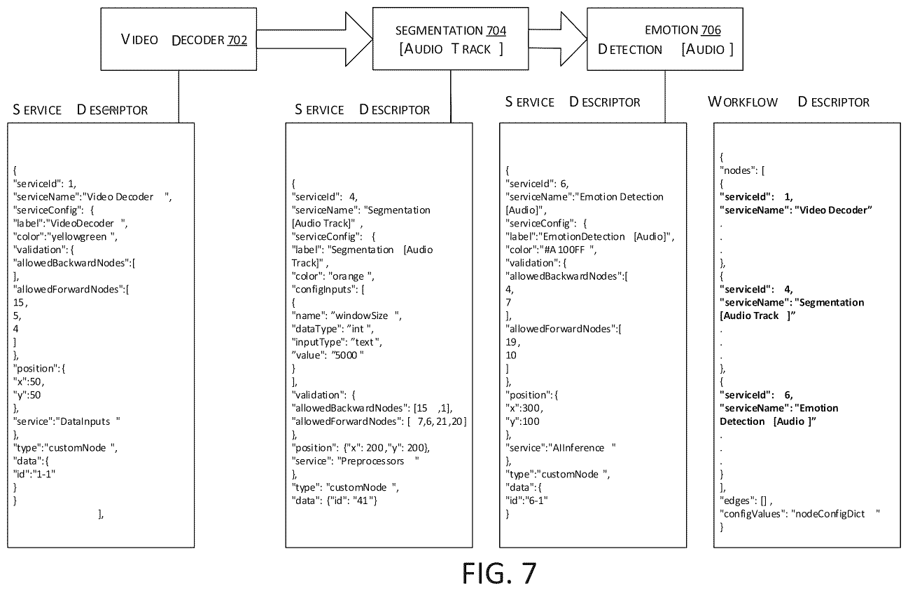

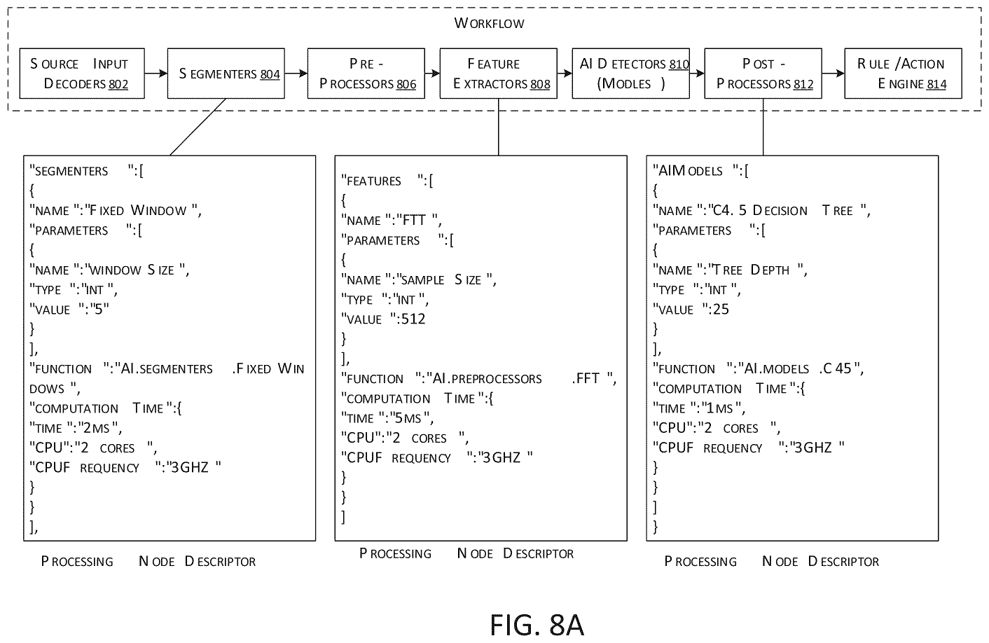

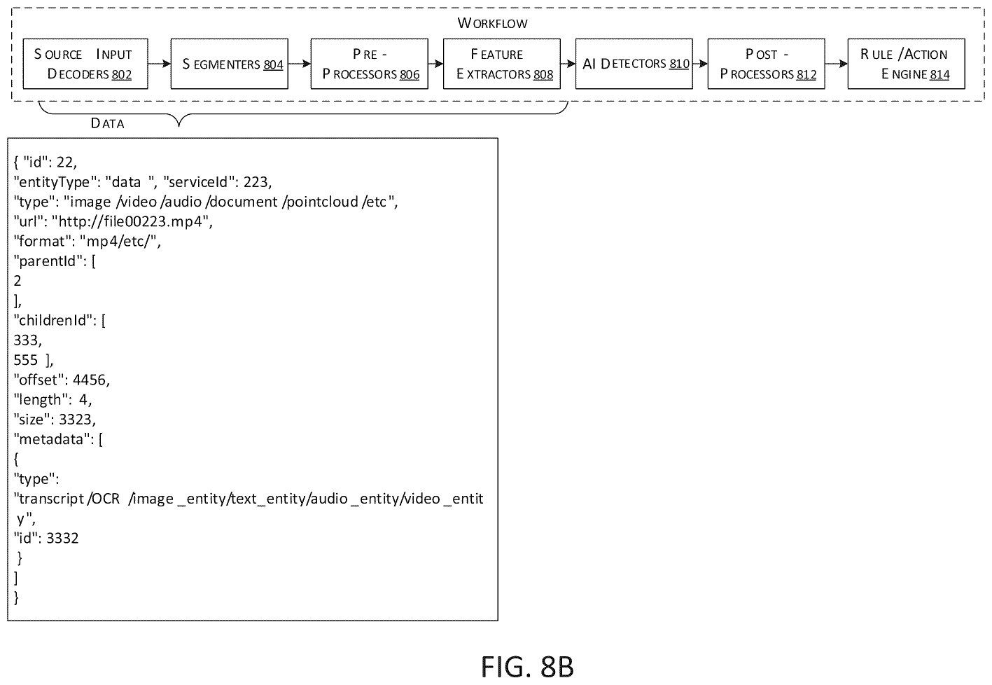

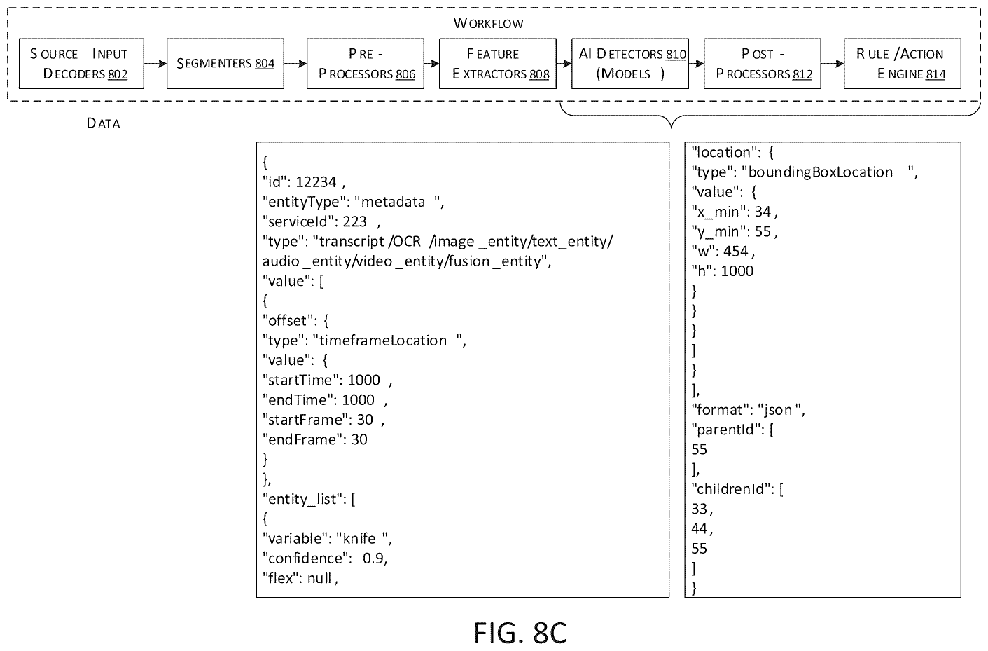

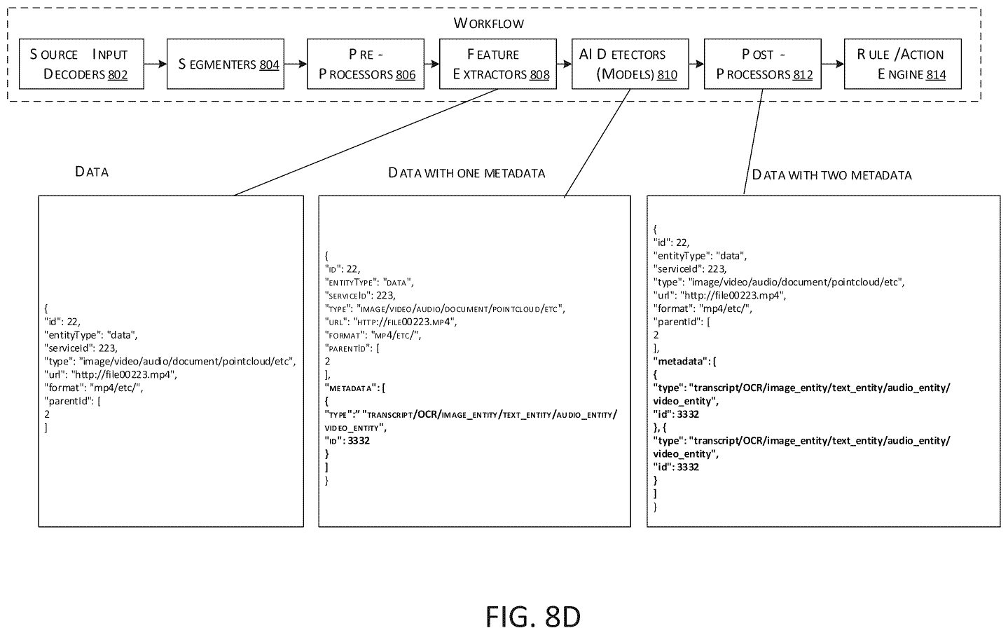

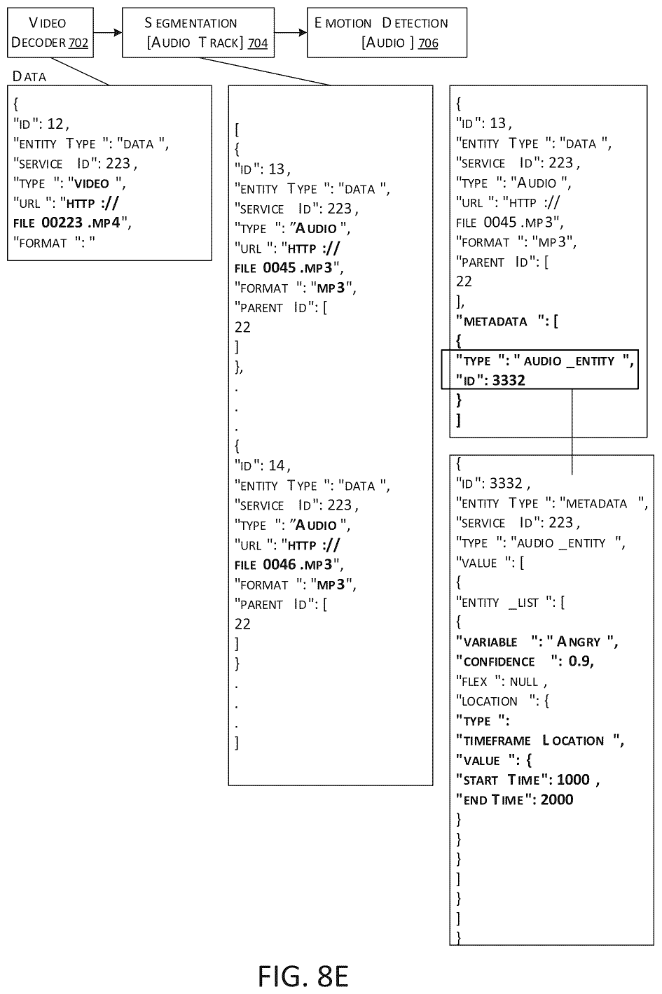

FIG. 7 illustrates a block diagram of an example workflow and service descriptors of AI and Generative AI services included in the workflow, in accordance with embodiments of the present disclosure. An example workflow for emotion detection of a user based on audio or speech is depicted. Accordingly, there may be three service nodes, namely, a video decoder 702, a segmentation (Audio track) 704 and an emotion detection (audio) 706. As shown, the workflow descriptor may be a concatenation of all service descriptors in JSON format. In an example embodiment, each service node may include one or more processing nodes, each of which has its own description in JSON format. An example set of processing nodes and their descriptors is shown in FIG. 8A. As shown, the emotion detection (audio) 706 service node may include processing nodes such as segmenters 804, pre-processors 806, feature extractors 808, AI detectors (Models) 810, post-processors 812, and rule/action engine 814.

FIG. 8B illustrates a block diagram of a data entity and a format for a sample workflow, in accordance with embodiments of the present disclosure. One of the conditions for re-usability of components (e.g., services) may be the representation of data 608 in the system 102 as it flows through the service nodes 604 and the processing nodes 602. The platform 400 has two data objectives: representing raw or transformed data and metadata 614 for storing events detected by the AI. In an example embodiment, the data 608 and a metadata 614 (or transformed data) may be represented using a JSON format. Any input raw data may be represented as JSON such that any new data types (e.g., image, video, cloud point) may be added easily as new source input decoders are created. In an example embodiment, as the data passes through the segmenters 804, the pre-processors 806 and the feature extractors 808, the data gets transformed however maintains the same JSON format and structure for generality.

FIG. 8C illustrates a block diagram of a metadata entity and a format for a sample workflow, in accordance with embodiments of the present disclosure. In an example embodiment, as data passes through the AI detectors 810, post-processors 812 (e.g., data fusion across data modalities) and rule/action engines 814, the data may be transformed into metadata objects. These metadata objects may be “summaries of the raw data” in the form of events of different types. In an example embodiment, the metadata objects are attached to the data object that generates it as it passes through AI and Generative AI service nodes 604. As shown in FIG. 8D, the data, data with one metadata and data with two metadata are represented in JSON format. FIG. 8E shows a data and a metadata flow example with the service descriptors in JSON format. At the segmentation (Audio track) 704, the audio data may be split into windows. Further, the emotion detection (audio) 706 may include an audio data for one window with metadata attached to it. Further, the attached metadata for audio detection is shown.

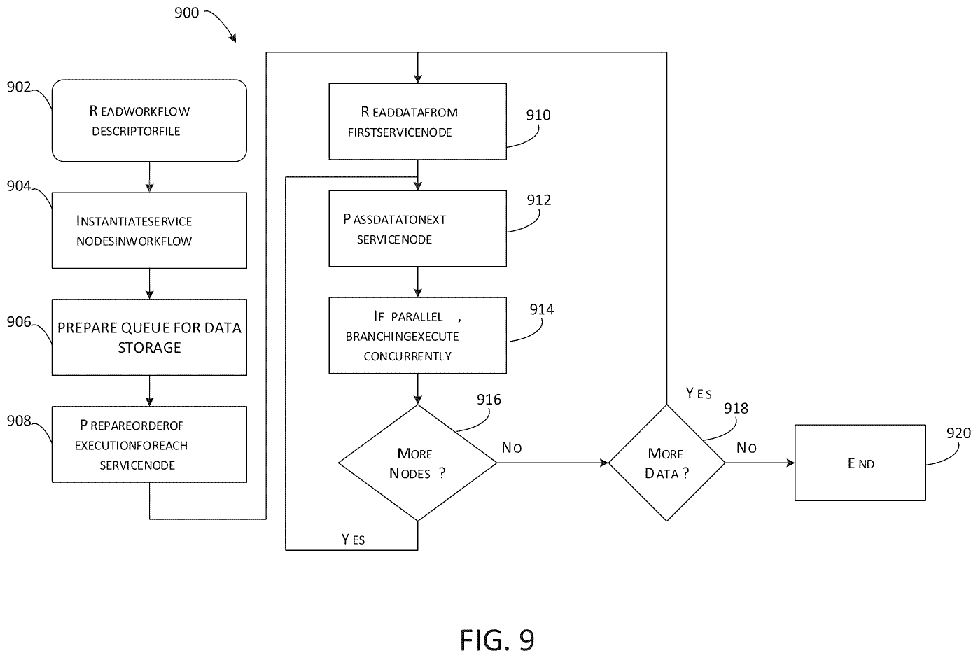

FIG. 9 illustrates an example block diagram depicting a process 900 performed by the orchestration engine 405, in accordance with embodiments of the present disclosure. In an example embodiment, the orchestration engine 405 may be implemented in the platform 400. One of the objectives for the orchestration engine 405 may be to ingest a JSON description file of a computationally optimal workflow and deployed components at the target cloud to coordinate the data flow from input to output and execution across each node to accomplish the desired task. In an example embodiment, the input data to the orchestration engine 405 may be a JSON file descriptor for workflow (service nodes and processing nodes) and a target cloud instantiation of each component service. In an example embodiment, the output of the orchestration engine 405 may be to supervise coordination of the data flow and execution of each service node from input to output to accomplish the desired workflow task. In an embodiment, the orchestration engine 405 may provide features that may include a cloud vendor independent coordination of data flow and a service processor execution. At step 902, a workflow descriptor file is read. At step 904, service nodes in a workflow are instantiated. At step 906, a queue for data storage is prepared. At step 908, an order of execution for each service node is prepared. At step 910, data from a first service node is read. At step 912, the data is passed to a next service node. At step 914, service nodes are executed concurrently if there is a parallel branching. At step 916, it is determined whether there are more nodes. In case there are more nodes, the loop goes back to step 912. In case there are no more nodes, then at step 918, it is determined whether there is more data to be read or processed. If yes, then the loop goes back to step 908. If no, then at step 920, the process is terminated.

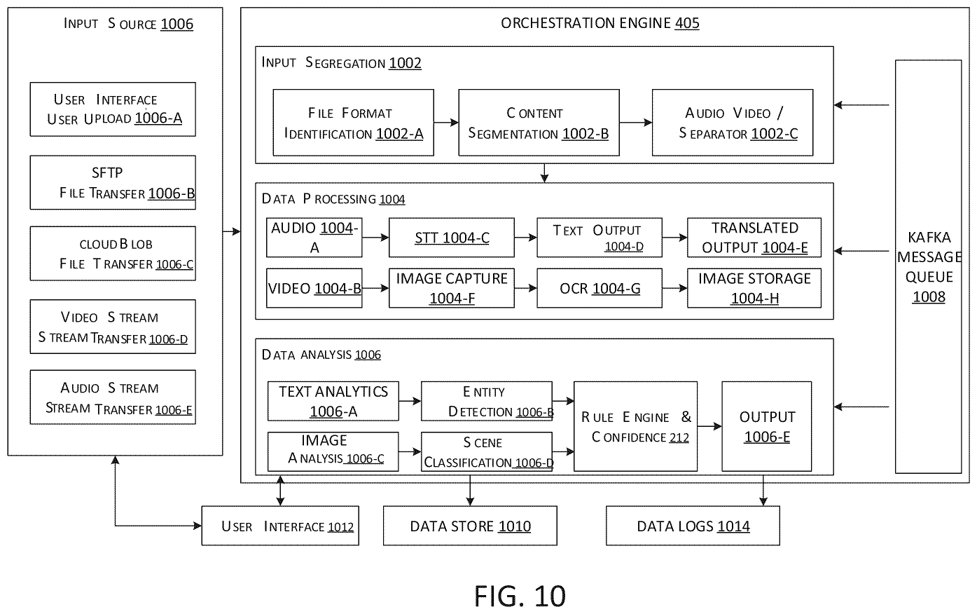

FIG. 10 illustrates a high-level architecture diagram of the orchestration engine 405, in accordance with embodiments of the present disclosure. As shown, the input sources 1006 may include a user interface 1006-A (upload by user), a SFTP 1006-B (file transfer), a cloud blob 1006-C (file transfer), a video stream 1006-C (stream transfer), an audio stream 1006-D (stream transfer) and the like. The output from the input source 1006 is fed to the orchestration engine 405. In an example embodiment, the orchestration engine 405 may include subcomponents such as, an input segregation 1002, a data processing 1004, and a data analysis 1006 that feed into a KAFKA message queue 1008. The orchestration engine 405 may communicate with a data store 1010, a user interface 1012 and data logs 1014. In an example embodiment, the input segregation 1002 may include a file format identification 1002-A, a content segmentation 1002-B, and an audio/video separator 1002-C. The data flows from the file format identification 1002-A to the audio/video separator 1002-C. The output of the input segregation 1002 is fed into the data processing 1004. The data processing 1004 may include an audio file 1004-A, and a video file 1004-B. The audio file 1004-A is then fed to STT 1004-C, a text output 1004-D, and a translated output 1004-E. Further, the video file 1004-B is fed image capture 1004-F, an OCR 1004-G, and an image storage 1004-H. The output of the data processing 1004 is fed to the data analysis 1006. The data analysis 1006 may include text analytics 1006-A, an entity detection 1006-B, an image analysis 1006-C, and the scene classification 1006-D. The output of the entity detection 1006-B and the scene classification 1006-D are fed to rule engine and confidence 212 and an output 1006-E is generated.

FIG. 11 illustrates a technical architecture diagram of the orchestration engine 405, in accordance with embodiments of the present disclosure. The orchestration engine 405 may include a set of services 1102 such as, a frame capture 1102-A, a content segmentation 1102-B, an audio/video separator 1102-C, translation services 1102-D, a STT 1102-E, a scene classification 1102-F, an entity extraction 1102-G, and OCR services 1102-H. In an example embodiment, a user may login 1104 to the orchestration engine 405 through the user interface 1106 and select one or more services from the set of services 1102. The selection leads to the creation of workflows based on selected services. In an example embodiment, the user interface 1106 may include a setup configuration 1106-A and upload and review modules 1106-B. The user interface 1106 communicates with the database 1108 to store data and configuration information. The input data 1110 may include stream 1110-A and/or a file 1110-B and may be fed to the streaming service 1112 and a file system 1114 to send data to one or more engines 1116. The engine 1116 stores data in the database 1108 and sends/receives messages from the messaging queue 1118. The engine 1116 may invoke the selected services from the set of services 1102 as required.

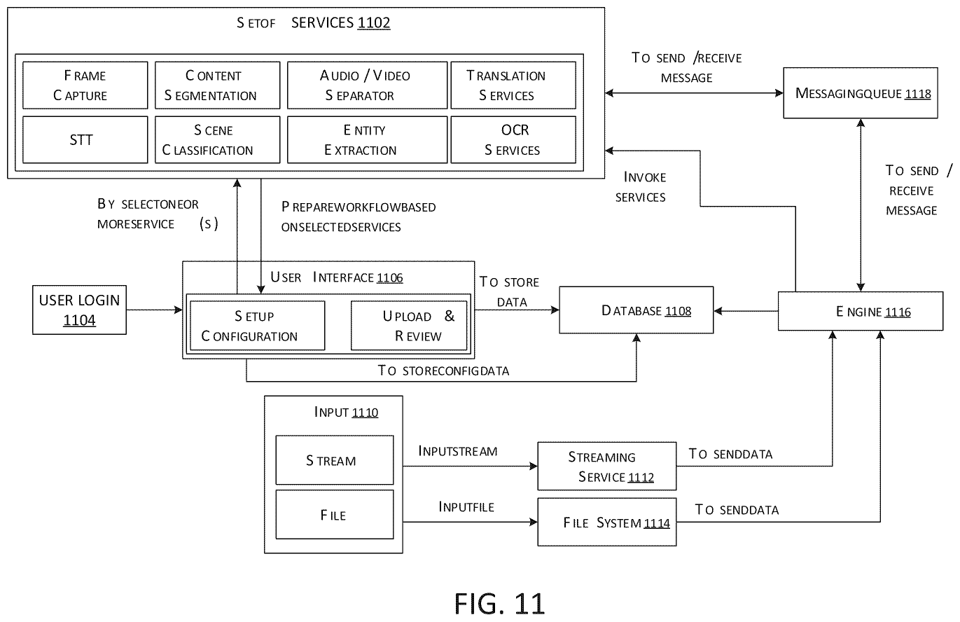

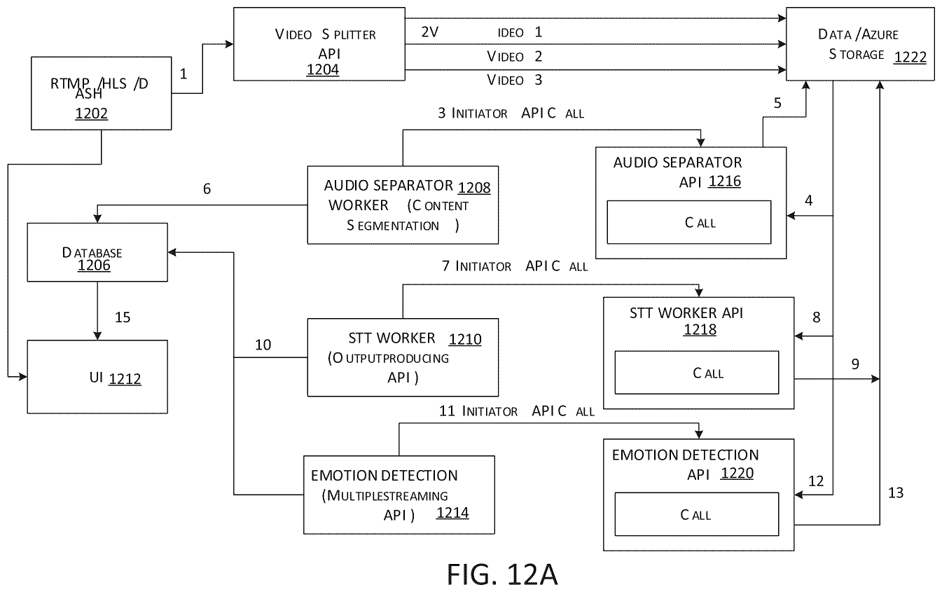

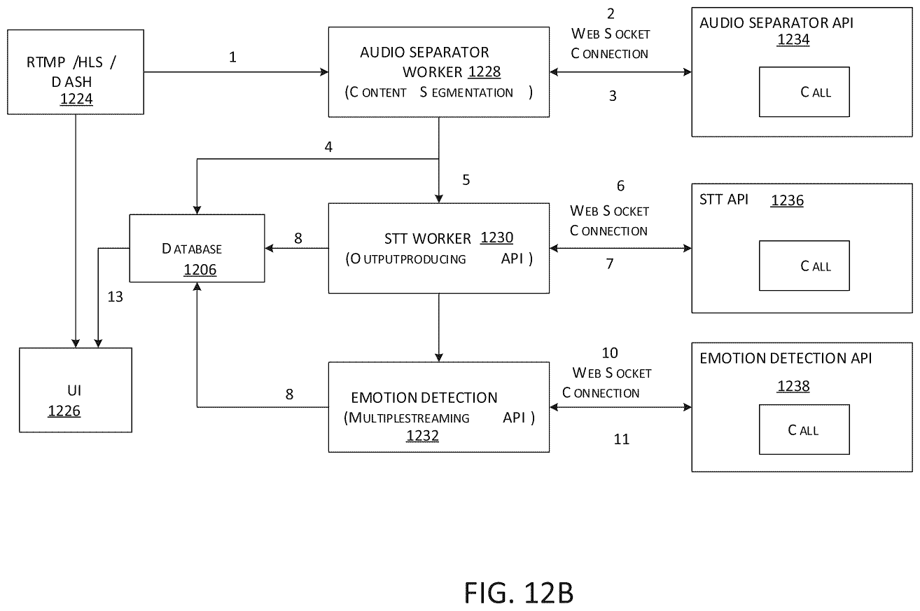

FIG. 12A illustrates a block diagram of an example file-based orchestration, in accordance with embodiments of the present disclosure. FIG. 12B illustrates a block diagram of an example streaming data orchestration, in accordance with embodiments of the present disclosure.

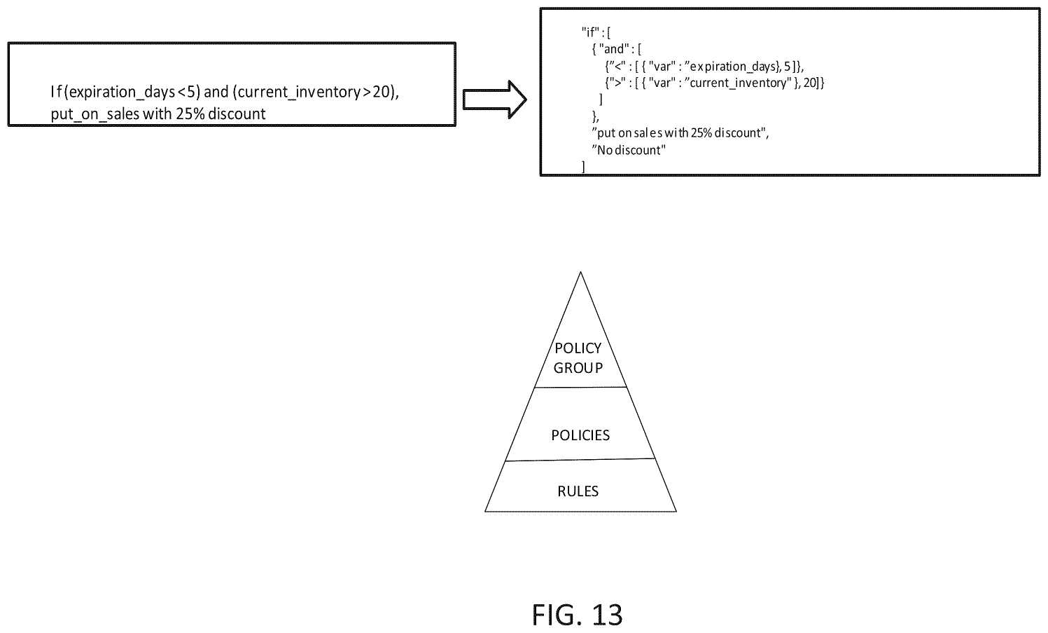

FIG. 13 illustrates a block diagram of an example rule representation, in accordance with embodiments of the present disclosure. The rules may be combined into groups, and the groups may be combined into policies. In an example embodiment, the policies may be defined at different hierarchical levels (e.g., regions, countries, production instances). For example, the rules may be logical statement using ifs, ANDs, ORs, and the like. The rules may be captured in JSON format which are actionable by the rule engine module 212. Further, the policies are groups of rules defined by the client and organized around themes. Furthermore, the policy groups may be groups of policies for a specific audience that could be defined by geography, age, and session type.

FIG. 14 illustrates a block diagram of an example rule engine module 212, in accordance with embodiments of the present disclosure. The platform 400 may include one or more rule engine modules 212. The objective of the rule engine module 212 is to implement rule engines supporting configurable rules on the fly represented in human readable JSON format and associated graphical editor. Another objective is to apply rules on data from AI and Generative AI services. In an example embodiment, the input 1402 to the rule engine module 212 may include rules and metadata from AI and Generative AI services. The rules and metadata may be represented in JSON format. For example, the input 1402 may include list of metadata, policy set IDs, parameter for metadata processing such as for example, window size (ms), offset (ms), duration threshold (ms), confidence option (max/avg) and the like. At step 1404, the input 1402 is processed using the metadata pre-processing 1404. The metadata pre-processing 1404 may include segment metadata into multiple pieces using sliding window. Further, rules 1406 from rule database 1408 are loaded. The rules 1406 may include scheduler interval (minutes) to load rules under policy set IDs. The rule engine 212 may include, for example, a Json Logic: panzi-json-logic on the data to generate the output 1410. The output 1410 may be a policy violation and/or an action. The action engine 214 may then trigger actions such as data modification, prevent, accept, or route. In case if the confidence score is low, then the output 1410 is routed to a human review 1412 and further the rule is updated 1414 into the rule database 1408.

The output 1410 of the rule engine module 212 may include a policy/rule violation and suggested actions (acceptance, rejection, and human review) defined by the rules. In an example embodiment, the one or more AI models used for validating the generated metadata based on a plurality of AI-based rules may include inference engines.

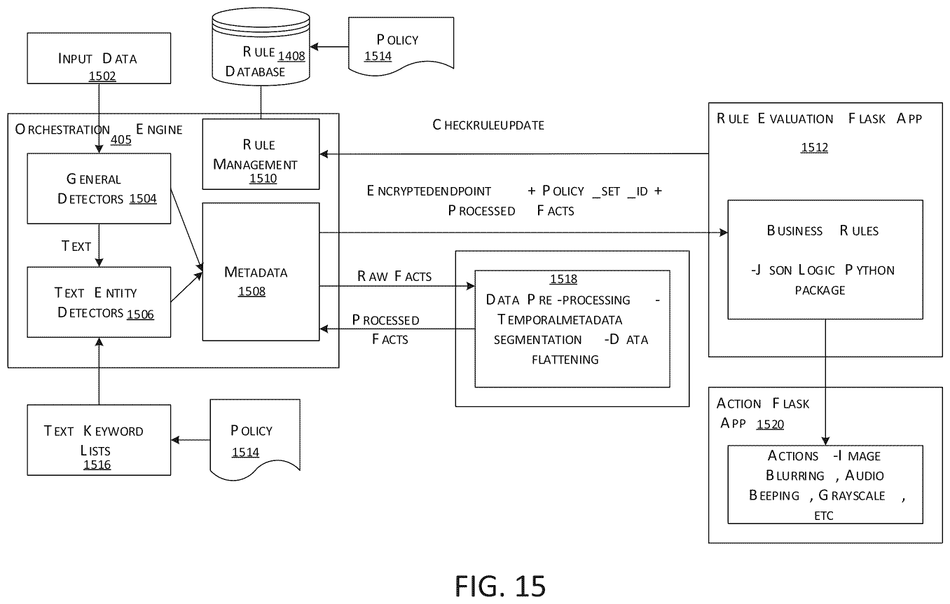

FIG. 15 illustrates an example rule engine architecture, in accordance with embodiments of the present disclosure. The input data 1502 is fed into the orchestration engine 405. The orchestration engine 405 includes general detectors 1504, a text entity detector 1506 for generating a metadata 1508. The orchestration engine 406 further includes a rule management module 1510. The rule management module 1510 is connected to the rule database 1408 and rule evaluation flask application 1512. The rule evaluation flask application 1512 includes business rules such as for example, a Json Logic Python package. The rule database 1408 is fed with a policy 1514. The text entity detectors 1506 communicate with text keyword lists 1516. The metadata 1508 is fed to a data preprocessing 1518 and the rule evaluation flask application 1512. The data preprocessing 1518 may include temporal metadata segmentation and data flattening. The rule evaluation flask application 1512 communicates with action flask application 1520. The action flask application 1520 includes actions such as image blurring, audio beeping, a grayscale, and the like.

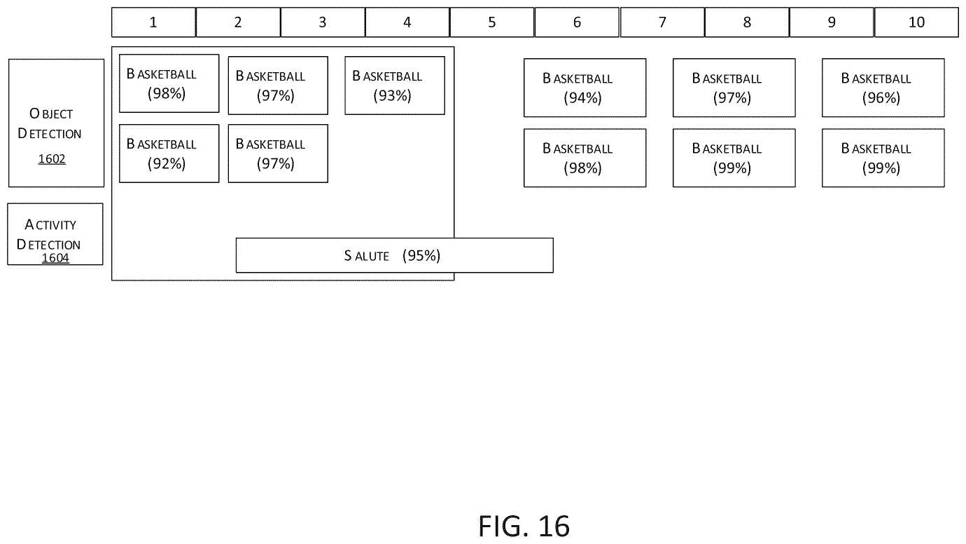

FIG. 16 illustrates a block diagram representation of an example rule engine metadata processing, in accordance with embodiments of the present disclosure. The metadata processing may include object detection 1602 and activity detection 1604. Some of the metadata parameters include window, w=5 s, offset, o=20% (→1 s), duration threshold, dt=−1 (−1 means appears at least once even for split second, otherwise value between 0 and 1 indicating percent of window), confidence approach, ca=highest (possible approaches are highest in the window, or average over the window), individual metadata item confidence thresholds determined in rule engine 212. Table. 4 below depicts an example decisions taken for each detected window:

TABLE 4

| Window | Detected in Window | Decision |
|---|---|---|
| 0-5 s | Basketball (98%), Salute (95%) | OK |
| 1-6 s | Basketball (97%), Salute (95%) | OK |
| 2-7 s | Basketball (95%), Salute (95%) | OK |
| 3-8 s | Salute (95%), Hoop (98%) | OK |
| 4-9 s | Basketball (97%), Salute (95%), | OK |
| | Hoop (99%) | |
| 5-10 s | Basketball (97%), Salute (95%), | OK |
| | Hoop (99%) | |

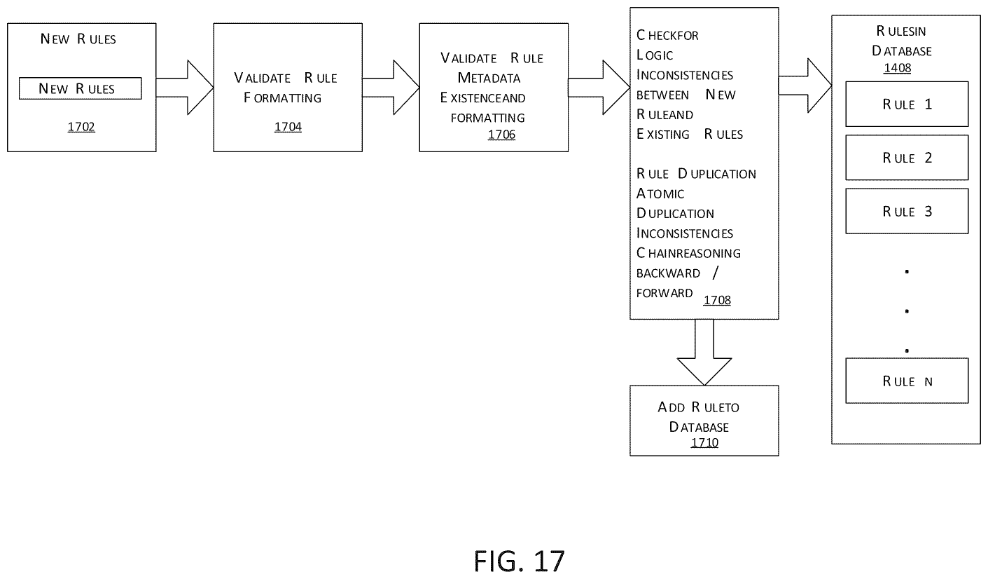

FIG. 17 illustrates an example block diagram of a process for creation of rules in the rule engine module 212, in accordance with embodiments of the present disclosure. In an example embodiment, the platform 400 provides a rule editor to edit rules in real-time. The objective of the rule editor is to allow non-technical users to understand and be able to write policy rules in the system 102 in a graphical manner. The rules may be composed over metadata/events detected by the AI. Further, the user may also select the level of confidence associated with a given event to be able to trigger a particular action. The input to the rule editor may correspond to metadata/events detected by the AI Detectors in the system 102. The output of the rule editor may correspond to a rule that acts upon different metadata/events using operators to trigger actions. At step 1702, a new rule is created. At step 1704, the new rule is validated based on rule formatting. At step 1706, rule metadata existence and formatting are validated. At step 1708, logic inconsistencies between new rule and existing rules are checked. For example, the following tests are performed, a rule duplication test, an atomic duplication test, an inconsistencies test, a chain reasoning backward/forward test and the like. If the validation is successful, then at step 1710, the new rule is added to the rule database 1408.

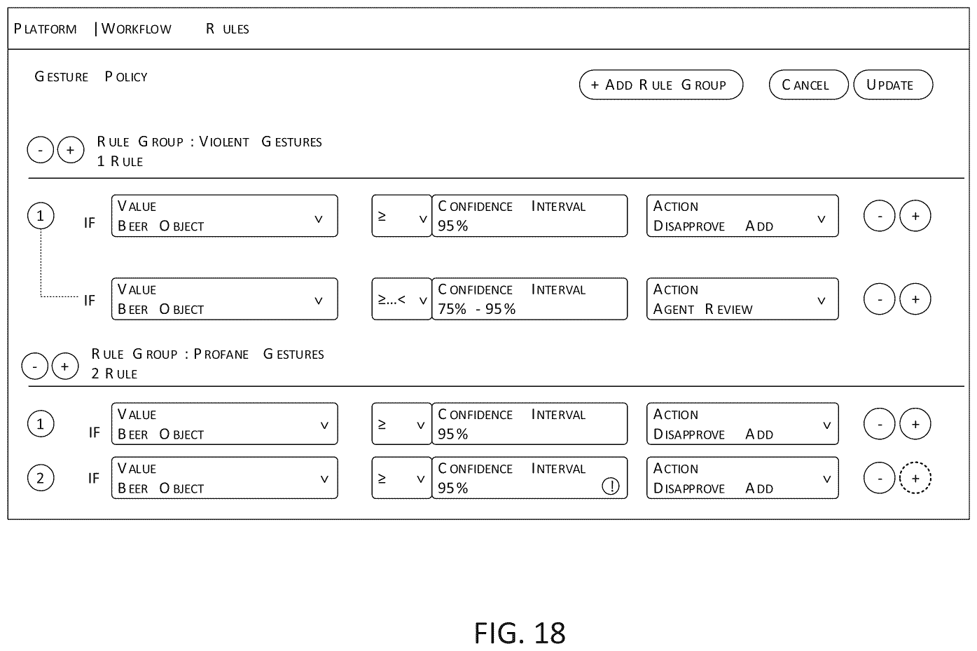

FIG. 18 illustrates a graphical user interface of an example rule editor, in accordance with embodiments of the present disclosure.

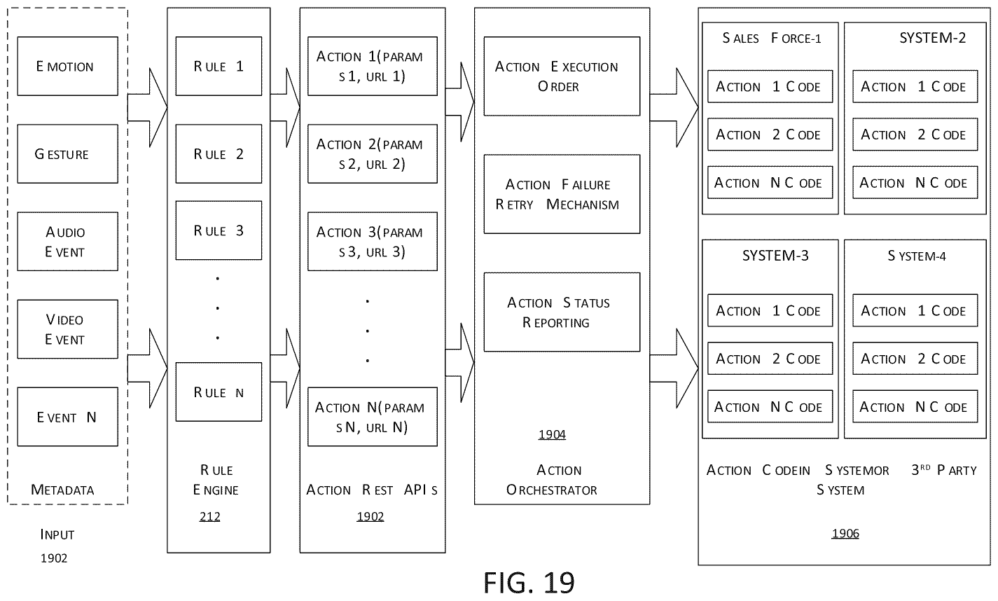

FIG. 19 illustrates a block diagram representation of an action engine module 214 in accordance with embodiments of the present disclosure. In an example embodiment, the platform 400 includes an action engine module 214. The objective of the action engine module 214 is to execute actions after one or several rules have triggered. For example, actions may be of two types: (1) atomic executable pieces of code that act in the system 102 such as “send an email”, “send an SMS notification”, “open an application”, and “store content in a file” and (2) integrations with third party systems such as CRM systems to perform specific actions such as “get a copy of invoice from SAP”, “Update user address in Oracle”, and “Update ticket in Salesforce”. The input to the action engine module 214 may correspond to a set of rules that triggered from metadata/events detected by the AI and their associated actions to trigger. The output of the action engine module 214 may correspond to actions executed in the system 102- or third-party systems in the appropriate order of execution.

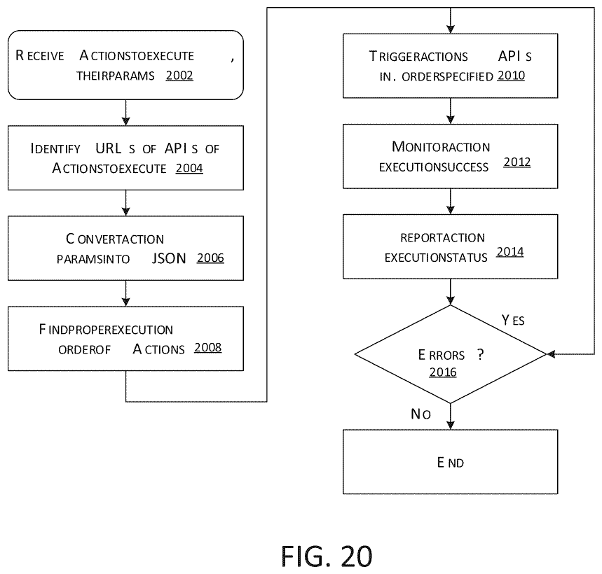

FIG. 20 illustrates an example flowchart executed by the action engine module 214, in accordance with embodiments of the present disclosure. At step 2002, the method 200 includes, receiving, by the processor 110, actions to be executed and their parameters. At step 2004, the method 2000 includes, identifying, by the processor 110, URLs of APIs of actions to be executed. At step 2006, the method 2000 includes converting, by the processor 110, the action parameters into JSON format. At step 2008, the method 2000 includes determining, by the processor 110, a proper execution order of actions. At step 2010, the method 2000 includes triggering, by the processor 110, action APIs in order specified. At step 2012, the method 2000 includes monitoring, by the processor, 110, the success of action execution. At step 2014, the method 2000 includes reporting, by the processor 110, an action execution status. At step 2016, the method 2000 includes determining, by the processor 110, whether there are any errors. If yes, the loop goes back to step 2010 and 2008.

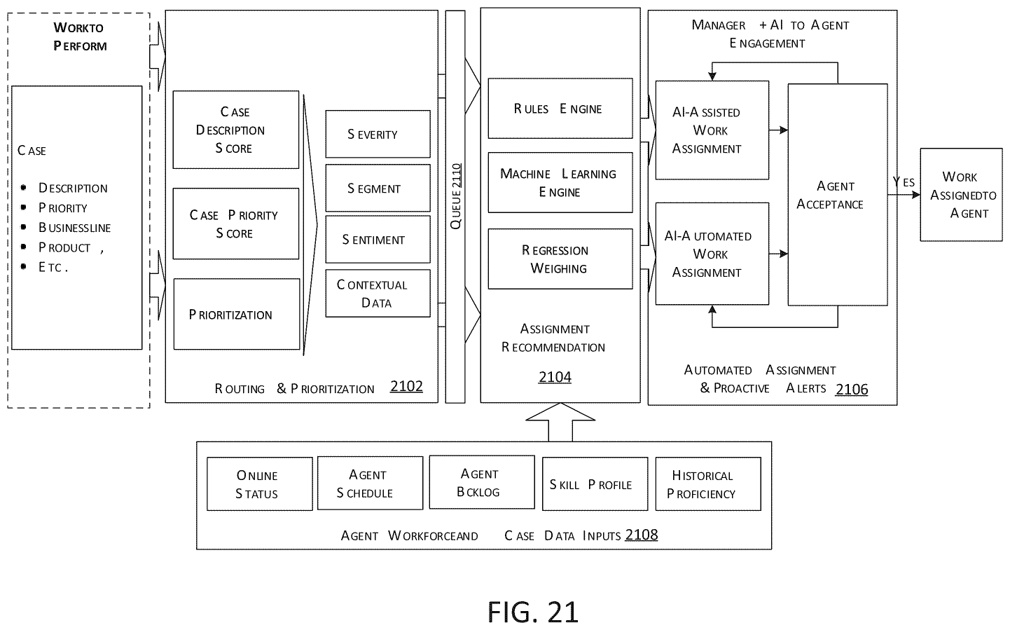

FIG. 21 illustrates an example architecture diagram of an agent routing module 216, in accordance with embodiments of the present disclosure. In an example embodiment, the platform provides intelligent routing. The objective of the agent routing module 216 is to identify the best agent (human) to work on a given case given the agent's time availability, experience in resolving similar cases, training, education, and certifications. The input to the agent routing module 216 may correspond to the case to be resolved and its description, priority, and constraints. The output of the agent routing module 216 may correspond to a prioritized list of agents that are better suited to work on a particular case. The agent routing module 216 uses AI Models such as, for example, but not limited to, a regression weighing, a Glowworm Swarm optimization (GSO), a Quantum-Inspired Evolutionary Algorithm (QEA), a NSGA-II (Non-dominated Sorting Genetic Algorithm II), a stochastic multi-gradient algorithm support vector machine and the like. The agent routing module 216 may include routing and prioritization module 2102, an assignment recommendation module 2104, an automated assignment and proactive alerts module 2106 and an agent workforce and case data inputs 2108. The routing and prioritization module 2102 may include a case description score, case priority score and prioritization which determines the severity, segment, sentiment, and contextual data of the input data. The output of the routing and prioritization module 2102 is fed to message queue 2110. The assignment recommendation module 2104 may include rules engine, machine learning engine, and regression weighing. The output of the assignment recommendation module 2104 to automated assignment and proactive alerts module 2106. Further, the assignment recommendation module 2104 receives input from agent workforce and case data inputs 2108. The automated assignment and proactive alerts module 2106 may include AI assisted work assignment, AI-automated work assignment, and an agent acceptance. If the agent has accepted, then the work is assigned to the agent. The agent workforce and case data inputs 2108 may include online status, agent schedule, agent backlog, skill profile, and historical proficiency.

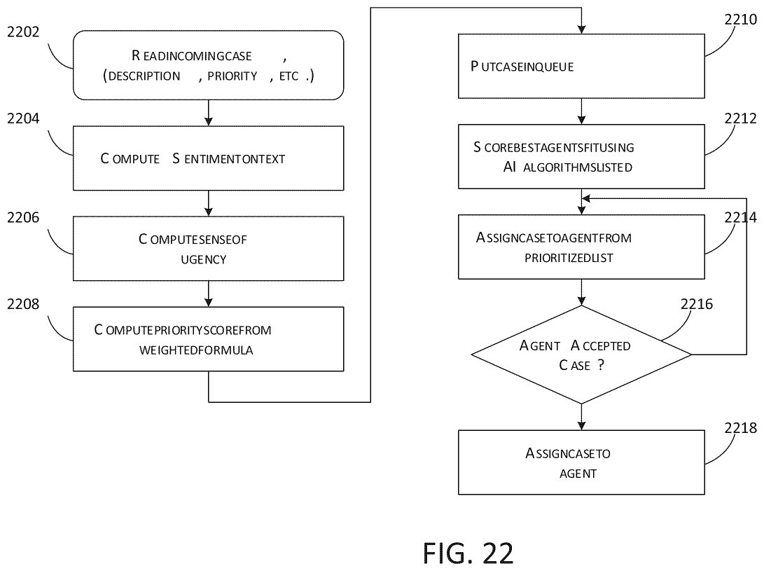

FIG. 22 illustrates an example flow chart for agent routing module 216 in accordance with embodiments of the present disclosure. At step 2202, the method 2200 includes reading, by the processor 110, an incoming case, (for example, description, priority, and the like). At step 2204, the method 2200 includes computing, by the processor 110, a sentiment on text. At step 2206, the method 2200 includes computing, by the processor 110, sense of urgency. At step 2208, the method 2200 includes computing, by the processor 110, a priority score from a weighted formula. At step 2210, the case is assigned to a queue. At step 2212, the method 2200 includes scoring, by the processor 110, best agents fit using AI algorithms listed. At step 2214, the method 2200 includes assigning, by the processor 110, a case to an agent from a prioritized list. At step 2216, determining, by the processor 110, whether the agent has accepted the case. If yes, then at step 2218, assigning, by the processor 110, the case to the agent. If no, the loop goes back to step 2214.

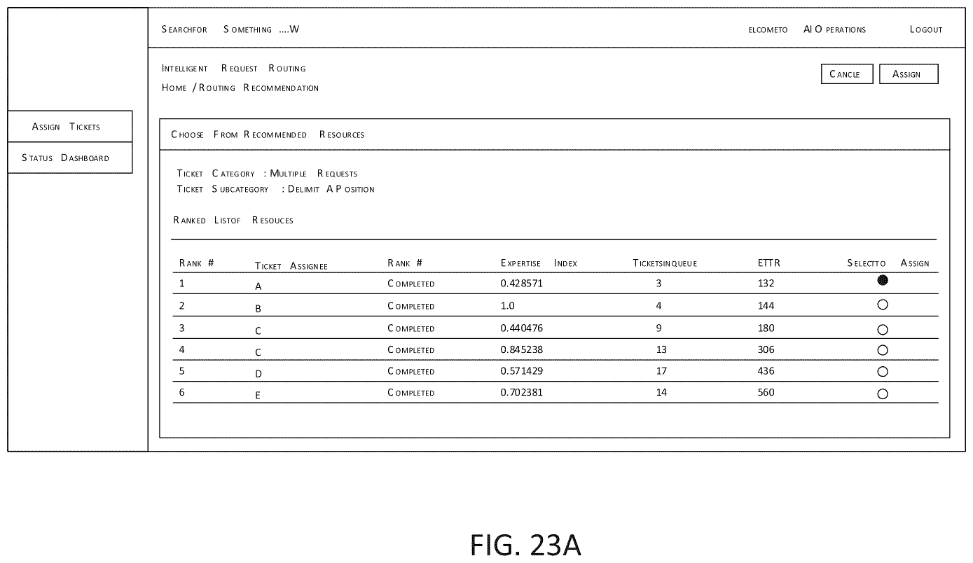

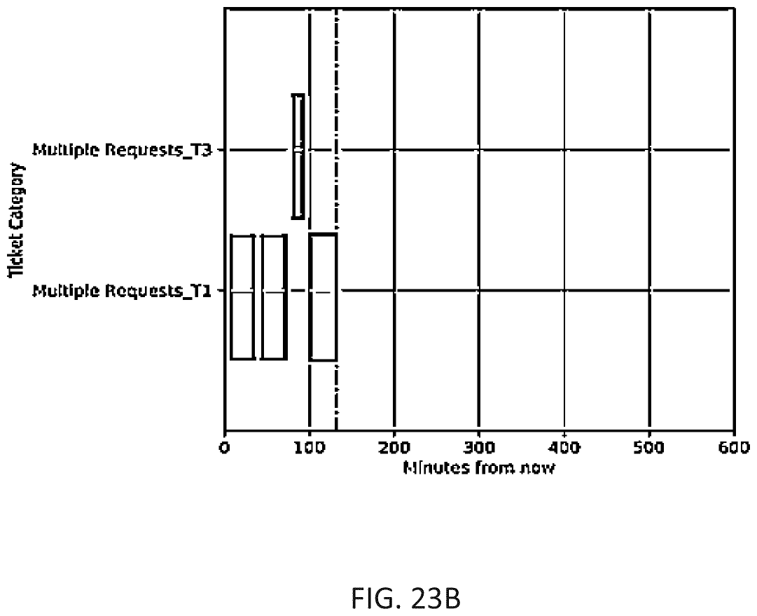

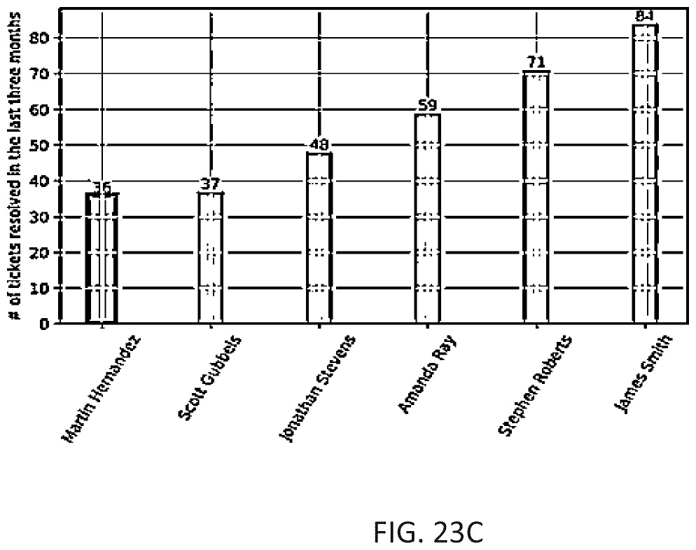

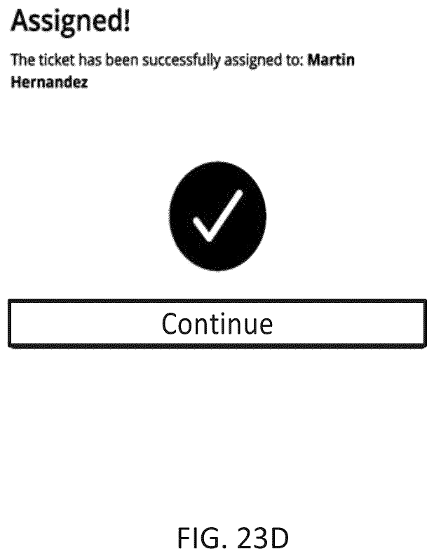

FIG. 23A-D depicts graphical user interfaces of an example routing dashboard, in accordance with embodiments of the present disclosure. FIG. 23A depicts a graphical user interface of an example routing dashboard for prioritized list of agents, in accordance with embodiments of the present disclosure. FIG. 23B depicts a graphical user of an example routing dashboard for justification of agent scoring, in accordance with embodiments of the present disclosure. FIG. 23C depicts a graphical user of an example routing dashboard for expertise index justification in accordance with embodiments of the present disclosure. FIG. 23D depicts a graphical user of an example routing dashboard for case assignment in accordance with embodiments of the present disclosure.

In an example embodiment, the platform 400 provides steps for agent assignment resolution. The goal is to improve collective issue resolution within enterprise operations, meeting time and trust requirements. The first step may include identifying issue resolution pain-points (feasibility and impact analysis). For instance, the step may include discovering routing patterns in collective issue resolution that may further include relating Issue Resolution Sequences (i.e., Sequence of Agents) to Time to Resolve and SLA breach ratio. The step may further include measuring (1) the human decision time for routing and (2) frequency of misrouting and its impact.

The second step may include constructing a working agent finding model (Structured Output Learning). In an example embodiment, the step may include building a baseline model for intelligent agent finding based on Miao, Gengxin, et al. KDD 2010 (resolution model). Accordingly, the model may receive three input data. First input may be: Issue description (sequence of bigrams: b1, . . . , bm). Second input may be—Issue priority (value in range [1-4]: PR). Third input may be—Issue current sequence of agents (sequence of categorical value: E1, . . . , En−1). The output may correspond to the best agent group to be recommended to work on issue resolution next (categorical value: En). Yet another output may be ranked list of agent groups to work on the next issue resolution. The second step may include an inference problem: argmaxn P (En|E1 . . . , En−1, b1, . . . , bm, PR) that is solvable by a Bayesian Inference using conditional independence in an example embodiment.

The third step may include (optional) model augmentations that further include potential augmentation for intelligent agent finding. The step may further include process prediction to identify frequent/routine resolution processes and recommend coherent agent sequences all at once (resolution workflow recommendation). The process prediction may further include building a hierarchical classifier to detect whether the issue may get resolved using a routine workflow. The potential augmentation for intelligent agent finding may include predicting the expected time to resolve (ETR) for an incoming issue (helps to act quickly on complex issues) that further includes expertise profiling per historical issues.

The fourth step may include integration with enterprise issue tracking and incident management systems, such as, but limited to, a service now, a service manager, a service desk, and the like. The fifth step may include a user testing and model validation (pilot). This step may further include evaluation of the tendency to use (how often do the users make request for recommendations?), a recommendation rate on a request (when a request is made, how often does the framework make a high-confidence recommendation?), an adoption rate (when an agent/process is recommended, how often is the recommendation completely followed by humans?), and a success rate after adoption (when a recommendation is adopted, how often does it result in a resolution?).

There may be data requirements for agent assignment in the platform 400 in accordance with an embodiment. For example, it may be required to have a data associated with issue/incident logs (natural language) that may include priority (categorical), description (Text), resolution (Text), and resolution sequence (List of categorical values). The resolution sequence may include a sequence of agents who worked on the issue, and a sequence of agent groups which worked on the issue. The issue/incident logs may further include time to resolve, and SLA target met/breached.

In yet another example, it may be required to have a data associated with interaction logs that may include a time stamped routing history between agents/agent groups. In still further example, it may be required to have a data associated with an issue category/taxonomy information. In another example, it may be required to have a data associated with a knowledge base record (FAQs for Issue Resolution, and the like.). In another example, it may be required to have data associated with operational support records. The operational support records may include acknowledgement time and impact/outage information (end user down time).

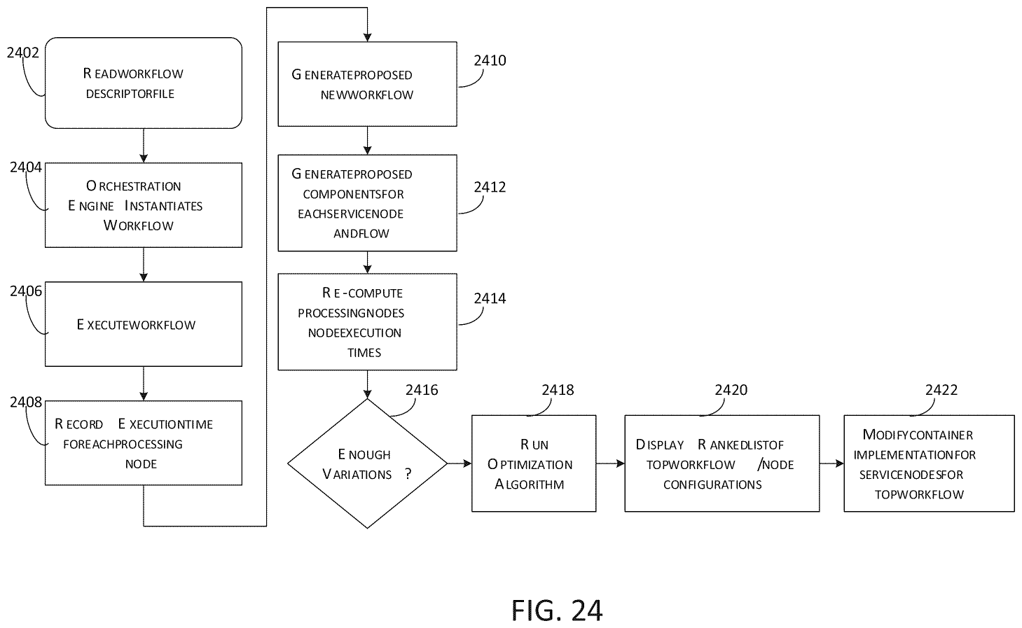

FIG. 24 illustrates an example flowchart of optimization compiler module 220, in accordance with embodiments of the present disclosure. At step 2402, the method 2400 includes reading, by the processor 110, a workflow descriptor file. At step 2404, the method 2400 includes instantiating, by the processor 110, a workflow by the orchestration engine 405. At step 2406, the method 2400 includes executing, by the processor 110, a workflow. At step 2408, the method 2400 includes recording, by the processor 110, an execution time for each processing node. At step 2410, the method 2400 includes generating, by the processor 110, a proposed new workflow. At step 2412, the method 2400 includes generating, by the processor 110, proposed components for each service node and flow. At step 2414, the method 2400 includes recomputing, by the processor 110, the processing nodes and node execution times. At step 2416, the method 2400 includes determining, by the processor 110, whether there are enough variations. At step 2418, the method 2400 includes running, by the processor 110, an optimization algorithm. At step 2420, the method 2400 includes displaying, by the processor 110, a ranked list of top workflow/node configurations. At step 2422, the method 2400 includes modifying, by the processor 110, a container implementation for service nodes for top workflow.

In an example embodiment, the platform 400 may include optimization compiler module 220. The objective of the optimization compiler module 220 is to review the workflow graph and innerworkings of each processing node to optimize the execution graph with respect to execution time. The input to the optimization compiler module 220 may correspond to JSON file descriptor for workflow and JSON descriptors for each processing node in the workflow. The output of the optimization compiler module 220 may include a new workflow execution graph with reduced execution time. In an example embodiment, the optimization compiler module 220 may provide a plurality of features, such as, an execution time for each processing node, a processing node description, code functions executed for each node, and a workflow description. In an example embodiment, the optimization compiler module 220 may implement AI models, such as, for example, but not limited to, a Glowworm Swarm optimization (GSO), a Quantum-Inspired Evolutionary Algorithm (QEA), a NSGA-II (Non-dominated Sorting Genetic Algorithm II), and a Stochastic Multi-Gradient Algorithm Support Vector Machine.

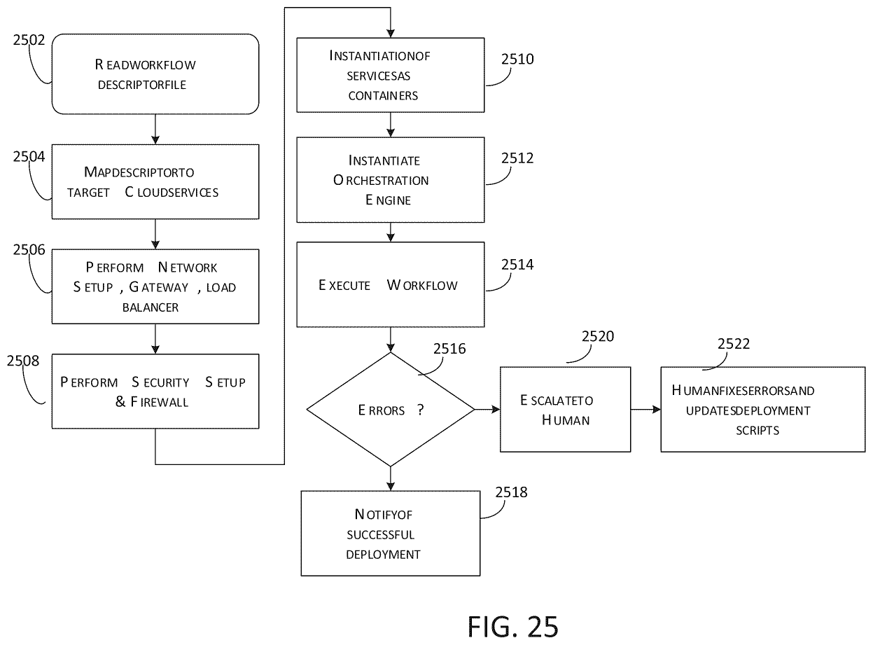

FIG. 25 shows an example flowchart implemented in the cloud deployer module 218 in accordance with embodiments of the present disclosure. In an example embodiment, the platform 400 may include the cloud deployer module 218. The objective of the cloud deployer module 218 is to ingest a JSON description of the computationally optimal workflow and service processors and instantiate the necessary components for workflow execution in the target cloud. The input to the cloud deployer module 218 may correspond to JSON file descriptor for computationally optimal workflow and target cloud. The output of the cloud deployer module 218 may correspond to workflow instantiated and executed on target cloud in real-time where data may flow and be processed according to the workflow specifications. In an example embodiment, the cloud deployer module 218 may provide a plurality of features, such as, cloud vendor independent instantiation of the workflow, and configurable in case computation specified in the workflow cannot keep up with real-time performance. In an example embodiment, the cloud deployer module 218 may implement AI models, such as, a Glowworm Swarm optimization (GSO), a Quantum-Inspired Evolutionary Algorithm (QEA), a NSGA-II (Non-dominated Sorting Genetic Algorithm II), and a Stochastic Multi-Gradient Algorithm Support Vector Machine.

At step 2502, the method 2500 includes reading, by the processor 110, a workflow descriptor file. Further, at step 2504, the method 2500 includes mapping, by the processor 110, a descriptor to target cloud services. At step 2506, the method 2500 includes performing, by the processor 110, a network setup, a gateway, and a load balancer. At step 2508, the method 2500 includes performing, by the processor 110, a security setup and firewall. At step 2510, the method 2500 includes instantiating, by the processor 110, services as containers. At step 2512, the method 2500 includes instantiating, by the processor 110, orchestration engine 405. At step 2514, the method 2500 includes executing, by the processor 110, the workflow. At step 2516, the method 2500 includes determining, by the processor 110, whether there are any errors. If there are no errors, then at step 2518, the method 2500 includes notifying, the processor 110, a successful deployment. If there are errors, then at step 2520, the method 2500 includes escalating, by the processor 110, the process to human. At step 2522, the method 2500 includes fixing and updating, by the processor 110, the errors and deployment scripts.

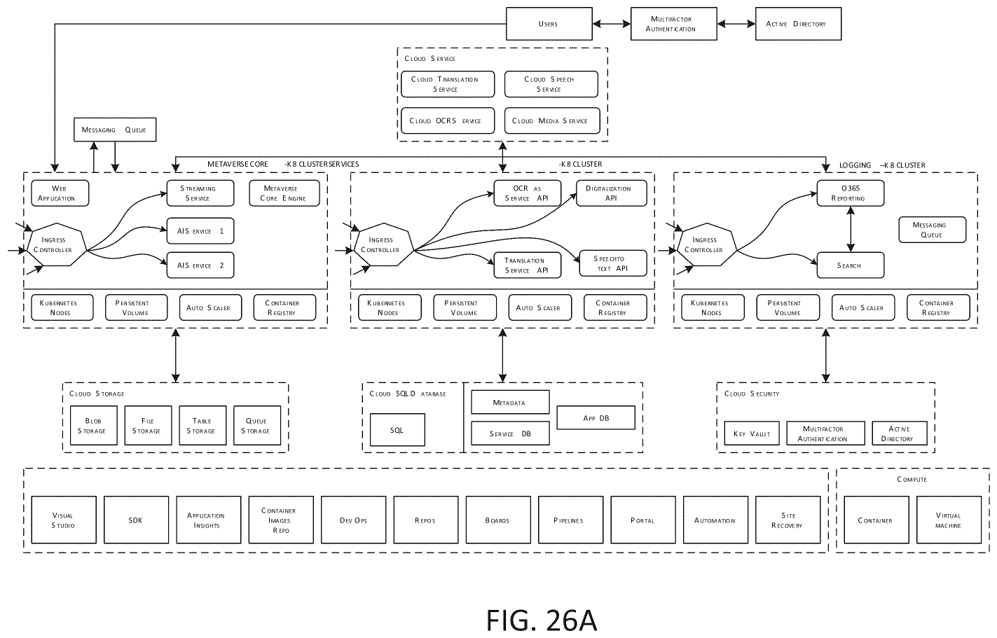

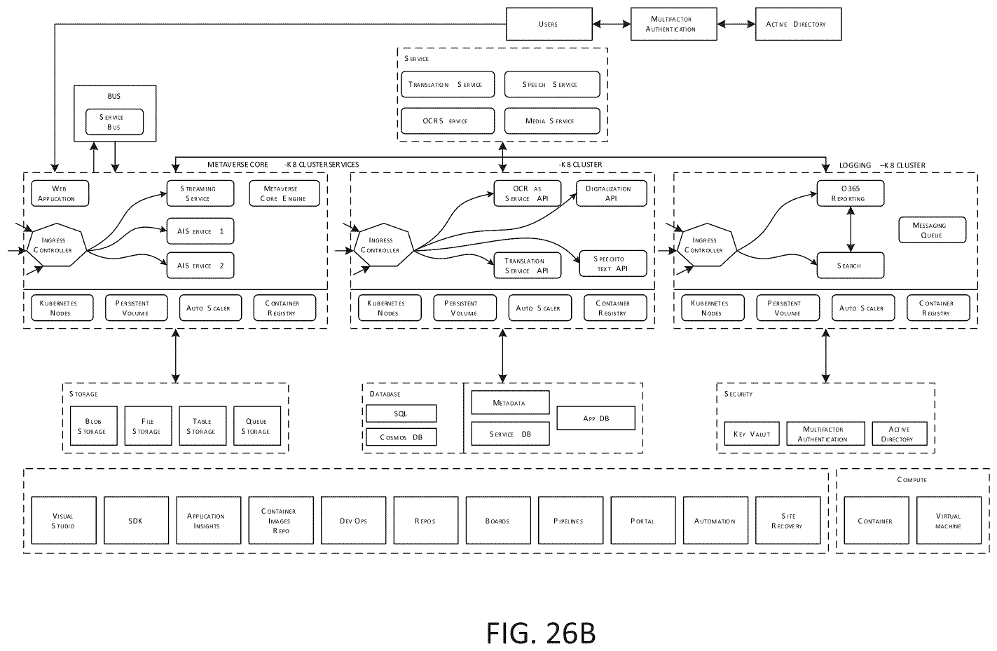

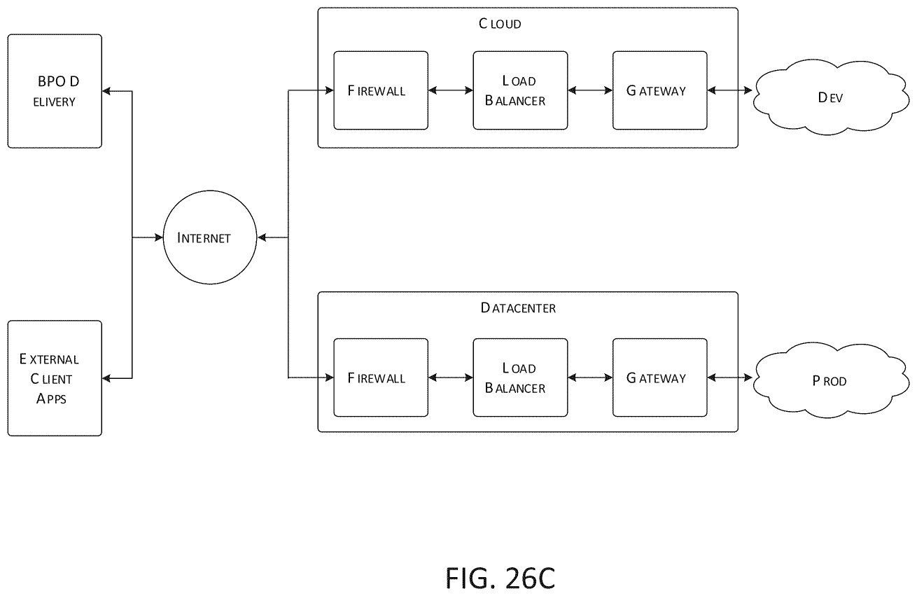

FIG. 26A illustrates a system cloud deployer module 218 architecture in accordance with embodiments of the present disclosure. FIG. 26B depicts an example system cloud specific deployment architecture in accordance with an example embodiment. FIG. 26C depicts a cloud network setup in accordance with an example embodiment.

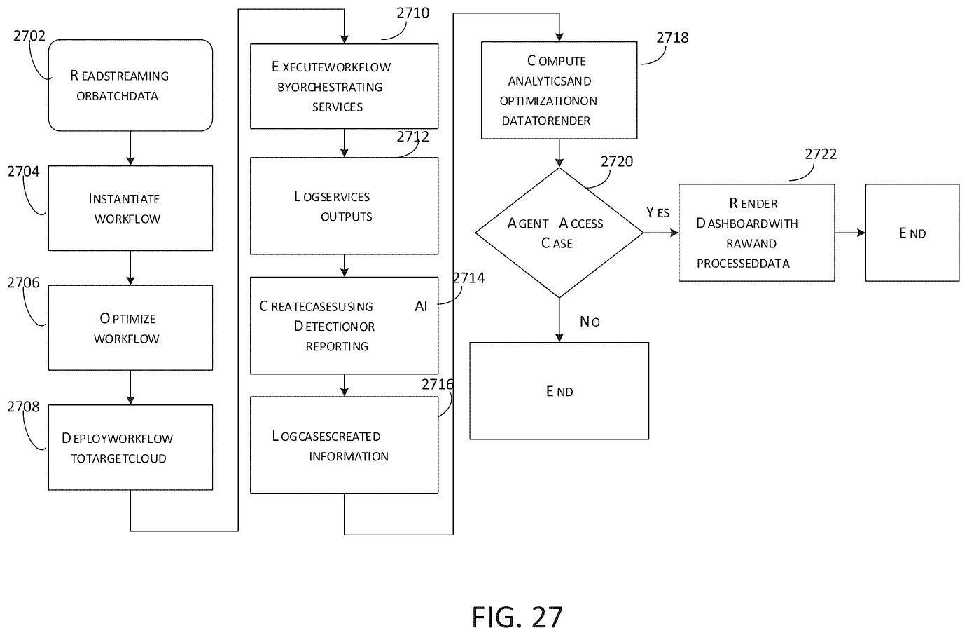

FIG. 27 illustrates an example flowchart implemented in an agent review dashboard 306 in accordance with embodiments of the present disclosure. In an example embodiment, the platform 400 may include an agent review dashboard 306. The objective of the agent review dashboard 306 is to allow human agents to review all the important information associated with a case, including AI results, visualizations, users' history, and actions. The system 102 may send any case for human review when the AI is not confident enough to take an automated decision as per the threshold set in the rule engine 212 and associated rule editor dashboards. The input to the agent review dashboard 306 may correspond to all raw data associated with a case (e.g., history of users, case), and processed data associated with the case such as AI event inferences, summaries, and processing. The output of the agent review dashboard 306 may correspond to generic graphic visualization of all events and processing performed on a case to enable the human agent to review it and act on it.

At step 2702, the method 2700 includes reading, by the processor 110, a streaming or batch data. At step 2704, the method 2700 includes instantiating, by the processor 110, a workflow and at step 2706, optimizing, by the processor 110, the workflow. At step 2708, the method 2700 includes deploying, by the processor 110, the workflow to target cloud. At step 2710, the method 2700 includes executing, by the processor 110, the workflow by orchestrating services. Further, at step 2712, the method 2700 includes logging, by the processor 110, services outputs and at step 2714, creating, by the processor 110, cases using AI detection or reporting. At step 2716, the method 2700 includes logging, by the processor 110, cases created information and at step 2718, computing, by the processor 110, analytics and rendering optimization on data. At step 2720, it is determined whether the agent has accessed the case and if yes, at step 2722, dashboard with raw data and processed data are rendered.

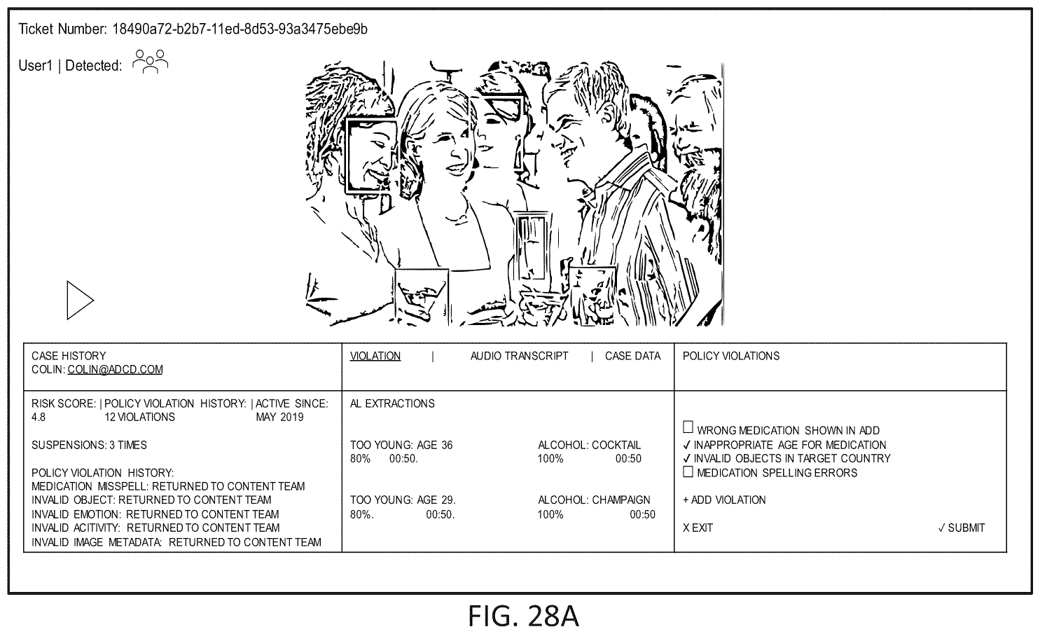

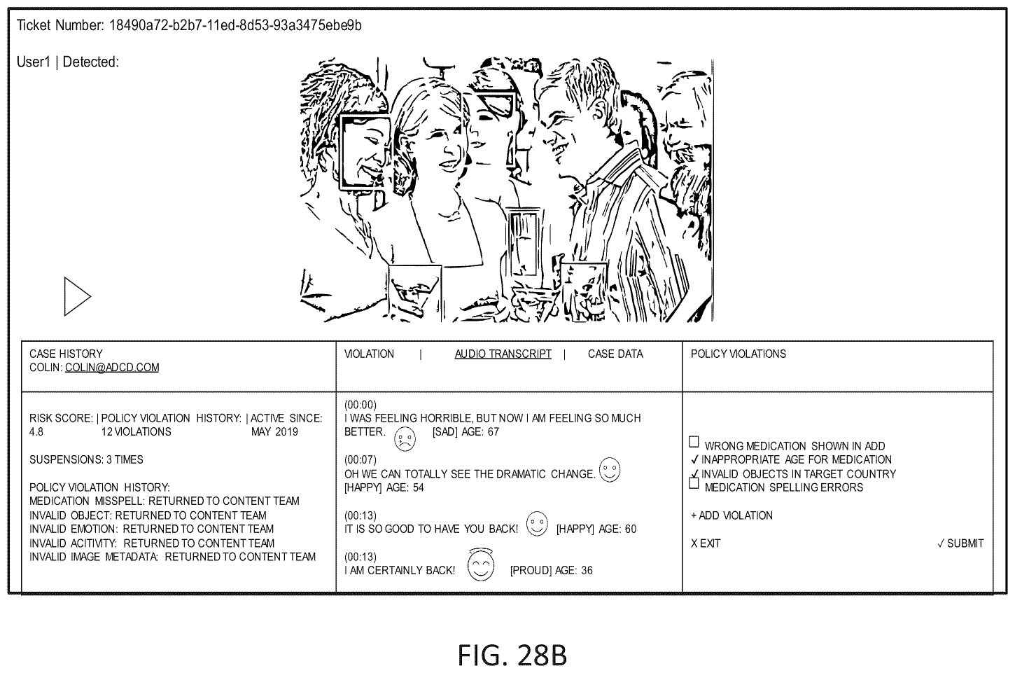

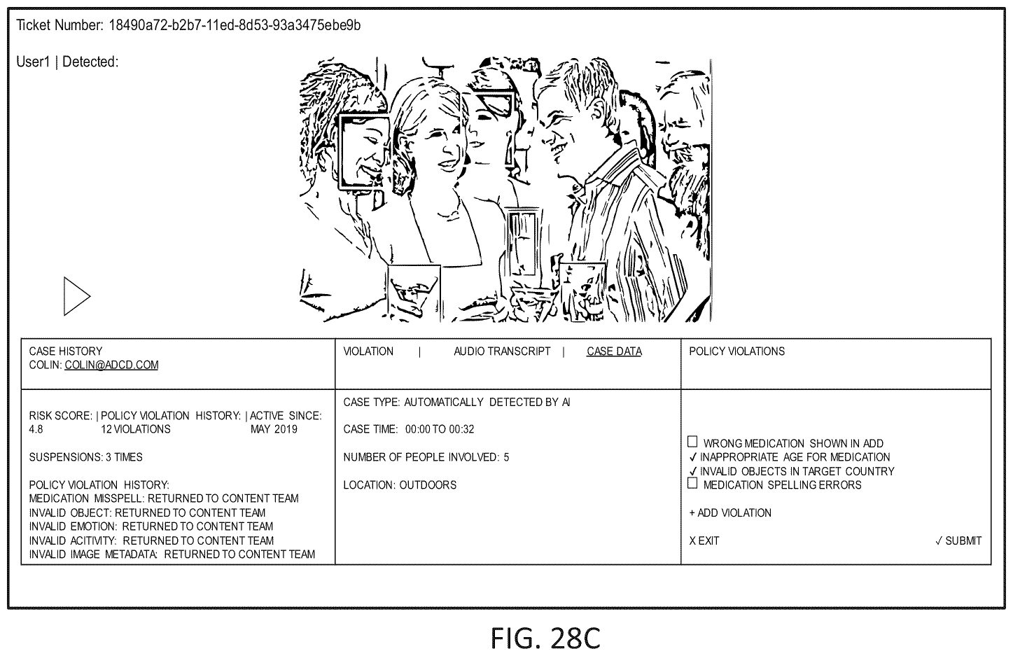

FIGS. 28A-C illustrates graphical user interfaces (GUIs) of an example use case of agent review dashboard 306, in accordance with embodiments of the present disclosure. The example shown corresponds to medical advertisement compliance. FIG. 28A depicts AI detected policy violations in the input image. FIG. 28B depicts audio transcript data for the input data. FIG. 28C depicts case data with case history.

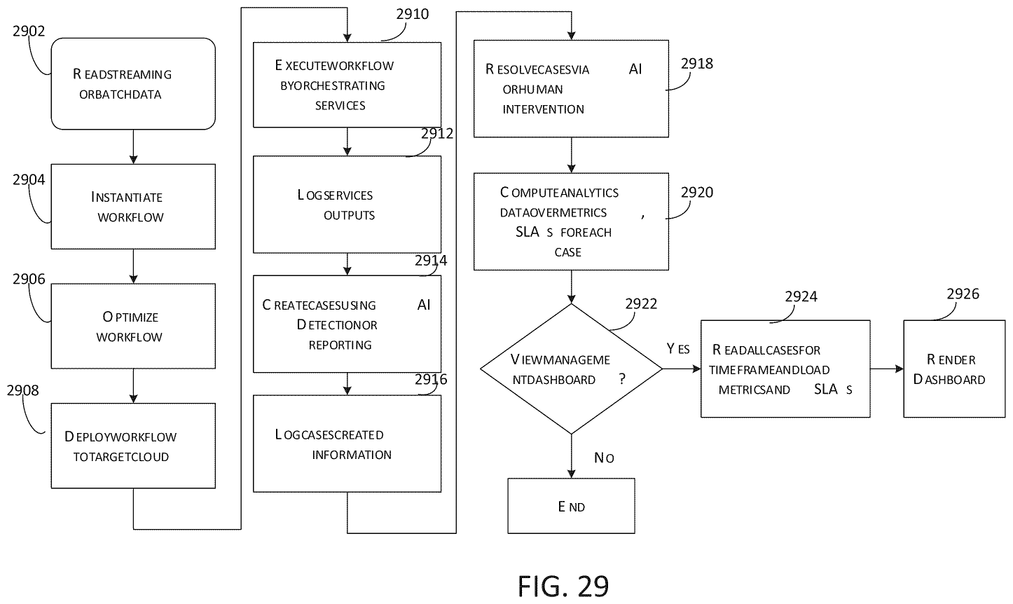

FIG. 29 illustrates an example flowchart implemented in the management dashboard 222 in accordance with embodiments of the present disclosure. In an example embodiment, the platform 400 may include a management dashboard 222. The objective of the management dashboard 222 is to allow management to review the health and wealth of the system 102 by displaying dashboards with different metrics, all the important information associated with a case, including AI results, visualizations, user's history and take actions. The system 102 may send any case for human review when the AI is not confident enough to take an automated decision as per the threshold set in the rule engine 212 and associated rule editor dashboards. The input of the management dashboard 222 may correspond to all raw data associated with a case (e.g., video, images, text, history of users, case), and processed data associated with the case such as AI event inferences, summaries, and processed data. The output of the management dashboard 222 may correspond to generic graphic visualization of all events and processing performed on a case to enable the human agent to review it and act on it. At step 2902, streaming or batch data are read and at step 2904, workflows are instantiated. At step 2906, workflows are optimized. At step 2908, workflows are deployed on target cloud. At step 2910, workflows are executed by orchestrating services. At step 2912, services outputs are logged and at step 2914, cases are created using AI detection or reporting. At step 2916, cases created information are logged and at step 2918, cases are resolved via AI. At step 2920, analytics data and SLAs for each case are computed. At step 2922, it is determined whether to view management dashboard. If yes, then at step 2924, all cases for the time frame are read and metrics and SLAs are loaded. At step 2926, the dashboard is rendered.

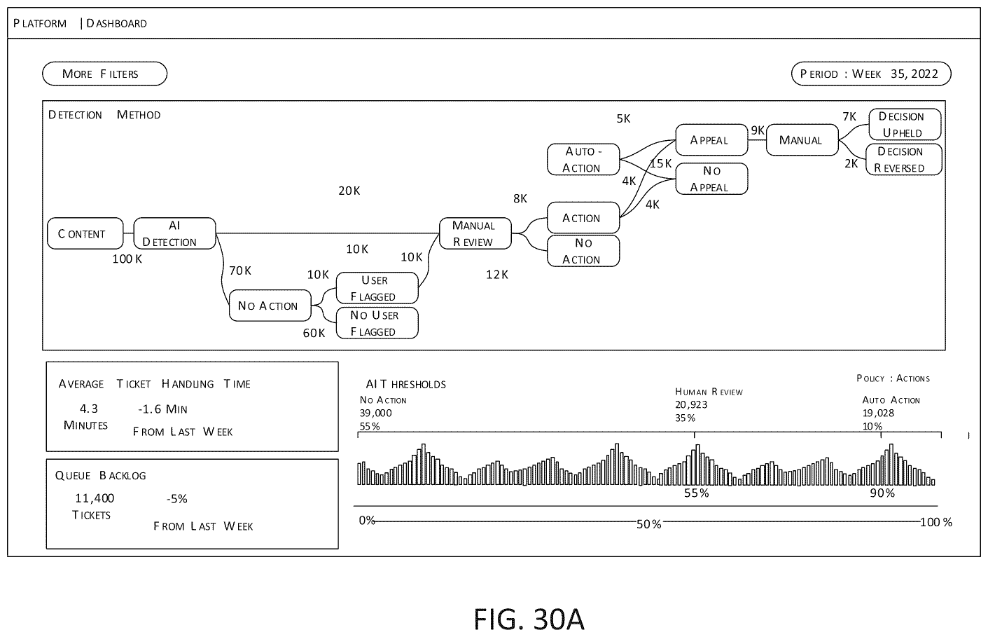

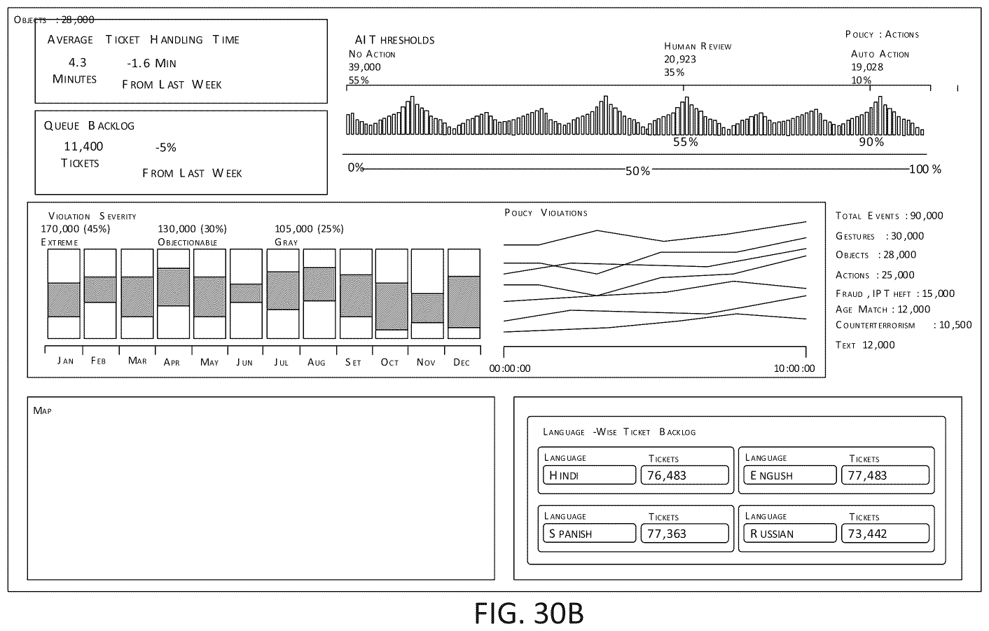

FIGS. 30A-B illustrates examples of management dashboard visualizations in accordance with embodiments of the present disclosure.

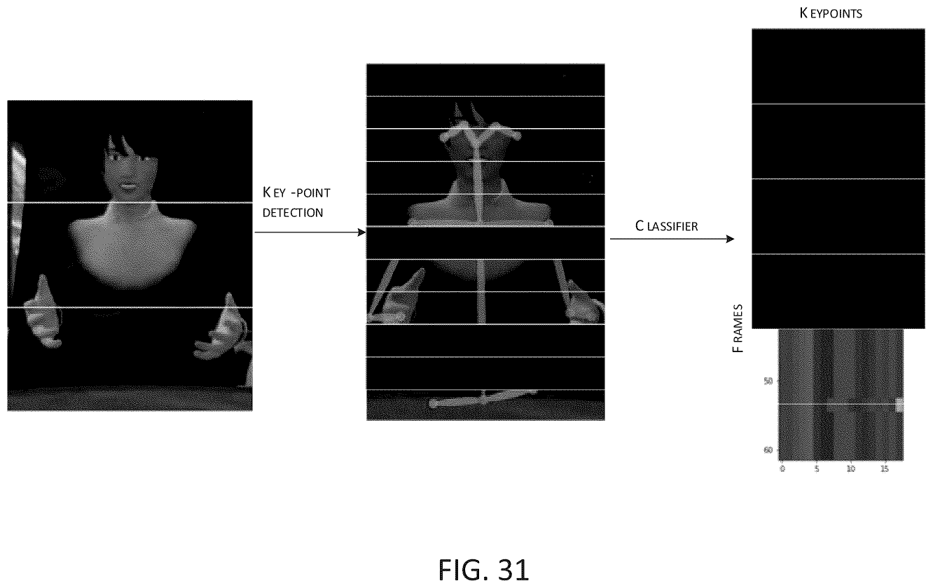

FIG. 31 illustrates a graphical user interface of an example gesture detection sample data in accordance with embodiments of the present disclosure. One of the examples use cases may correspond to an activity detection. The objective of the activity detection is to classify activities into one of seven activities from a video. The input to the activity detection may correspond to a three-dimensional cloud point data from both hands and oculus controller clicks recorded over five second intervals. The output of the activity detection may correspond to seven activities detected (e.g., neutral, middle finger, punch, clap, wave, nod, shake head). In an example embodiment, the system 102 may provide a plurality of features for this use case. The plurality of features may include key points detected for each person converted to an image with having width equal to number of key points per frame, a height equal to the number of frames in the video and a number of channels being equal to the number of coordinates (2D in this case). In an example embodiment, the system 102 may implement an AI model, such as, for example, but not limited to, a size independent Convolutional Neural Network. The implementation may include experiments, such as, for example, split x training, y testing or cross-validation. The metrics may be represented as accuracy 91.3%, FP rate: X %, a precision: Y %, and a recall Z %.

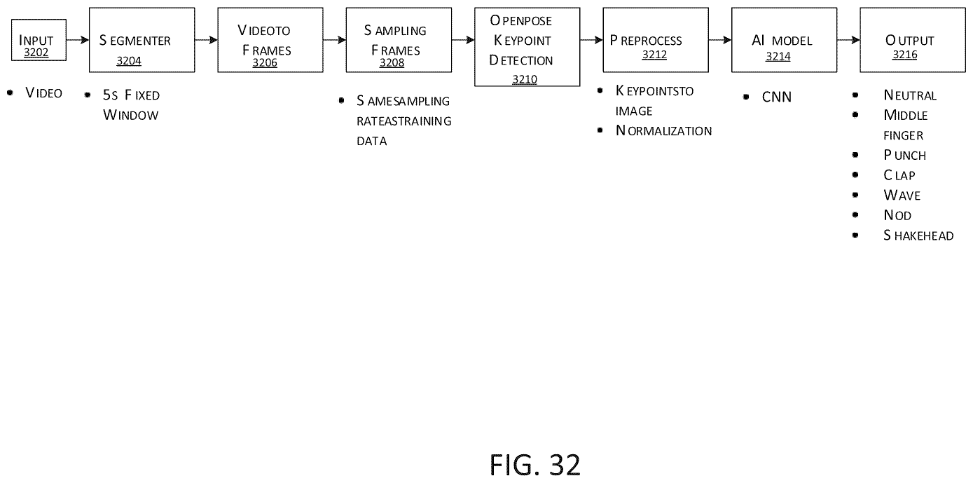

FIG. 32 illustrates a block diagram of an example gesture detection in accordance with embodiments of the present disclosure. At step 3202, an input such as a video is fed to a segmenter 3204. The segmenter 3204 segments the video using a 5 s fixed window. Further, the video is classified into frames at step 3206. The sampling frames 3208 samples the frames using sampling rate as training data. At step 3210, an open pose key point detection is performed. At step 3212, the key points are pre-processed to image and a normalization is performed. At step 3214, the AI model, such as CNN is performed and the output 3216 is generated. The output 3216 may be neutral, middle finger, punch, clap, wave, nod, and shake head.

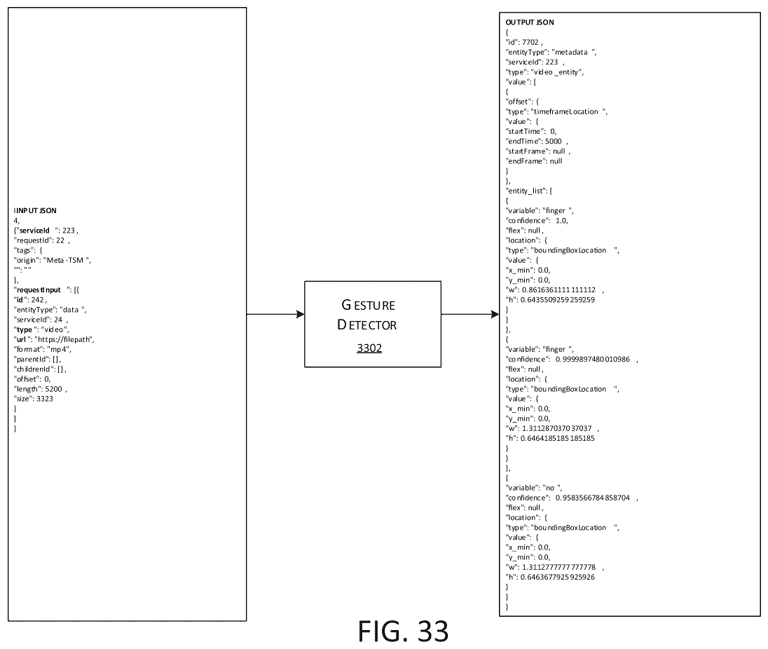

FIG. 33 illustrates an example API specification for gesture detection in accordance with embodiments of the present disclosure. The gesture detector 3302 is fed with an input data. The input data may include, for example, a video file in JSON format. The gesture detector 3302 may further output a processed data in a JSON format.

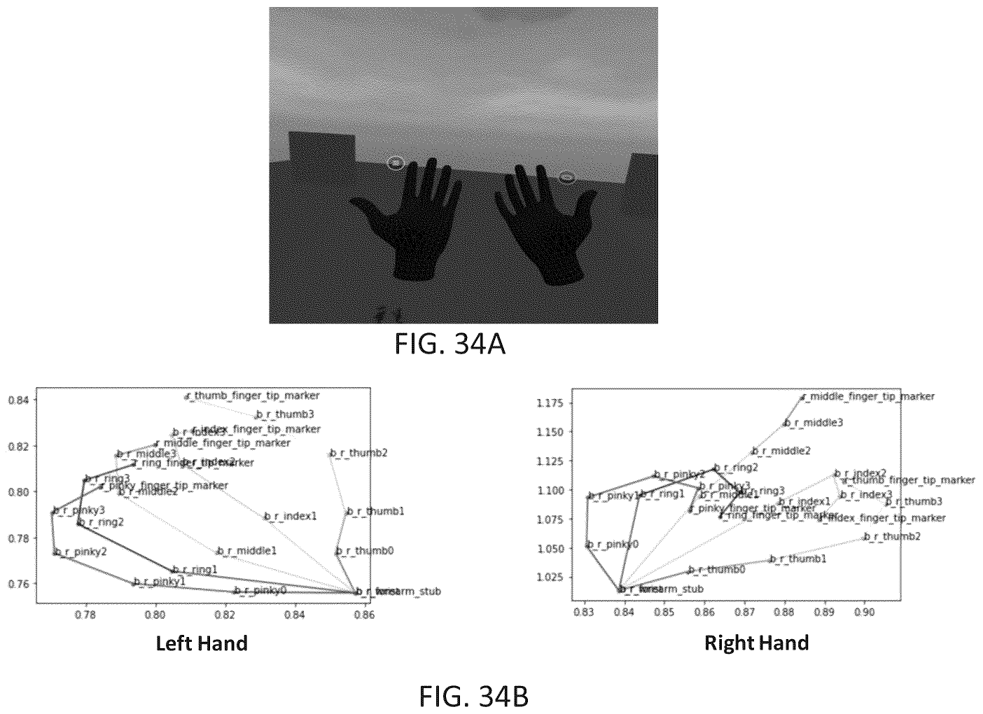

FIGS. 34A-B illustrates an example representation of a gesture detection sample data in accordance with embodiments of the present disclosure. Consider the same use case with a variation wherein the objective of the gesture detection is to classify activities among seven activities from a video. The input data may correspond to a three-dimensional cloud point data from both hands and oculus controller clicks recorded over five second intervals. The output may correspond to five gestures detected (e.g., middle finger, like, dislike, palm, and wave). The features may include a vector that consists of (x, y) coordinate of five fingertips, x_delta between each frame, and maximum width over the entire time frame. The platform 400 may implement an AI model, such as, for example, but not limited to, a support vector machine. The experiment may include split x training, y testing, or cross-validation. The metrics may correspond to an accuracy of 91.3%, for instance. FIG. 34B represents a graphical representation of gesture detection sample data, where 24 key points data are represented with (x, y, z) coordinate information and x, y, z axes rotational information for each point.

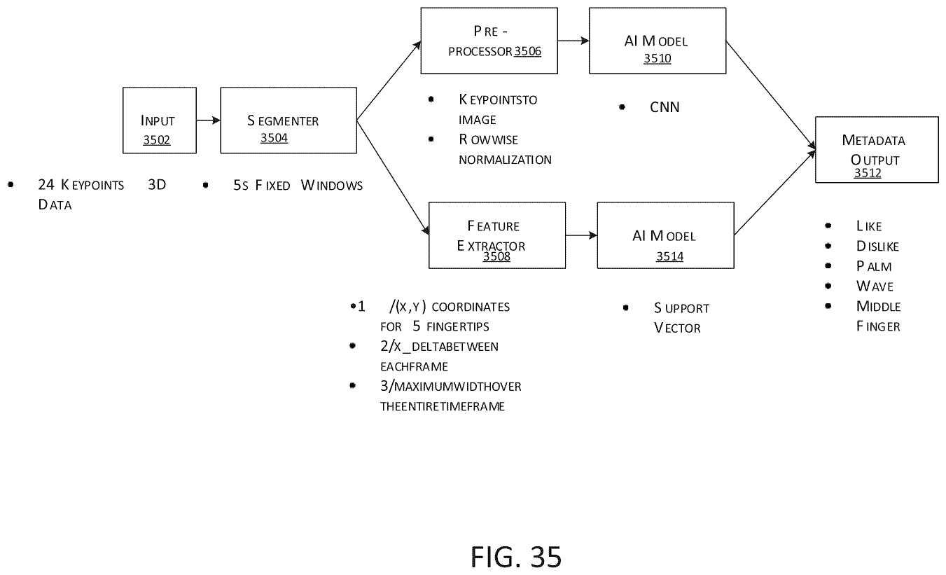

FIG. 35 illustrates an example block diagram of a gesture detection for the above use case in accordance with an embodiment. In an example embodiment, the input 3502 such as 24 Key points 3D Data are fed to a segmenter 3504, where the input 3502 is segmented using a 5 s fixed window. Further, the output of the segmenter 3504 is fed to preprocessor 3506 and a feature extractor 3508. The preprocessor 3506 processes the key points to image and performs a row wise normalization. Then, an AI model 3510 is used to generate a metadata output 3512. The AI model 3510 may be for example, but not limited to, a CNN model. Further, the feature extractor 3508 extracts feature such as 1/(x, y) coordinates for 5 fingertips, 2/x_delta between each frame, and 3/maximum width over the entire time frame. Further, the AI model 3514 such as a support vector machine is used for generating the metadata output 3512. The metadata output 3512 may include like, dislike, palm, wave, and a middle finger.

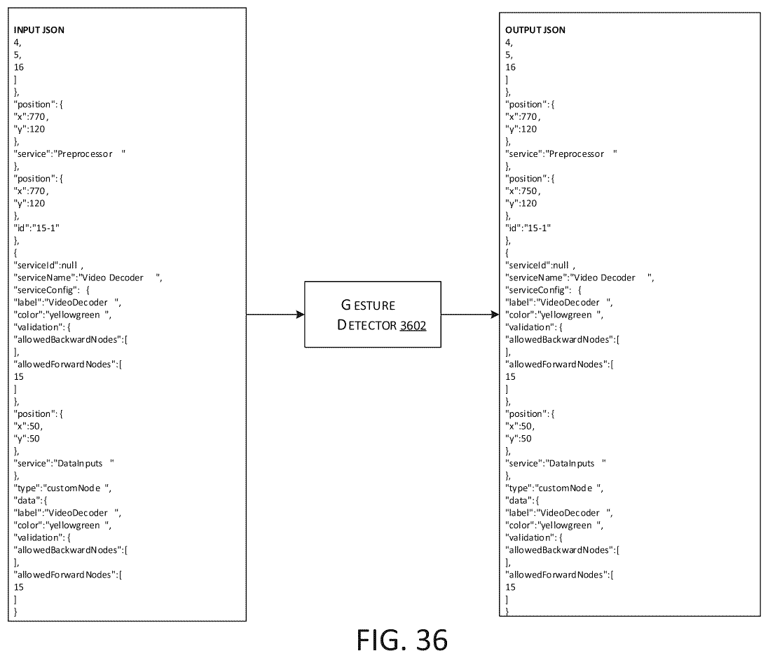

FIG. 36 illustrates an example API specification for gesture detection in accordance with embodiments of the present disclosure. The gesture detector 3602 receives an input data in JSON format and outputs a data in JSON format.

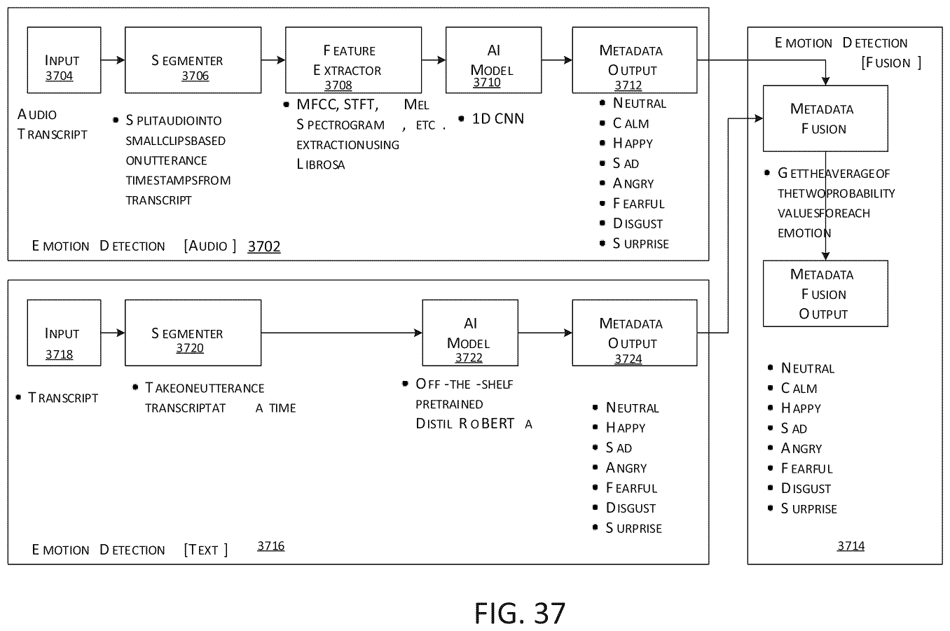

FIG. 37 illustrates a block diagram of an emotion detection in accordance with an embodiment. In an example embodiment, a use case may be emotion detection based on an audio. The objective is to recognize an emotion from the audio. The input data may correspond to audio and/or text transcript. The output may correspond to eight emotions detected (e.g., Neutral, Calm, Happy, Sad, Angry, Fearful, Disgust, Surprise). The features may include a vector that consists of audio statistics, including but not limited to a MFCC, Mel spectrogram, and a Chroma Short-time Fourier Transform. The system 102 may implement an AI model, such as, for example but not limited to, a one dimensional (1D) Convolutional Neural Network (CNN). The experiment may include: a train/validation split, trained on RAVDESS for 45 epochs with learning rate of 0.001. The metrics correspond to an accuracy of 95.8% for instance.

Yet another example use case may be an emotion detection based on a text. The objective is to recognize the emotion from a transcript. The input data may correspond to a text transcript. The output may correspond to seven emotions detected (e.g., Neutral, Happy, Sad, Angry, Fearful, Disgust, Surprise). The features may include word embeddings. The platform 400 may implement an AI model, such as, for example, but not limited to a Distil Roberta model finetuned with six diverse datasets (off-the-shelf model from Hugging Face). The metrics correspond to an accuracy of 66% for instance.

Yet another example use case may be an emotion detection based on a fusion. The objective is to combine emotions detected from the emotion detection [Audio] and the emotion detection [Text]. The output may correspond to the right emotions detected (e.g., Neutral, Calm, Happy, Sad, Angry, Fearful, Disgust, Surprise). The features may include two python dictionaries containing emotion labels and respective prediction probabilities (e.g., {“neutral”: 0.004, “calm”: 0.009, “happy”: 0.994, . . . }).

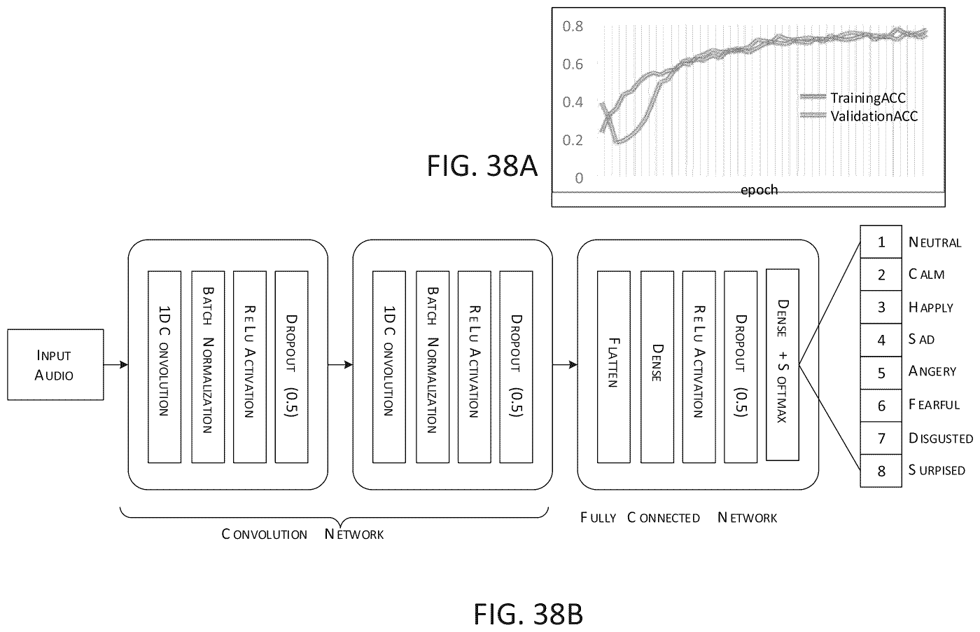

The input 3704 from an emotion detection audio 3702 is fed to a segmenter 3706, then to a feature extractor 3708, and an AI model 3710 to generate a metadata output 3712. The input 3704 may be an audio and/or a transcript. The segmenter 3706 may split the audio into small clips based on utterance timestamps from transcript. The feature extractor 3708 may extract features such as MFCC, STFT, Mel Spectrogram, extraction using Librosa and the like. The AI model 3710 may be a 1D CNN. The metadata output 3712 may be neutral, calm, happy, sad, angry, fearful, disgust, and surprise. At the emotion detection text side 3716, the input 3718 may be fed to a segmenter 3706, and then to the AI model 3720, to generate the metadata output 3722. The input 3718 may be a transcript. The segmenter 3706 may take one utterance transcript at a time. The AI model 3720 may be Off-the-shelf pretrained Distil Roberta. The metadata output 3722 may include a neutral, happy, sad, angry, fearful, disgust, and surprise. The metadata output 3712 and 3722 from both the emotion detection (text) 3716 and emotion detection (audio) 3702 is fed into the emotion detection (fusion) 3714 as shown in FIG. 37. The emotion detection fusion 3714 may include a metadata fusion a metadata fusion output. The metadata fusion may get the average of the two probability values for each emotion and the metadata fusion output may include neutral, calm, happy, sad, angry, fearful, disgust and surprise. FIGS. 38A-B illustrates exemplary representations of workflow for emotion detection (audio) in accordance with an embodiment. A 1D Convolutional Neural Network and Trained on RAVDESS (45 epochs, learning_rate=0.001) may be used for generating the metadata fusion output, as described in FIG. 37.

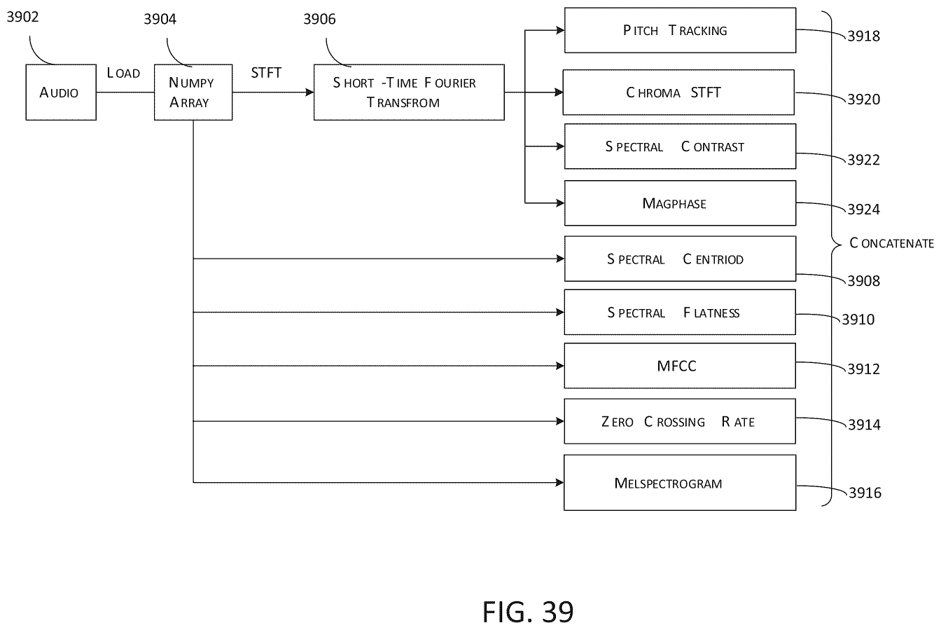

FIG. 39 illustrates an exemplary representation of workflow for feature processing for emotion detection (audio) in accordance with an embodiment. The input audio file 3902 is loaded to a NumPy array 3904. The output of the NumPy array 3904 is fed to a short-time Fourier transform 3906 and each of a spectral centroid 3908, a spectral flatness 3910, a MFCC 3912, a zero-crossing rate 3914, and a Mel spectrogram 3916. The spectral centroid 3908 provides a mean/standard or maximum centroid. The spectral flatness 3910 means flatness (noise like level). The MFCC 3912 provides a mean/standard or maximum mfcc (n_nfcc). The zero-crossing rate 3914 may provide mean zero crossing rate, and the Mel spectrogram 3916 may provide mean Mel spectrogram (n_mels). The short-time Fourier transform 3906 (1025, n_frames) are fed to each of a pitch tracking 3918, a chroma STFT 3920, a spectral contrast 3922 and a Magphase 3924. The pitch tracking 3918 may include a pitch tuning offset and a pitch mean/std/max/min value. The chroma STFT 3920 may include a mean chroma. The spectral contrast 3922 may include mean contrast (n_bands+1). The Magphase 3924 may include means/std/max magnitude and a mean/std/max root mean square. Each output is then concatenated as shown in FIG. 39.

In an example embodiment, no windowing or clipping is used and almost all features are statistic-based (mean/std/min/max). Hence, audio length does not affect the feature generation process.

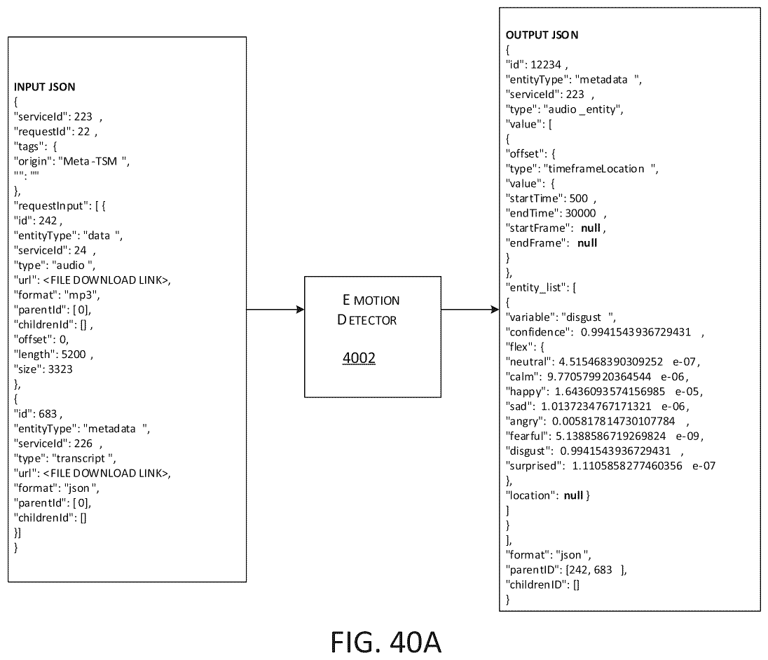

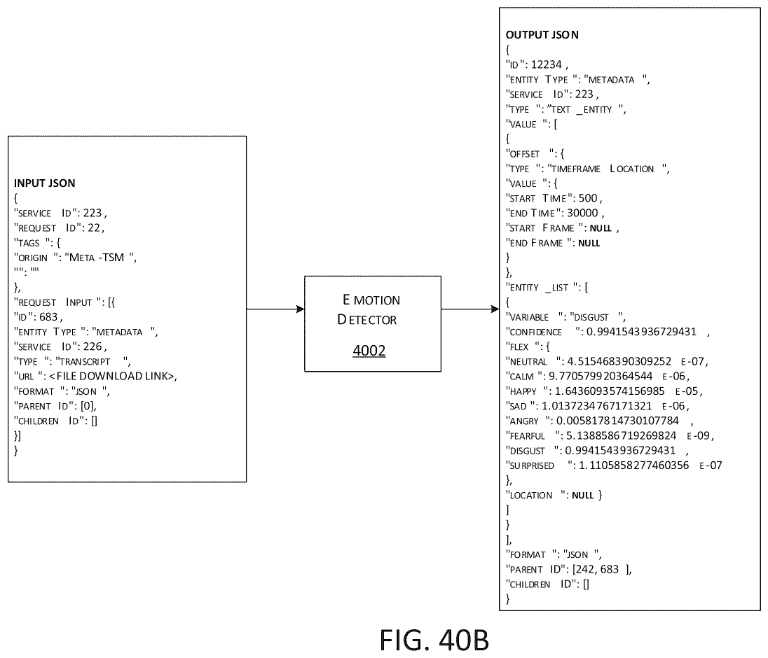

FIG. 40A illustrates an example API specification for emotion detection (audio) in accordance with an embodiment. The emotion detector 4002 receives an input data in JSON format and outputs a data in JSON format.

FIG. 40B illustrates an example API specification for emotion detection (text) in accordance with an embodiment. In an example embodiment, the emotion detection based on text may involve the steps of generating transcription from speech-to-text module and feeding it into the text-based emotion detection model. The emotion detection further includes the step of making a final prediction based on the weighted probabilities between two models, i.e., SER (Speech Emotion Recognition) and text model. A test accuracy of about 0.789 when equal weights were assigned to SER model and text model. Further, in an example embodiment, the seven emotions in the text model may be mapped to 8 emotions in the SER model. In an example embodiment, the text model may correspond to off-the-shelf model from Hugging Face (Distil Roberta model finetuned with six diverse dataset). It may be noted that the errors introduced by speech-to-text module can be propagated to downstream tasks (emotion recognition). In an example embodiment, seven emotions in text model may be mapped to eight emotions in SER model. For example, a joy emotion in text model may be mapped to happy emotions in SER model. Similarly, neutral to neutral mapping, sadness to sad, anger to angry, fear to fearful, disgust to disgust and surprise to surprise mapping may be employed.

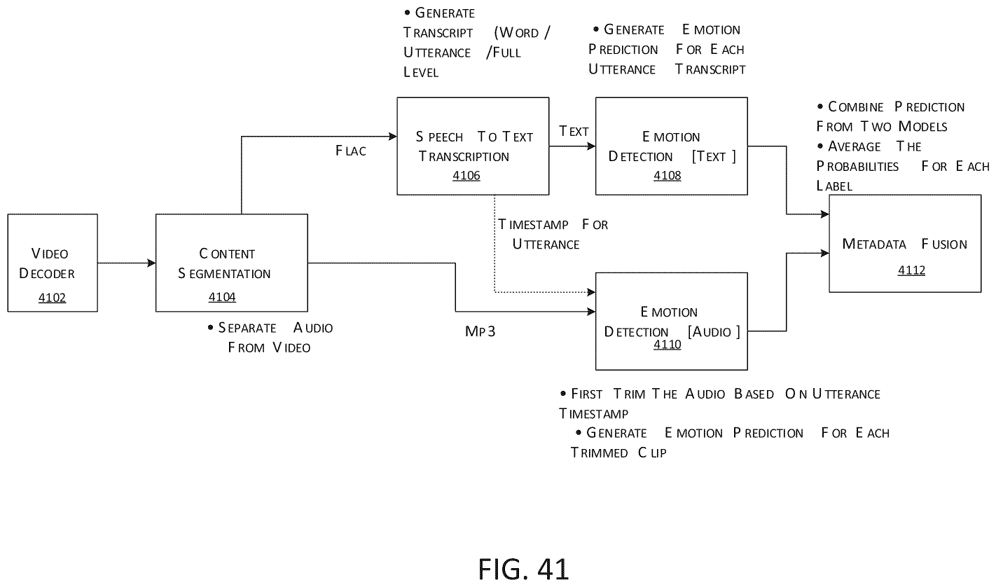

FIG. 41 illustrates an example block diagram of an emotion detection (fusion-text and audio) in accordance with an embodiment. The output of a video decoder 4102 is fed to a content segmentation 4104 for separate audio from video. The output of content segmentation 4104 is fed to a speech-to-text transcription 4106 for generating transcript (word/utterance/full level). Further, the output of the speech-to-text transcription 4106 is fed to emotion detection (text) 4108 and an emotion detection (audio) 4110. The emotion detection (text) 4108 generates emotion prediction for each utterance transcript and such output is fed to metadata fusion 4112. The metadata fusion 4112 is also fed with output of emotion detection (audio) 4110. The emotion detection (audio) 4110 first trims the audio based on utterance timestamp and generates emotion prediction for each trimmed clip. The emotion detection (audio) 4110 is also fed with timestamp for utterance from speech-to-text transcription 4106. The metadata fusion 4112 combines prediction from two models and averages the probabilities for each label.

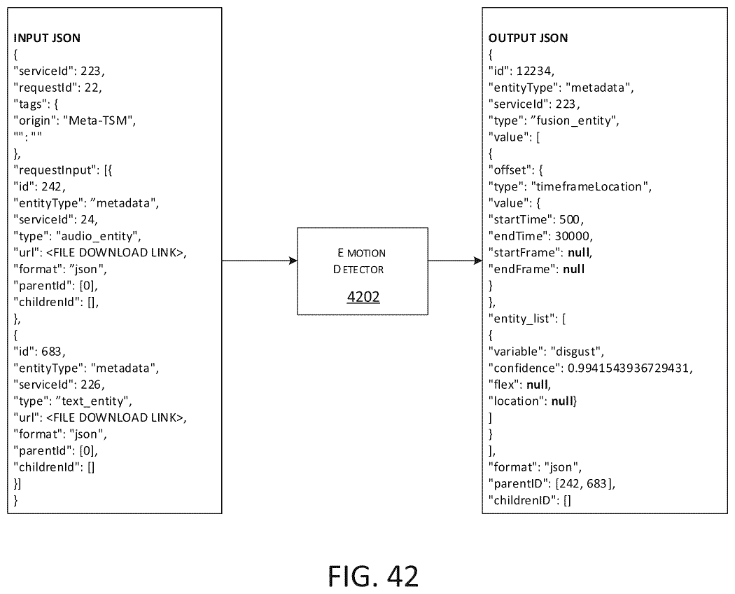

FIG. 42 illustrates an example API specification for emotion detection (fusion) in accordance with an embodiment. The emotion detector 4202 receives an input data in JSON format and outputs a data in JSON format.

Although, in FIG. 42 only some types of file formats are depicted, it may be understood by a person skilled in the art that the API design may be created for any other type of file formats known in the art. Although only some examples of the specific input file format are depicted, it may be understood by a person skilled in the art that the description above may be applicable for any other known file format including any API design, any input type, any model type, and any one or more values.

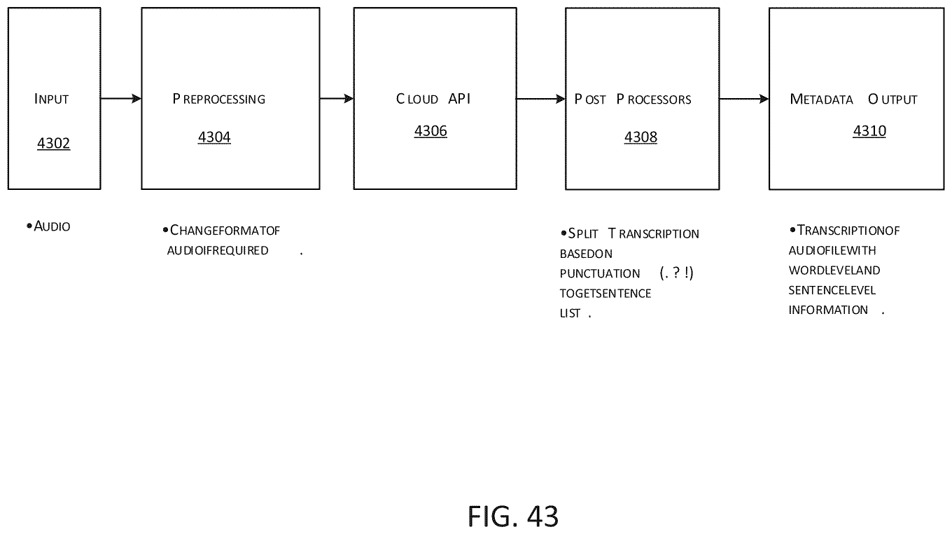

FIG. 43 illustrates a block diagram of an example STT transcription service in accordance with an embodiment. In an example embodiment, the platform 400 may also include STT transcription service. The objective is to generate a metadata output 4310 including a transcription and a timeframe information at a word and a sentence level for any given audio (input 4302) using cloud service. The input data 4302 may correspond to an audio file and the output 4310 may correspond to transcription for any given audio. The input 4302 is fed to preprocessing 4304 such as change format of audio required and then to a cloud API 4306, and a post processor 4308. The post processor 4308 may split transcription based on punctuation (.?!) to get a sentence list.

FIG. 44 illustrates an example API specification for STT transcription in accordance with an embodiment. The STT transcription 4402 receives an input data in JSON format and outputs a data in JSON format.

Although, in FIG. 44 only some types of file formats are depicted, it may be understood by a person skilled in the art that the API design may be created for any other type of file formats known in the art. Although only some examples of the specific input file format are depicted, it may be understood by a person skilled in the art that the description above may be applicable for any other known file format including any API design, any input type, any model type, and any one or more values.

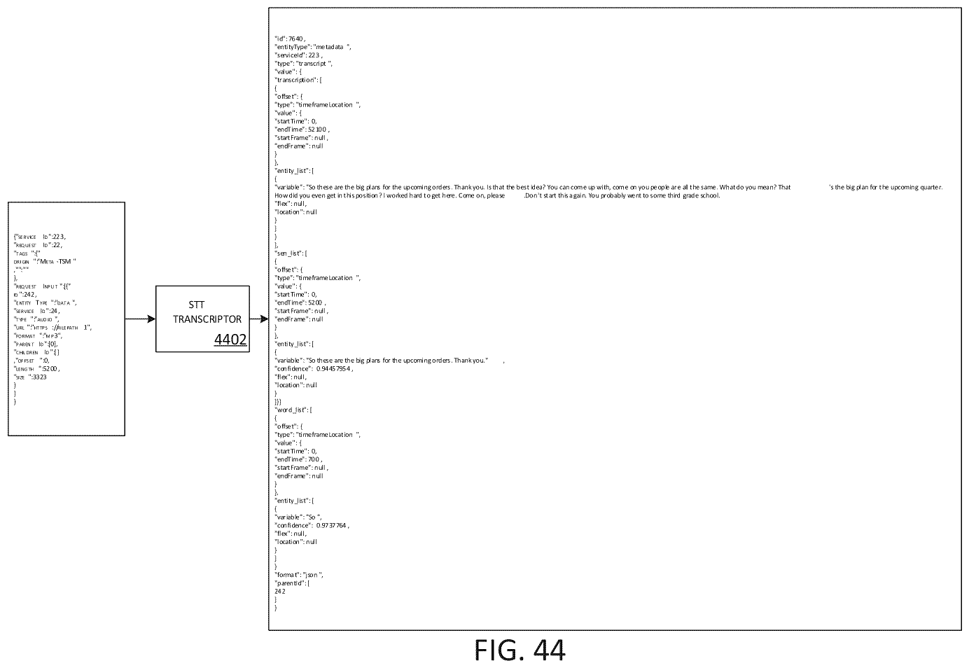

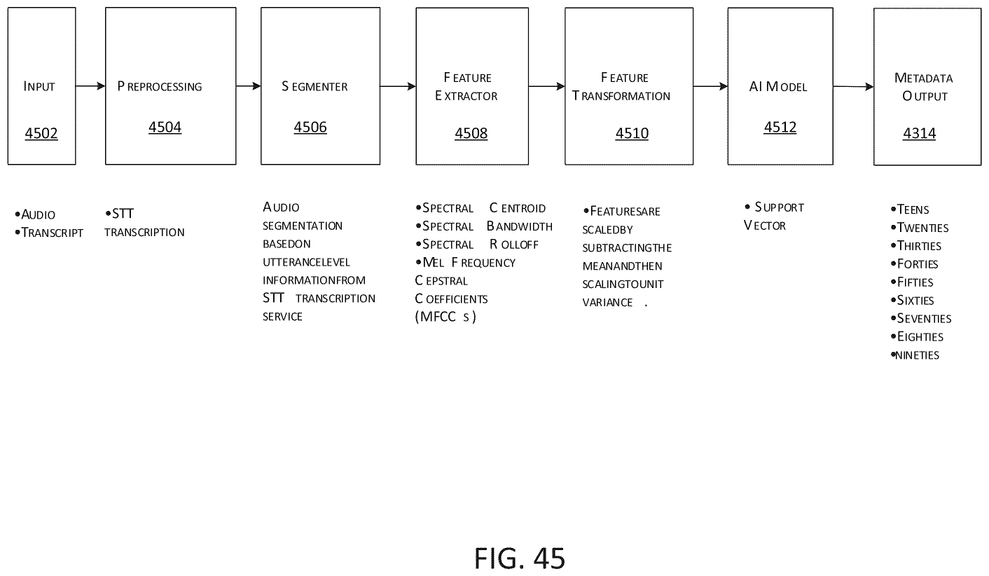

FIG. 45 illustrates a block diagram of an age detection workflow in accordance with an embodiment. In an example embodiment, the platform 400 may also include age detection service. The objective is to detect the age of the speaker for each utterance. The input data 4502 may correspond to audio file and a transcript. The input data 4502 is fed to a preprocessor 4504 which may include a STT transcription. The output of the preprocessor 4504 is fed to a segmenter 4506 which performs audio segmentation based on utterance level information from STT transcription service. The output of the segmenter 4506 is fed to a feature extractor 4508 which extracts features such as spectral centroid, spectral bandwidth, spectral Rolloff, and Mel Frequency Cepstral Coefficients (MFCCs). The output of the feature extractor 4508 is then fed to a feature transformation 4510 which scales the features by subtracting the mean and then scaling to unit variance. The output 4514 may correspond to an age class/label as described in the TABLE. 5 below.

TABLE 5

| Age Class | Description |
|---|---|
| teens | approximate age of the |
| | speaker is between 13 to 19 |
| twenties | approximate age of the |
| | speaker is between 20 to 29 |
| thirties | approximate age of the |
| | speaker is between 30 to 39 |
| forties | approximate age of the |
| | speaker is between 40 to 49 |
| fifties | approximate age of the |
| | speaker is between 50 to 59 |
| sixties | approximate age of the |
| | speaker is between 60 to 69 |
| seventies | approximate age of the |
| | speaker is between 70 to 79 |
| eighties | approximate age of the |
| | speaker is between 80 to 89 |
| nineties | approximate age of the |
| | speaker is 90 and above |

In an example embodiment, the service may provide features 4508 such as, a 23-tuple vector consisting of 20 Mel-frequency cepstral coefficients (MFCC), Spectral centroid, and Spectral Bandwidth and Spectral Rolloff. In an example embodiment, the service may implement AI model 4510 such as, for example, but not limited to a support vector machine. The experiment may include cross-validation. The metrics may be represented in terms of accuracy (around 82.3%), precision (around 77.6%), and recall (around 90.8%).

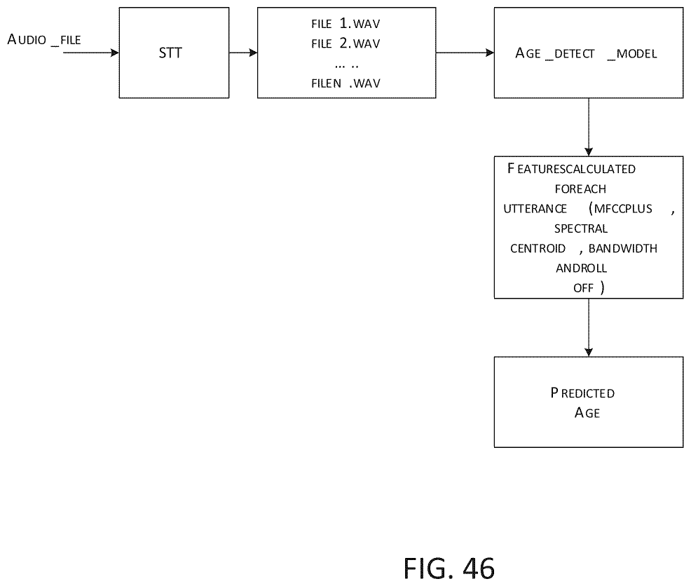

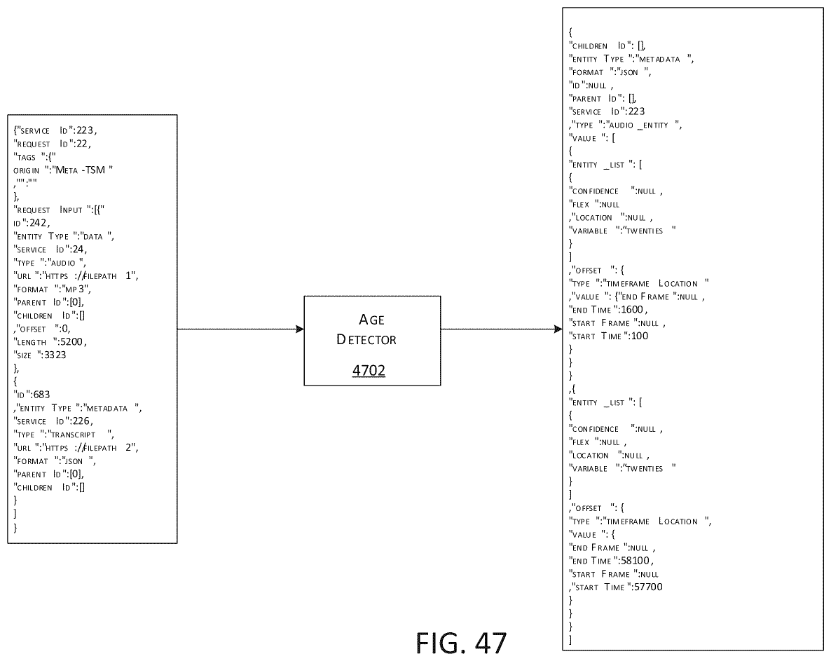

FIG. 46 illustrates an example workflow for age detection based on audio file in accordance with an embodiment. FIG. 47 illustrates an example API specification for age detection in accordance with an embodiment. The age detector 4702 receives an input data in JSON format and outputs a data in JSON format.

Although, in FIG. 47 only some types of file formats are depicted, it may be understood by a person skilled in the art that the API design may be created for any other type of file formats known in the art. Although only some examples of the specific input file format are depicted, it may be understood by a person skilled in the art that the description above may be applicable for any other known file format including any API design, any input type, any model type, and any one or more values.

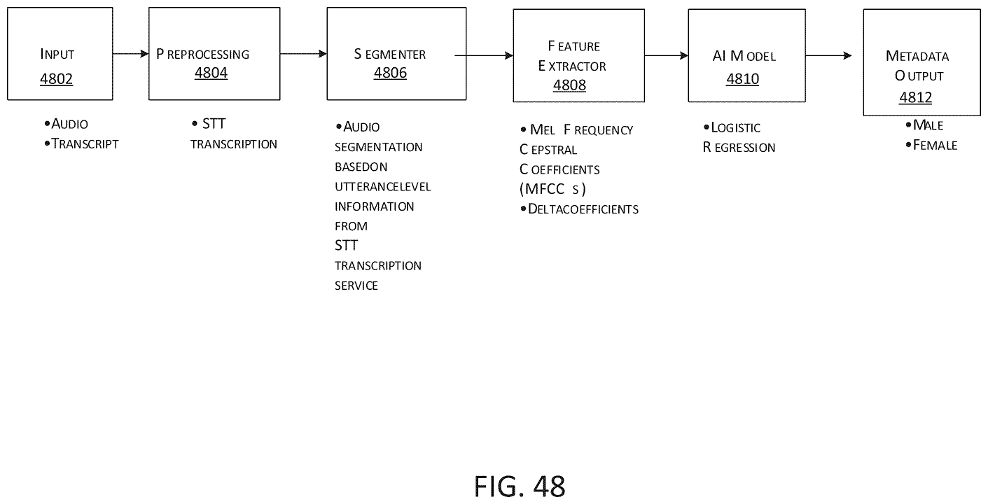

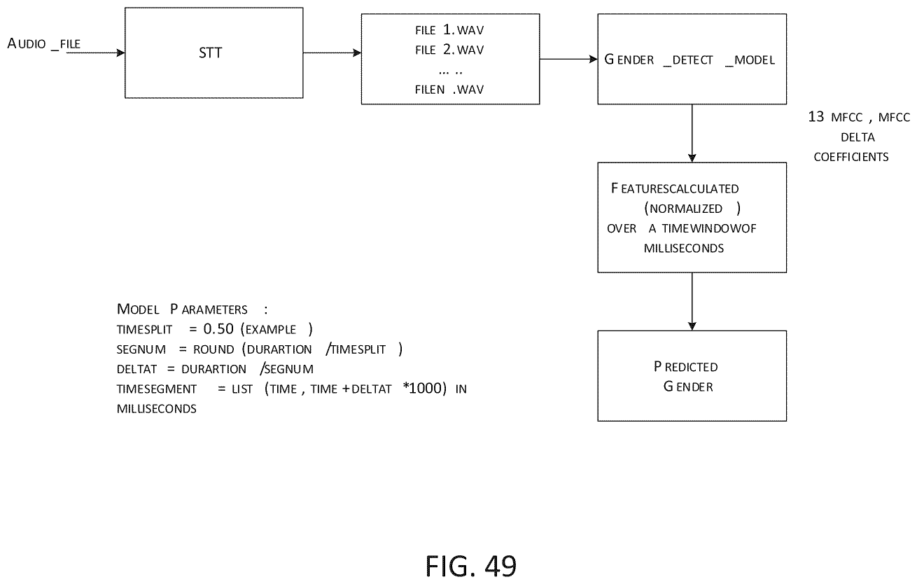

FIG. 48 illustrates a block diagram of an example gender detection in accordance with an embodiment. In an example embodiment, the platform 400 may also include gender detection service. The input 4802 may correspond to an audio file and/or transcript. The input data 4802 is fed to a preprocessor 4804 which may include a STT transcription. The output of the preprocessor 4804 is fed to a segmenter 4806 which performs audio segmentation based on utterance level information from STT transcription service. The output of the segmenter 4806 is fed to a feature extractor 4808 which extracts features such as Mel Frequency Cepstral Coefficients (MFCCs) and delta coefficients. The output of the feature extractor 4808 is then fed to an AI model 4810 including a logistic regression model. The metadata output 4812 may correspond to a male gender or a female gender. In an example embodiment, the gender detection service may provide features, such as, seventeen tuple vectors consisting of 13 Mel-frequency cepstral coefficients (MFCC) and MFCC delta coefficients (means, standard deviations, maximum and minimum). In an example embodiment, the gender detection service implements AI model 4810, such as, for example, but not limited to, a logistic regression. The experiment may include Cross-validation and the metrics: may be represented in terms of accuracy of about 89.7%. FIG. 49 illustrates an example workflow for gender detection in accordance with an embodiment. In an example embodiment, a model parameter may include a time split=0.50 (example), a segnum=round (duration/time split), a deltat=duration/segnum, and a time segment=list (time, time+deltat*1000) in milliseconds

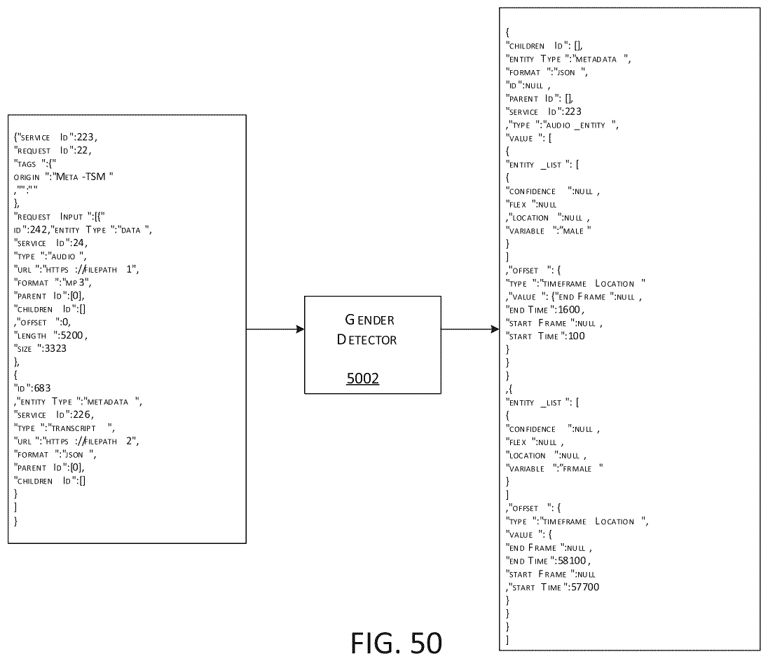

FIG. 50 illustrates an example API specification for gender detection in accordance with an embodiment. The gender detector 5002 receives an input data in JSON format and outputs a data in JSON format.

Although, in FIG. 50 only some types of file formats are depicted, it may be understood by a person skilled in the art that the API design may be created for any other type of file formats known in the art. Although only some examples of the specific input file format are depicted, it may be understood by a person skilled in the art that the description above may be applicable for any other known file format including any API design, any input type, any model type, and any one or more values.

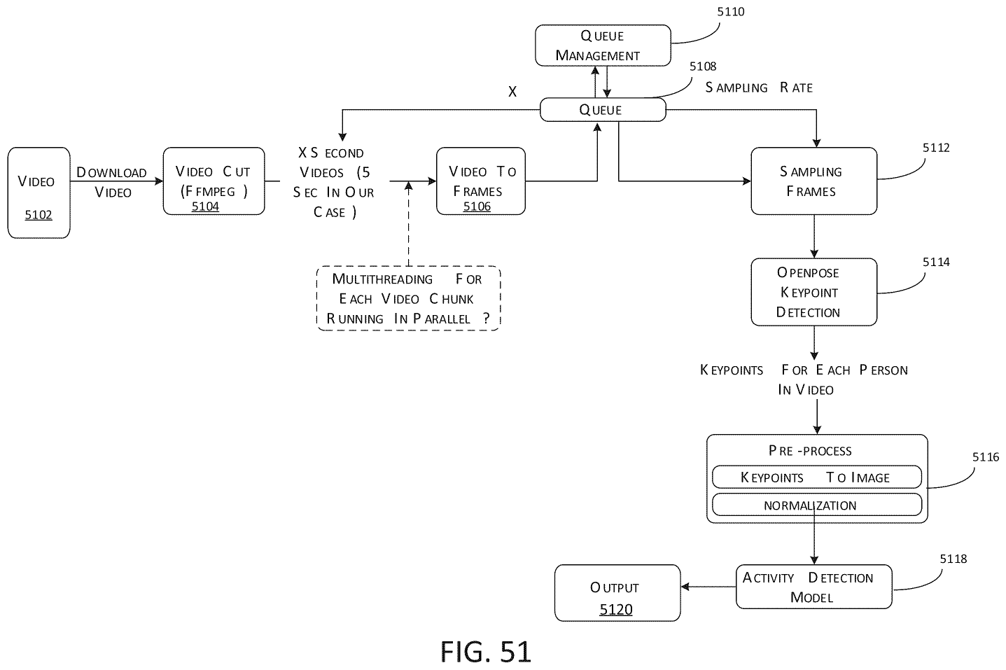

FIG. 51 illustrates an example workflow for two-dimensional activity detection (video) in accordance with an embodiment. The video 5102 is fed to video cut 5104. The output of the video cut 5104 may include x second videos (for example, 5 seconds), which is fed to the video to frames 5106. The output of the video to frame 5106 is fed to queue 5108 which communicates with a queue management 5110. The output of the queue 5108 is fed to sampling frames 5112, followed by open pose key point detection 5114. The open pose key point detection 5114 provides key points for each person in the video. Further, the preprocessor 5116 converts key points to images and performs normalization. The activity detection model 5118 receives the preprocessed output and generates the output 5120.

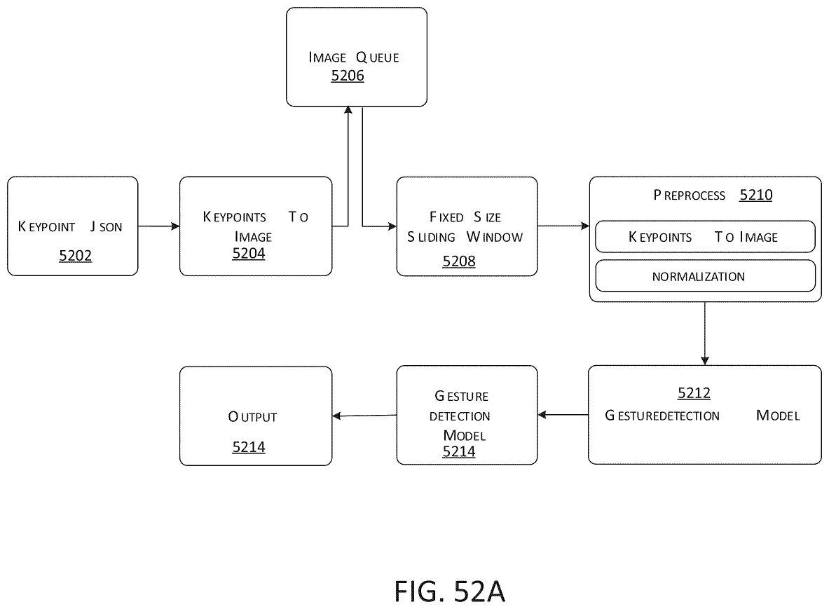

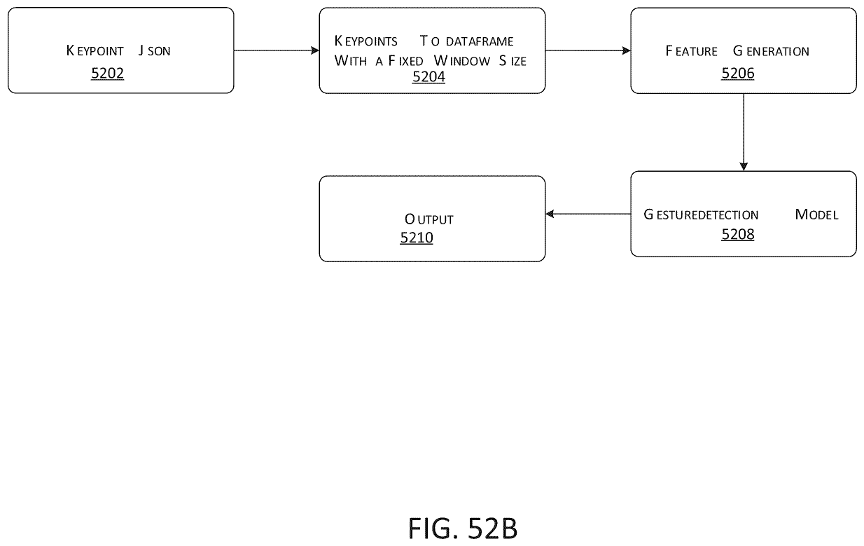

FIGS. 52A-B illustrates an example workflow for three-dimensional activity detection in accordance with an embodiment. The kepypoint JSON input 5202 is fed to a key point to image transform module 5204. The output of the key points to image transform module 5204 is fed to the image queue 5206. The output of the image queue 5206 is fed to the fixed size sliding window 5208. The output of the fixed size sliding window 5208 is fed to the preprocessor 5210. The output of the preprocessor 5210 is fed to the gesture detection model 5212 to generate the output 5214. FIG. 52B illustrates an example workflow for three-dimensional activity detection without streaming changes, in accordance with an embodiment. The key point JSON input 5202 is fed to a key point to data frame transform module 5204 with a fixed window size. The output of the key points to data frame transform module 5204 is fed to feature generation 5206. The output of the feature generation 5206 is fed to the gesture detection model 5208 to generate the output 5210.

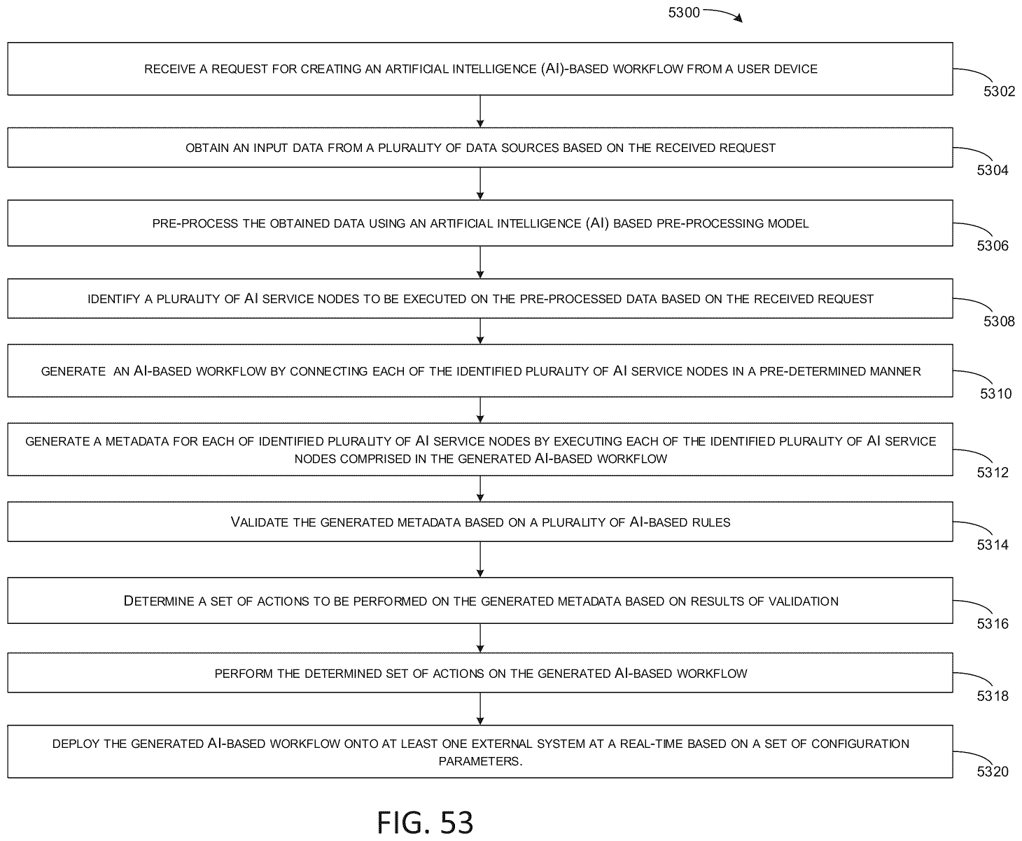

FIG. 53 illustrates an example flowchart representation of method 5300 for codeless creation of artificial intelligence (AI) and and generative AI based workflows, in accordance with embodiments of the present disclosure.

At step 5302, the method 5300 includes receiving, by a processor 110, a request for creating an artificial intelligence (AI)-based workflow from a user device 106. At step 5304, the method 5300 includes obtaining, by the processor 110, an input data from a plurality of data sources based on the received request. At step 5306, the method 5300 includes pre-processing, by the processor 110, the obtained data using an artificial intelligence (AI) based pre-processing model. Further, at step 5308, the method 5300 includes identifying, by the processor 110, a plurality of AI and Generative AI service nodes to be executed on the pre-processed data based on the received request. The plurality of AI and Generative AI service nodes may include a functional task to be executed on the pre-processed data. The plurality of AI and Generative AI service nodes may include a plurality of processing nodes. At step 5310, the method 5300 includes generating, by the processor 110, an AI-based workflow by connecting each of the identified plurality of AI and Generative AI service nodes in a pre-determined manner. The AI-based workflow may include the identified plurality of AI and Generative AI service nodes to be executed, an order of execution, and a service configuration. The AI-based workflow may include a workflow description. Further, at step 5312, the method 5300 includes generating, by the processor 110, a metadata for each of identified plurality of AI and Generative AI service nodes by executing each of the identified plurality of AI and Generative AI service nodes comprised in the generated AI-based workflow. The metadata is generated at each stage of execution of the plurality of AI and Generative AI service nodes. At step 5314, the method 5300 includes validating, by the processor 110, the generated metadata based on a plurality of AI-based rules. At step 5316, the method 5300 includes determining, by the processor 110, a set of actions to be performed on the generated metadata based on results of validation. Furthermore, at step 5318, the method 5300 includes performing, by the processor 110, the determined set of actions on the generated AI-based workflow. At step 5320, the method 5300 includes deploying, by the processor 110, the generated AI-based workflow onto at least one external system based on a set of configuration parameters.

In identifying the plurality of AI and Generative AI service nodes to be executed on the pre-processed data based on the received request, the method 5300 includes determining, by the processor 110, a plurality of functional tasks to be performed for each type of the plurality of multi-media files based on the received request. Further, the method 5300 includes tagging, by the processor 110, the determined plurality of functional tasks to each type of the plurality of multi-media files. The method 5300 includes determining, by the processor 110, the plurality of processing nodes corresponding to the determined plurality of functional tasks. The plurality of processing nodes is to perform a computation within the determined plurality of functional tasks. Furthermore, the method 5300 includes configuring, by the processor 110, the determined plurality of processing nodes based on the received request; and identifying, by the processor 110, the plurality of AI and Generative AI service nodes corresponding to the configured plurality of processing nodes.

In generating the AI-based workflow by connecting each of the identified plurality of AI and Generative AI service nodes in the pre-determined manner, the method 5300 includes determining, by the processor 110, a service configuration of the identified plurality of AI and Generative AI service nodes based on a type of an AI service node and identifying, by the processor 110, an order of execution for the identified plurality of AI and Generative AI service nodes based on a data flow of the pre-processed data and a type of the plurality of functional tasks. Further, the method 5300 includes determining, by the processor 110, a flow path between the identified plurality of AI and Generative AI service nodes based on the identified order of execution and the determined service configuration. The identified plurality of AI and Generative AI service nodes is dragged and dropped at a plurality of node locations. The method 5300 further includes connecting, by the processor 110, each of the identified plurality of AI and Generative AI service nodes based on the determined flow path; and generating, by the processor 110, the AI-based workflow comprising the identified plurality of AI and Generative AI service nodes to be executed, the order of execution, and the service configuration based on the connection. The AI-based workflow may include the workflow description. The AI-based workflow may include a starting service node, an intermediate service node and an ending service node connected in the order of execution and based on the determined flow path.

In executing each of the identified plurality of AI and Generative AI service nodes comprised in the generated AI-based workflow, the method 5300 include analyzing, by the processor 110, the workflow descriptor associated with each of the identified plurality of AI and Generative AI service nodes. The workflow descriptor comprises data objects in a human-readable format. Further, the method 5300 includes instantiating, by the processor 110, each of the plurality of AI and Generative AI service nodes in the generated AI-based workflow and performing, by the processor 110, a functional task associated with each of the plurality of AI and Generative AI service nodes in the order of execution. Furthermore, the method 5300 incudes generating, by the processor 110, the metadata for each of the identified plurality of AI and Generative AI service nodes at each stage of execution of the functional task and fusing, by the processor 110, the metadata generated at each stage with corresponding data objects of an AI service node. Further, the method 5300 includes generating, by the processor 110, fused metadata output at each stage of execution of the functional task.

In validating the generated metadata based on the plurality of AI-based rules, the method 5300 includes obtaining, by the processor 110, a list of the generated metadata, policy set identifiers (IDs) and parameters for metadata processing and segmenting, by the processor 110, each of the generated metadata in the list into a plurality of data segments using a sliding window. Further, the method 5300 include determining, by the processor 110, the plurality of AI-based rules associated with the plurality of data segments based on a pre-stored rule database and validating, by the processor 110, the generated metadata by applying the determined plurality of AI-based rules to the generated metadata. Additionally, the method 5300 includes generating, by the processor 110, a confidence score for the generated metadata based on the validation. The confidence score comprises one of a low confidence score and a high confidence score. Further, the method 5300 includes determining, by the processor 110, the set of actions to be performed on the generated metadata based on the generated confidence score. The confidence score corresponds to the high confidence score. The set of actions comprise at least one of a locally executable part of code within a system 102 and integrations with the at least one external system 116. The method 5300 includes routing, by the processor 110, the received request to an agent system 116 for resolution based on the generated confidence score. The confidence score corresponds to the low confidence score, and the received request is resolved by the agent system 116 by assessing, by the processor 110, the received request based on a description, a priority level, a business line, and product information and determining, by the processor 110, a request description score and a request priority score for the received request based on the assessment. Further, the method 5300 includes identifying, by the processor 110, issue resolution pain-points for the received request to be resolved by the agent system and determining, by the processor 110, an appropriate agent corresponding to the received request based on at least one of the determined request description score, the request priority score, the priority level, identified issue resolution pain points, a resolution method, and a resolution sequence. The appropriate agent is determined by constructing a working agent finding model and assigning, by the processor 110, the received request to the determined appropriate agent/The method 5300 further includes periodically monitoring, by the processor 110, monitor a request progress at the agent system based on feedback from the agent system, interaction logs and a status report; and continuously updating, by the processor 110, the rule database with learnings from the agent system upon resolving the received request, wherein the learnings comprise at least one of an issue category, knowledge base records, and operational support records.

In an embodiment, method 5300 further includes analyzing, by the processor 110, workflow descriptors associated with each of the identified plurality of AI and Generative AI service nodes. The workflow descriptors comprise data objects in a human-readable format. Further the method 5200 includes instantiating, by the processor 110, each of the plurality of AI and Generative AI service nodes in the generated AI-based workflow and performing, by the processor 110, the functional task associated with each of the plurality of AI and Generative AI service nodes in the order of execution. Furthermore, the method 5200 includes measuring, by the processor 110, an execution time of each of the processing nodes within the plurality of AI and Generative AI service nodes; and validating, by the processor 110, the generated AI-based workflow based on at least one of the measured execution time, a processing node description, code functions, and the analyzed workflow descriptors. Furthermore, the method 5300 includes generating, by the processor 110, an updated AI-based workflow based on results of validation by modifying the AI-based workflow with updated processing nodes and corresponding AI-based service nodes. Further, the method 5300 includes re-computing, by the processor 110, the execution time of each of the updated processing nodes; and tuning, by the processor 110, the updated AI-based workflow based on the re-computed execution time using an AI-based optimization method. Furthermore, the method 5300 includes generating, by the processor 110, a ranked list of workflows and node configurations based on the tuned AI-based workflow; and modifying, by the processor, container implementation information for each of the AI-based service nodes comprised within each of the generated ranked list of workflows and the node configurations.

In deploying the generated AI-based workflow onto the at least one external systems at the real-time based on the set of configuration parameters, the method 5300 includes analyzing, by the processor 110, workflow descriptors associated with each of the identified plurality of AI and Generative AI service nodes. The workflow descriptors comprise data objects in a human-readable format. The method 5300 further includes mapping, by the processor 110, the analyzed workflow descriptors to a target external system and performing, by the processor 110, network connection tests at the target external system for deploying the generated AI-based workflow onto the target external system/Furthermore, the method 5300 includes instantiating, by the processor 110, AI-based services corresponding to the generated AI-based workflow as containers at the target external system. The method further includes executing, by the processor 110, each of the identified plurality of AI and Generative AI service nodes at the target external system in the pre-determined manner based on the generated AI-based workflow/Additionally, the method 5300 includes validating, by the processor 110, the execution of each of the identified plurality of AI and Generative AI service nodes at the target external system and generating, by the processor 110, a deployment successful message upon successful validation of the execution of each of the identified plurality of AI and Generative AI service nodes at the target external system. Furthermore, the method 5300 includes generating, by the processor 110, a deployment failure message upon failure of the execution of each of the identified plurality of AI and Generative AI service nodes at the target external system. The deployment failure message comprises one or more execution errors detected during execution. The method 5300 includes performing, by the processor 110, one or more actions to rectify the one or more execution errors at the target external system.

The method 5300 may be implemented in any suitable hardware, software, firmware, or combination thereof. The order in which the method 5300 is described is not intended to be construed as a limitation, and any number of the described method blocks may be combined or otherwise performed in any order to implement the method 5300 or an alternate method. Additionally, individual blocks may be deleted from the method 5300 without departing from the spirit and scope of the present disclosure described herein. Furthermore, the method 5300 may be implemented in any suitable hardware, software, firmware, or a combination thereof, that exists in the related art or that is later developed. The method 5300 describes, without limitation, the implementation of the system 102. A person of skill in the art will understand that method 5300 may be modified appropriately for implementation in various manners without departing from the scope and spirit of the disclosure.

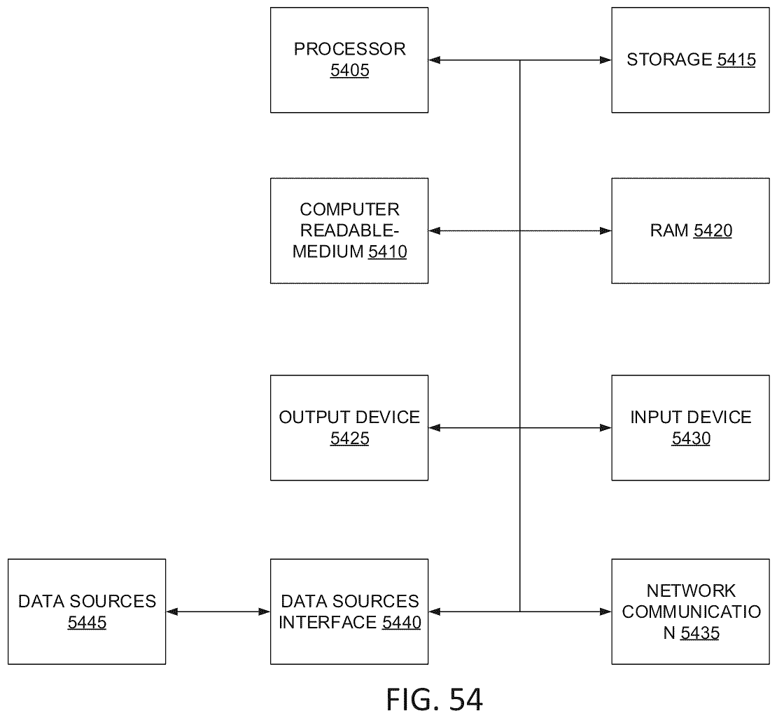

FIG. 54 illustrates an exemplary block diagram representation of a hardware platform 5400 for implementation of the disclosed system 102, in accordance with embodiments of the present disclosure. For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform 5400. As illustrated, the hardware platform 5400 may include additional components not shown, and some of the components described may be removed and/or modified. For example, a computer system with multiple GPUs may be located on external-cloud platforms including amazon web Services® (AWS), internal corporate cloud computing clusters, or organizational computing resources.

The hardware platform 5400 may be a computer system such as the system 102 that may be used with the embodiments described herein. The computer system 102 may represent a computational platform that includes components that may be in a server or another computer system. The computer system 102 may be executed by the processor 5405 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., random access memory (RAM), read-only memory (ROM), erasable, programmable ROM (EPROM), electrically erasable, programmable ROM (EEPROM), hard drives, and flash memory). The computer system may include the processor 5405 that executes software instructions or code stored on a non-transitory computer-readable storage medium 5415 to perform methods of the present disclosure. The software code includes, for example, instructions to gather data and analyze the data.

The instructions on the computer-readable storage medium 5415 are read and stored the instructions in storage 5415 or random-access memory (RAM). The computer-readable storage medium 5415 may provide a space for keeping static data where at least some instructions could be stored for later execution. The stored instructions may be further compiled to generate other representations of the instructions and dynamically stored in the RAM such as RAM 5420. The processor 5405 may read instructions from the RAM 5420 and perform actions as instructed.

The computer system may further include the output device 5425 to provide at least some of the results of the execution as output including, but not limited to, visual information to users, such as external agents. The output device 5425 may include a display on computing devices and virtual reality glasses. For example, the display may be a mobile phone screen or a laptop screen. GUIs and/or text may be presented as an output on the display screen. The computer system may further include an input device 5430 to provide a user or another device with mechanisms for entering data and/or otherwise interacting with the computer system. The input device 5430 may include, for example, a keyboard, a keypad, a mouse, or a touchscreen. Each of these output devices 5425 and input device 5430 may be joined by one or more additional peripherals. For example, the output device 5425 may be used to display the results such as bot responses by the executable chatbot.

A network communicator 5435 may be provided to connect the computer system to a network and in turn to other devices connected to the network including other clients, servers, data stores, and interfaces, for example. A network communicator 5435 may include, for example, a network adapter such as a LAN adapter or a wireless adapter. The computer system may include a data sources interface 5440 to access the data source interface 5445. The data source interface 5440 may be an information resource. As an example, a database of exceptions and rules may be provided as the data source interface 5445. Moreover, knowledge repositories and curated data may be other examples of the data source interface 5445.

The present disclosure provides a system and method for codeless creation of artificial intelligence (AI) and generative AI based workflows. The present system provides a human plus machine platform for Business Process Services (BPS) which may be used to create AI-based solutions in a short duration, such as, for example, in a few minutes. The implementation of the system/platform is achieved in a codeless manner and may be applicable for many potential use cases involving multiple input data such as, but not limited to, images, audio, video, documents, and the like. Further, the present system discloses workflows, which include data connections, pre-processors, AI detectors, Generative AI detectors, routing to agents, and action triggering based on a configurable rule engine that may be compiled and deployed in the order of minutes, for example, to any target cloud vendor. The disclosed system provides generic modules to edit the rules in a human understandable manner (for example, using JSON format) as well as generic GUIs to achieve multiple features. For example, the system may enable users to visualize the events that are detected by the AI, localize them within the data stream, and view the automatic action taken by the AI. If the AI is not confident enough, the system may automatically route the work to the best available human agent based on their training, education, and past experience in solving similar issues for actioning purposes. The disclosed system leverages AI to proactively detect events, educate users and trigger configurable actions amongst other things.

The disclosed embodiments of the system provide a generic configurable pipeline workflow, a modular design for third party contributors, an orchestration engine to instantiate pipelines in real-time, a rule engine for auto-actioning, a graphical rule engine configuration editor, and a user historic profile scoring. The disclosed embodiment of the system further provides context-aware multi-level polices, a multimodal visualizer of events level polices, a multimodal visualizer of events and actions, a real-time computational efficiency optimizer, a time computational efficiency optimizer, and a shallow and deep integration with virtual environment. In an example embodiment, the features of the disclosed system may be implemented in several technology stacks, clouds platforms and programming languages.

There are numerous advantages of the disclosed system for an organization that provides or implements AI solutions. For example, the system, being generic and scalable, significantly lowers the development timeline involved with creating AI solutions for multiple use cases. The resulting AI solution standardizes and builds a reusable library of: (1) data connectors, (2) AI and Generative AI detectors and models, (3) rule knowledge cartages that are sets of rules reusable for specific areas, and (4) actions on third party systems within the organization.

Currently, in certain scenarios, it takes around 6-9 months for an organization to deliver an AI solution to its clients. This is because the organization spends time building custom code, AI algorithms, system integrations, and graphical interfaces that are not fully reusable across multiple clients. Additional delays may be due to approvals required to access data in production for AI training. Such a development speed for AI solutions may not be acceptable, as it makes the solutions expensive and slows down the innovation process. This is because more time is spent on working on the same software engineering tasks and similar AI algorithmic problems rather than solving new and distinct ones.

The present system overcomes the above-mentioned problem by providing an end-to-end system that develops AI solutions for a variety of client use cases such as, but not limited to, generative AI, metaverse, gaming, streaming audio/video, images, and social media due to a plurality of characteristics. In an embodiment, the plurality of characteristics may include a flexible and a modular architecture, customizable rules, an intelligent agent routing, and continuous learning. The system also embodies a single, integrated end-to-end platform, reduces AI solution development time, allows reusability by building libraries of AI algorithms, integrations, actions, and rule polices, and higher decision-making confidence due to continuous learning.

Further, the present systems provide auto-actioning via AI rule engine, which includes proactive detection, decisioning, and actioning using AI and rules, and explain ability. Further, the system provides shallow and deep integration with multi-user environments by integrating at different integration points in a multi-user environment such as video feeds, audio feeds, controller data feeds, headset feeds, and the like. Furthermore, the systems provide AI context aware multi-level policies by allowing for policy configuration at different levels such as user, multi-user, platform, environment, and different contexts, such as friends, family, and legal environments. The system further provides multimodal visualization of events and actions by providing generic GUIs to view multi-modal data and highlight events detected and actions. Further, the system provides real-time computational efficiency optimizer by ingesting the workflow configuration and analysing each processing node in the workflow for computational optimization opportunities such as the extraction of common computation steps across services. Additionally, the system provides standardization of AI modules/detectors by standardizing the input output of AI modules for connectivity and reusability across the company.

The present system provides context aware multi-level policies by allowing policy creation depending on the user context as detected by the AI such as being with friends, family, legal environments, and the like. The present system also supports conventional policy creation per user group, region, country, deployment, application, environment type (prod, dev, and the like).

The present system provides multi-modal behaviour and action detection for new virtual functionalities. In most systems, actions can be triggered based on system events, but not over novel detection of user behaviour, actions and gestures combining CV, point cloud, and signal analysis data. Further, the present system provides Emotion based Actioning (audio, video, future sensors). In an embodiment, the usage of detection and interpretation methods from affective computing to provide additional context to scenario when making decisions and triggering actions. For example, device sensors that may measure heart rate, pupil dilation and the like may be used to sense emotional state beyond current methods using transcribed text and speech tone. Further, configurable rule engine to detect Complex behaviours and Content is disclosed. In an embodiment, machine actionable rules customizable per jurisdiction, maturity level, or other environmental reason is disclosed which may be generated using top-down policy-rule approach, or bottom-up learn-by-example approach from user behaviour or system actions. Further, the present system provides metadata attribute based NFT Monitoring by using NFT image attributes such as object in the scene, scene category, similarity with other images to trigger actions on NFT images. Additionally, the present system provides localized spatial behaviour detection in virtual world environments by identifying clusters of interacting entities (avatars) in a virtual world based on coordinate positions and contextual information and detect group behaviour.

The present system has implemented a machine platform for business processes and services, multi-user environments and beyond that may be used to create AI-based solutions in minutes instead of months or years. This is performed by leveraging AI itself to create AI applications in a codeless manner for many use cases involving multiple input data such as Images, audio, video, documents, and the like in bususiness processes and virtual multi-user environments such as, for example, but not limited to, Generative AI and metaverse applications. The composed workflow, which includes data connections, pre-processors, AI detectors, routing to human agents, and automatic action triggering based on a configurable generative AI rule engine. These components can be compiled and deployed in the order of minutes to any target cloud vendor. The platform comes with generic modules to edit the rules in a human understandable manner, or automatically create rules using generative AI based on specific use case documentation, as well as generic GUIs to visualize the events that are detected by the AI, localize them within the data stream, and view the automatic action taken by the AI. If the AI is not confident enough, the platform automatically routes the work to the best available human agent based on their training, education, past experience solving similar issues for actioning purposes. The platform leverages AI to proactively detect events, educate users and trigger configurable actions. The platform works in real-time with streaming data from different sources (documents, audio, video, images) and also in batch mode, where data processing happens in the background in a non real-time fashion for later consumption.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, and the like. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A system comprising:
a processor; and
a memory coupled to the processor, wherein the memory comprises processor-executable instructions, which on execution, cause the processor to:
receive a request for creating an artificial intelligence (AI)-based workflow from a user device;
obtain an input data from a plurality of data sources based on the received request;
pre-process the obtained data using an artificial intelligence (AI) based pre-processing model;
identify a plurality of AI and Generative AI service nodes to be executed on the pre-processed data based on the received request, wherein the plurality of AI and Generative AI service nodes comprise a functional task to be executed on the pre-processed data and wherein the plurality of AI and Generative AI service nodes comprise a plurality of processing nodes;
generate an AI-based workflow by connecting each of the identified plurality of AI and Generative AI service nodes in a pre-determined manner, wherein the AI-based workflow comprises the identified plurality of AI and Generative AI service nodes to be executed, an order of execution, and a service configuration, and wherein the AI-based workflow comprises a workflow description;
generate a metadata for each of identified plurality of AI and Generative AI service nodes by executing each of the identified plurality of AI and Generative AI service nodes comprised in the generated AI-based workflow, wherein the metadata is generated at each stage of execution of the plurality of AI and Generative AI service nodes;
validate the generated metadata based on a plurality of AI-based rules;
determine a set of actions to be performed on the generated metadata based on results of validation;
perform the determined set of actions on the generated AI-based workflow; and
deploy the generated AI-based workflow onto at least one external system based on a set of configuration parameters.

2. The system of claim 1, wherein the processor is to pre-process the obtained data using the artificial intelligence (AI) based pre-processing model by:
identifying a type of data format associated with the obtained data, wherein the type of data format comprises a multi-media data format;
classifying the obtained data into a plurality of categories based on content of the obtained data; and
segmenting the obtained data into a plurality of multi-media files based on the plurality of categories, wherein each of the plurality of multi-media files comprise data objects and data object descriptors.

3. The system of claim 1, wherein the processor is to identify the plurality of AI and Generative AI service nodes to be executed on the pre-processed data based on the received request by:
determining a plurality of functional tasks to be performed for each type of the plurality of multi-media files based on the received request;
tagging the determined plurality of functional tasks to each type of the plurality of multi-media files;
determining the plurality of processing nodes corresponding to the determined plurality of functional tasks, wherein the plurality of processing nodes is to perform a computation within the determined plurality of functional tasks;
configuring the determined plurality of processing nodes based on the received request; and
identifying the plurality of AI and Generative AI service nodes corresponding to the configured plurality of processing nodes.

4. The system of claim 1, wherein the processor is to generate the AI-based workflow by connecting each of the identified plurality of AI and Generative AI service nodes in the pre-determined manner by:
determining a service configuration of the identified plurality of AI and Generative AI service nodes based on a type of an AI service node;
identifying an order of execution for the identified plurality of AI and Generative AI service nodes based on a data flow of the pre-processed data and a type of the plurality of functional tasks;
determining a flow path between the identified plurality of AI and Generative AI service nodes based on the identified order of execution and the determined service configuration, wherein the identified plurality of AI and Generative AI service nodes are dragged and dropped at a plurality of node locations;
connecting each of the identified plurality of AI and Generative AI service nodes based on the determined flow path; and
generating the AI-based workflow comprising the identified plurality of AI and Generative AI service nodes to be executed, the order of execution, and the service configuration based on the connection, wherein the AI-based workflow comprises the workflow description and wherein the AI-based workflow comprises a starting service node, an intermediate service node and an ending service node connected in the order of execution and based on the determined flow path.

5. The system of claim 1, wherein the processor is to execute each of the identified plurality of AI and Generative AI service nodes comprised in the generated AI-based workflow by:
analyzing the workflow descriptor associated with each of the identified plurality of AI and Generative AI service nodes, wherein the workflow descriptor comprises data objects in a human-readable format;
instantiating each of the plurality of AI and Generative AI service nodes in the generated AI-based workflow;
performing a functional task associated with each of the plurality of AI and Generative AI service nodes in the order of execution;
generating the metadata for each of the identified plurality of AI and Generative AI service nodes at each stage of execution of the functional task;
fusing the metadata generated at each stage with corresponding data objects of an AI service node; and
generating a fused metadata output at each stage of execution of the functional task.

6. The system of claim 1, wherein the processor is to validate the generated metadata based on the plurality of AI-based rules by:
obtaining a list of the generated metadata, policy set identifiers (IDs) and parameters for metadata processing;
segmenting each of the generated metadata in the list into a plurality of data segments using a sliding window;
determining the plurality of AI-based rules associated with the plurality of data segments based on a pre-stored rule database;
validating the generated metadata by applying the determined plurality of AI-based rules to the generated metadata; and
generating a confidence score for the generated metadata based on the validation, wherein the confidence score comprises one of a low confidence score and a high confidence score.

7. The system of claim 6, wherein the processor is to:
determine the set of actions to be performed on the generated metadata based on the generated confidence score, wherein the confidence score corresponds to the high confidence score, and wherein the set of actions comprise at least one of a locally executable part of code within a system and integrations with the at least one external system; and
route the received request to an agent system for resolution based on the generated confidence score, wherein the confidence score corresponds to the low confidence score, and wherein a processor at the agent system is to resolve the received request by:
assessing the received request based on a description, a priority level, a business line, and product information;
determining a request description score and a request priority score for the received request based on the assessment;
identifying issue resolution pain-points for the received request to be resolved by the agent system;
determining an appropriate agent corresponding to the received request based on at least one of the determined request description score, the request priority score, the priority level, identified issue resolution pain points, a resolution method, and a resolution sequence, wherein the appropriate agent is determined by constructing a working agent finding model;
assigning the received request to the determined appropriate agent;
periodically monitoring a request progress at the agent system based on feedback from the agent system, interaction logs and a status report; and
continuously updating the rule database with learnings from the agent system upon resolving the received request, wherein the learnings comprise at least one of an issue category, knowledge base records, and operational support records.

8. The system of claim 6, wherein the processor is to:
generate the plurality of AI-based rules based on at least one of a metadata existence, a data formatting and logic inconsistencies between an existing rule and an updated rule, wherein the plurality of AI-based rules are configured with updated metadata; and
periodically modify the plurality of AI-based rules based on the updated metadata, a plurality of events detected by an AI service node, the received request, and the plurality of AI and Generative AI service nodes, wherein each of the modified plurality of AI-based rules are assigned with corresponding confidence scores and actions to be performed.

9. The system of claim 1, wherein the processor is to:
analyze workflow descriptors associated with each of the identified plurality of AI and Generative AI service nodes, wherein the workflow descriptors comprise data objects in a human-readable format;
instantiate each of the plurality of AI and Generative AI service nodes in the generated AI-based workflow;
perform the functional task associated with each of the plurality of AI and Generative AI service nodes in the order of execution;
measure an execution time of each of the processing nodes within the plurality of AI and Generative AI service nodes;
validate the generated AI-based workflow based on at least one of the measured execution time, a processing node description, code functions, and the analyzed workflow descriptors;
generate an updated AI-based workflow based on results of validation by modifying the AI-based workflow with updated processing nodes and corresponding AI-based service nodes;
re-compute the execution time of each of the updated processing nodes;
tune the updated AI-based workflow based on the re-computed execution time using an AI-based optimization method;
generate a ranked list of workflows and node configurations based on the tuned AI-based workflow; and
modify container implementation information for each of the AI-based service nodes comprised within each of the generated ranked list of workflows and the node configurations.

10. The system of claim 1, wherein the processor is to deploy the generated AI-based workflow onto the at least one external systems at the real-time based on the set of configuration parameters by:
analyzing workflow descriptors associated with each of the identified plurality of AI and Generative AI service nodes, wherein the workflow descriptors comprise data objects in a human-readable format;
mapping the analyzed workflow descriptors to a target external system;
performing network connection tests at the target external system for deploying the generated AI-based workflow onto the target external system;
instantiating AI-based services corresponding to the generated AI-based workflow as containers at the target external system;
executing each of the identified plurality of AI and Generative AI service nodes at the target external system in the pre-determined manner based on the generated AI-based workflow;
validating the execution of each of the identified plurality of AI and Generative AI service nodes at the target external system;
generating a deployment successful message upon successful validation of the execution of each of the identified plurality of AI and Generative AI service nodes at the target external system;
generating a deployment failure message upon failure of the execution of each of the identified plurality of AI and Generative AI service nodes at the target external system, wherein the deployment failure message comprises one or more execution errors detected during execution; and
performing one or more actions to rectify the one or more execution errors at the target external system.

11. The system of claim 1, wherein the processor is to:
obtain one of a streaming data and a batch data associated with the generated AI-based workflow;
instantiate the generated AI-based workflow based on the obtained one of the streaming data and the batch data;
deploy the AI-based workflow onto at least one external systems at real-time based on the set of configuration parameters;
create a plurality of cases for the deployed AI-based workflow using an AI-detection model;
generate AI-based insights and visualizations for a plurality of events detected and processing performed on the plurality of cases; and
output the generated AI-based insights and visualizations on a graphical user interface of a user device.

12. The system of claim 1, wherein the processor is to perform the determined set of actions on the generated AI-based workflow by:
generating an action code relevant to the at least one external system based on the determined set of actions;
determining action parameters associated with the determined set of actions;
converting the determined action parameters into action descriptors, wherein the action descriptors correspond to a human-readable format;
determining an order of execution associated with the determined set of actions;
triggering action APIs associated with the determined set of actions based on the determined order of execution;
monitoring an action execution at the at least one external system; and
reporting an action execution status at the real-time based on the monitoring, wherein the action execution status comprises one of a successful execution status and errors detected status.

13. A method comprising:
receiving, by a processor, a request for creating an artificial intelligence (AI)-based workflow from a user device;
obtaining, by the processor, an input data from a plurality of data sources based on the received request;
pre-processing, by the processor, the obtained data using an artificial intelligence (AI) based pre-processing model;
identifying, by the processor, a plurality of AI and Generative AI service nodes to be executed on the pre-processed data based on the received request, wherein the plurality of AI and Generative AI service nodes comprise a functional task to be executed on the pre-processed data and wherein the plurality of AI and Generative AI service nodes comprise a plurality of processing nodes;
generating, by the processor, an AI-based workflow by connecting each of the identified plurality of AI and Generative AI service nodes in a pre-determined manner, wherein the AI-based workflow comprises the identified plurality of AI and Generative AI service nodes to be executed, an order of execution, and a service configuration, and wherein the AI-based workflow comprises a workflow description;
generating, by the processor, a metadata for each of identified plurality of AI and Generative AI service nodes by executing each of the identified plurality of AI and Generative AI service nodes comprised in the generated AI-based workflow, wherein the metadata is generated at each stage of execution of the plurality of AI and Generative AI service nodes;
validating, by the processor, the generated metadata based on a plurality of AI-based rules;
determining, by the processor, a set of actions to be performed on the generated metadata based on results of validation;
performing, by the processor, the determined set of actions on the generated AI-based workflow; and
deploying, by the processor, the generated AI-based workflow onto at least one external system based on a set of configuration parameters.

14. The method of claim 13, wherein identifying the plurality of AI and Generative AI service nodes to be executed on the pre-processed data based on the received request comprises:
determining, by the processor, a plurality of functional tasks to be performed for each type of the plurality of multi-media files based on the received request;
tagging, by the processor, the determined plurality of functional tasks to each type of the plurality of multi-media files;
determining, by the processor, the plurality of processing nodes corresponding to the determined plurality of functional tasks, wherein the plurality of processing nodes is to perform a computation within the determined plurality of functional tasks;
configuring, by the processor, the determined plurality of processing nodes based on the received request; and
identifying, by the processor, the plurality of AI and Generative AI service nodes corresponding to the configured plurality of processing nodes.

15. The method of claim 13, wherein generating the AI-based workflow by connecting each of the identified plurality of AI and Generative AI service nodes in the pre-determined manner comprises:
determining, by the processor a service configuration of the identified plurality of AI and Generative AI service nodes based on a type of an AI service node;
identifying, by the processor, an order of execution for the identified plurality of AI and Generative AI service nodes based on a data flow of the pre-processed data and a type of the plurality of functional tasks;
determining, by the processor, a flow path between the identified plurality of AI and Generative AI service nodes based on the identified order of execution and the determined service configuration, wherein the identified plurality of AI and Generative AI service nodes are dragged and dropped at a plurality of node locations;
connecting, by the processor, each of the identified plurality of AI and Generative AI service nodes based on the determined flow path; and
generating, by the processor, the AI-based workflow comprising the identified plurality of AI and Generative AI service nodes to be executed, the order of execution, and the service configuration based on the connection, wherein the AI-based workflow comprises the workflow description and wherein the AI-based workflow comprises a starting service node, an intermediate service node and an ending service node connected in the order of execution and based on the determined flow path.

16. The method of claim 13, wherein executing each of the identified plurality of AI and Generative AI service nodes comprised in the generated AI-based workflow comprises:
analyzing, by the processor, the workflow descriptor associated with each of the identified plurality of AI and Generative AI service nodes, wherein the workflow descriptor comprises data objects in a human-readable format;
instantiating, by the processor, each of the plurality of AI and Generative AI service nodes in the generated AI-based workflow;
performing, by the processor, a functional task associated with each of the plurality of AI and Generative AI service nodes in the order of execution, generating, by the processor, the metadata for each of the identified plurality of AI and Generative AI service nodes at each stage of execution of the functional task;
fusing, by the processor, the metadata generated at each stage with corresponding data objects of an AI service node; and
generating, by the processor, fused metadata output at each stage of execution of the functional task.

17. The method of claim 13, wherein validating the generated metadata based on the plurality of AI-based rules comprises:
obtaining, by the processor, a list of the generated metadata, policy set identifiers (IDs) and parameters for metadata processing;
segmenting, by the processor, each of the generated metadata in the list into a plurality of data segments using a sliding window;
determining, by the processor, the plurality of AI-based rules associated with the plurality of data segments based on a pre-stored rule database;
validating, by the processor, the generated metadata by applying the determined plurality of AI-based rules to the generated metadata;
generating, by the processor, a confidence score for the generated metadata based on the validation, wherein the confidence score comprises one of a low confidence score and a high confidence score;
determining, by the processor, the set of actions to be performed on the generated metadata based on the generated confidence score, wherein the confidence score corresponds to the high confidence score, and wherein the set of actions comprise at least one of a locally executable part of code within a system and integrations with the at least one external system; and
routing, by the processor, the received request to an agent system for resolution based on the generated confidence score, wherein the confidence score corresponds to the low confidence score, and wherein the received request is resolved by the agent system by:
assessing, by the processor, the received request based on a description, a priority level, a business line, and product information;
determining, by the processor, a request description score and a request priority score for the received request based on the assessment;
identifying, by the processor, issue resolution pain-points for the received request to be resolved by the agent system;
determining, by the processor, an appropriate agent corresponding to the received request based on at least one of the determined request description score, the request priority score, the priority level, identified issue resolution pain points, a resolution method, and a resolution sequence, wherein the appropriate agent is determined by constructing a working agent finding model;
assigning, by the processor, the received request to the determined appropriate agent;
periodically monitoring, by the processor, monitor a request progress at the agent system based on feedback from the agent system, interaction logs and a status report; and
continuously updating, by the processor, the rule database with learnings from the agent system upon resolving the received request, wherein the learnings comprise at least one of an issue category, knowledge base records, and operational support records.

18. The method of claim 13, further comprising:
analyzing, by the processor, workflow descriptors associated with each of the identified plurality of AI and Generative AI service nodes, wherein the workflow descriptors comprise data objects in a human-readable format;
instantiating, by the processor, each of the plurality of AI and Generative AI service nodes in the generated AI-based workflow;
performing, by the processor, the functional task associated with each of the plurality of AI and Generative AI service nodes in the order of execution;
measuring, by the processor, an execution time of each of the processing nodes within the plurality of AI and Generative AI service nodes;
validating, by the processor, the generated AI-based workflow based on at least one of the measured execution time, a processing node description, code functions, and the analyzed workflow descriptors;
generating, by the processor, an updated AI-based workflow based on results of validation by modifying the AI-based workflow with updated processing nodes and corresponding AI-based service nodes;
re-computing, by the processor, the execution time of each of the updated processing nodes;
tuning, by the processor, the updated AI-based workflow based on the re-computed execution time using an AI-based optimization method;
generating, by the processor, a ranked list of workflows and node configurations based on the tuned AI-based workflow; and
modifying, by the processor, container implementation information for each of the AI-based service nodes comprised within each of the generated ranked list of workflows and the node configurations.

19. The method of claim 13, wherein deploying the generated AI-based workflow onto the at least one external systems at the real-time based on the set of configuration parameters comprise:
analyzing, by the processor, workflow descriptors associated with each of the identified plurality of AI and Generative AI service nodes, wherein the workflow descriptors comprise data objects in a human-readable format;
mapping, by the processor, the analyzed workflow descriptors to a target external system;
performing, by the processor, network connection tests at the target external system for deploying the generated AI-based workflow onto the target external system;
instantiating, by the processor, AI-based services corresponding to the generated AI-based workflow as containers at the target external system;
executing, by the processor, each of the identified plurality of AI and Generative AI service nodes at the target external system in the pre-determined manner based on the generated AI-based workflow;
validating, by the processor, the execution of each of the identified plurality of AI and Generative AI service nodes at the target external system;
generating, by the processor, a deployment successful message upon successful validation of the execution of each of the identified plurality of AI and Generative AI service nodes at the target external system;
generating, by the processor, a deployment failure message upon failure of the execution of each of the identified plurality of AI and Generative AI service nodes at the target external system, wherein the deployment failure message comprises one or more execution errors detected during execution; and
performing, by the processor, one or more actions to rectify the one or more execution errors at the target external system.

20. A non-transitory computer-readable medium comprising machine-readable instructions that are executable by a processor to:
receive a request for creating an artificial intelligence (AI)-based workflow from a user device;
obtain an input data from a plurality of data sources based on the received request;
pre-process the obtained data using an artificial intelligence (AI) based pre-processing model;
identify a plurality of AI and Generative AI service nodes to be executed on the pre-processed data based on the received request, wherein the plurality of AI and Generative AI service nodes comprise a functional task to be executed on the pre-processed data and wherein the plurality of AI and Generative AI service nodes comprise a plurality of processing nodes;
generate an AI-based workflow by connecting each of the identified plurality of AI and Generative AI service nodes in a pre-determined manner, wherein the AI-based workflow comprises the identified plurality of AI and Generative AI service nodes to be executed, an order of execution, and a service configuration, and wherein the AI-based workflow comprises a workflow description;
generate a metadata for each of identified plurality of AI and Generative AI service nodes by executing each of the identified plurality of AI and Generative AI service nodes comprised in the generated AI-based workflow, wherein the metadata is generated at each stage of execution of the plurality of AI and Generative AI service nodes;
validate the generated metadata based on a plurality of AI-based rules;
determine a set of actions to be performed on the generated metadata based on results of validation;
perform the determined set of actions on the generated AI-based workflow; and
deploy the generated AI-based workflow onto at least one external system based on a set of configuration parameters.
